(19) United States
(12) Patent Application Publication
(10) Pub. No.: US 2026/0328296 A1
(43) Pub. Date: Oct. 22, 2026

(54) FLOW PATH SWITCHING DEVICE

(71) Applicant: AISAN KOGYO KABUSHIKI KAISHA, Obu-shi, Aichi (JP)

(72) Inventors: Mamoru YOSHIOKA, Susono-shi (JP); Kazumasa NAKASHIMA, Nagoya-shi (JP); Shogo IWADE, Nagoya-shi (JP); Hiroki KOBAYASHI, Kariya-shi (JP)

(73) Assignee: AISAN KOGYO KABUSHIKI KAISHA, Obu-shi, Aichi (JP)

(21) Appl. No.: 19/111,259

(22) PCT Filed: Sep. 25, 2023
(86) PCT No.: PCT/JP2023/034626

§ 371 Date: Mar. 12, 2025

(30) Foreign Application Priority Data
Oct. 11, 2022 (JP) 2022-163160
Jun. 13, 2023 (JP) 2023-097028

(51) Int. Cl. F16K 11/074

(52) U.S. Cl. CPC F16K 11/074

(57) ABSTRACT

A flow path switching device includes a housing and a valve body part disposed inside the housing. The valve body part includes a fixed disk, a rotary disk stacked on the fixed disk, and a rotary shaft. The housing, the fixed disk, and the rotary disk respectively have a plurality of communication paths, and the communication paths are connected accompanying the rotation of the rotary disk, whereby the flow paths of a fluid are formed. Seal members which suppress leakage of the fluid at least between the fixed disk and the rotary disk are respectively provided in the flow paths. The leading end portion of the rotary shaft is provided to be able to contact and engage with the fixed disk, and the fixed disk is configured to be able to reciprocate in the axial direction by contacting and engaging with the leading end section of the rotary shaft.

### TECHNICAL FIELD

The technique disclosed in this description relates to a flow path switching device for switching flow paths of a fluid in a fluid circuit.

### BACKGROUND ART

As the technique of this type, conventionally, for example, a flow path switching device described in Patent Document 1 listed below is known. As described in paragraphs [0156] to [0166] and FIG. 10 of Patent Document 1, this device is provided with a housing 71 and a valve body part 73 placed in the housing 71. The valve body part 73 includes a fixed disk 75 and a drive disk 74 which is rotationally driven. The fixed disk 75 is placed so as to segmentalize the inside of the housing 71 and has a plurality of communication paths 75a, 75b. The drive disk 74 has a plate-like shape with a size that can close the communication paths 75a, 75b.

### RELATED ART DOCUMENTS

### Patent Documents

Patent Document 1: Japanese unexamined patent application publication No. 2022-21966

### SUMMARY OF INVENTION

### Problems to be Solved by the Invention

Meanwhile, in the device described in Patent Document 1, it is conceivable that seal members are provided around the communication paths 75a, 75b between the fixed disk 75 and the drive disk 74. In this case, when the drive disk 74 is rotationally driven to switch between the communication paths 75a, 75b, the edges of the communication paths 75a, 75b or the edge of the drive disk 74 move across the seal members with high surface pressure. This may cause sliding wear on the seal members or dislodgement of the seal members by drag.

This disclosed technique has been made to address the above problems and has a purpose to provide a flow path switching device provided with a seal member at least between a fixed disk and a drive disk and configured to prevent the seal member from undergoing sliding wear or dislodging or coming off due to drag when the drive disk rotates.

### Means of Solving the Problems

(1) To achieve the above-mentioned purpose, one aspect of the present disclosure provides a flow path switching device comprising: a housing; a valve body part placed in the housing; in which the valve body part includes: a fixed disk; a drive disk stacked on the fixed disk, the drive disk being to rotate with respect to the fixed disk; and a rotary shaft for rotating the drive disk, the housing, the fixed disk, and the drive disk each include a plurality of communication paths, which are connected by rotation of the drive disk to form flow paths of a fluid, a seal member is provided in the flow paths at least between the fixed disk and the drive disk to suppress leakage of the fluid, wherein a leading end portion of the rotary shaft is provided to be able to make contact and engagement with the fixed disk, and the fixed disk is configured to reciprocally move in an axial direction by making contact and engagement with the leading end portion of the rotary shaft in association with rotation of the rotary shaft.

In the above-mentioned configuration (1), the drive disk rotates with respect to the fixed disk when the rotary shaft rotates. At that time, in the seal member located at least between the fixed disk and the drive disk, sliding resistance due to rotation of the drive disk is reduced. Specifically, according to the configuration (1), the leading end portion of the rotary shaft is provided to be able to make contact and engagement with the fixed disk, and the fixed disk is configured to move reciprocally in the axial direction by contacting and engaging with the leading end portion of the rotary shaft in association with rotation of the rotary shaft. Thus, when the drive disk rotates as the rotary shaft rotates, the rotary disk reciprocally move in the axis direction, which widens the spacing, i.e., distance, between the housing and the drive disk and the spacing between the fixed disk and the drive disk. The surface pressure applied on the seal member between the housing and the drive disk and the seal member between the fixed disk and the drive disk is reduced, and thus sliding resistance of each seal member is reduced.

(2) To achieve the foregoing purpose, in the above-mentioned configuration (1), the leading end portion of the rotary shaft includes a shaft protrusion and a shaft recess, which are arranged in a circumferential direction, the fixed disk includes a disk recess and a disk protrusion, which can make contact and engagement with the shaft protrusion and the shaft recess, and the shaft protrusion and the shaft recess, and, the disk recess and the disk protrusion include side surfaces inclined in the circumferential direction.

According to the above configuration (2), in addition to the operations of the configuration (1), rotating the rotary shaft can establish a state where the shaft protrusion and the disk protrusion contact each other (a protrusion-protrusion contact state) and a state where the shaft protrusion and the shaft recess respectively engage with the disk recess and the disk protrusion (a protrusion-recess engagement). Herein, in the protrusion-protrusion contact state, movement of the fixed disk in the axial direction widens the spacing between the housing and the drive disk and the spacing between the fixed disk and the drive disk, and the surface pressure applied on the seal member between the housing and the drive disk and the seal member between the fixed disk and the drive disk are reduced. In contrast, in the protrusion-recess engagement, when the fixed disk is moved in the axial direction, allowing the spacing between the housing and the drive disk and the spacing between the fixed disk and the drive disk to return to respective original spacings, and the surface pressure applied on the seal member between the housing and the drive disk and the seal member between the fixed disk and the drive disk are returned to respective original levels. When the protrusion-protrusion contact state and the protrusion-recess engagement state are switched over, the inclined side surfaces of the shaft protrusion and the shaft recess and the inclined side surfaces of the disk recess and the disk protrusion go through a state of contacting with each other.

(3) To achieve the foregoing purpose, in the above-mentioned configuration (2), a top portion of at least one of the shaft protrusion or the disk protrusion is formed with a flat surface or a protruding curved surface, and a bottom portion of at least one of the disk recess or the shaft recess is formed with a flat surface or a recessed curved surface.

According to the above configuration (3), in addition to the operations of the configuration (2), the top portion of at least one of the shaft protrusion or the disk protrusion has a flat surface or a protruding curved surface. While the shaft protrusion and the disk protrusion are in contact, therefore, when the rotary shaft is rotated from this state, the position of the rotary shaft in the axial direction does not change suddenly. Further, since the bottom portion of at least one of the disk recess or the shaft recess has a flat surface or a recessed curved surface, when the rotary shaft is rotated while the shaft protrusion and the shaft recess respectively engage with the disk recess and the disk protrusion, the position of the rotary shaft in the axial direction does not change suddenly.

(4) To achieve the foregoing purpose, in the above-mentioned configuration (2), the disk recess includes a V-shaped recess gently-inclined surface at the bottom portion of the disk recess, and includes a steeply-inclined surface continuous from the recess gently-inclined surface to the disk protrusion, forming the side surface of the disk protrusion, and the shaft protrusion includes a V-shaped protrusion gently-inclined surface at the top portion of the shaft protrusion, the protrusion gently-inclined surface conforming to the recess gently-inclined surface, and the side surface of the shaft protrusion, continuous from the protrusion gently-inclined surface, includes a steeply-inclined surface conforming to the steeply-inclined surface of the side surface of the disk protrusion.

According to the above configuration (4), in addition to the operations of the configuration (2), when the rotary shaft starts to rotate from the state where the shaft protrusion of the rotary shaft is in engagement with the disk recess of the fixed disk and the protrusion gently-inclined surface of the shaft protrusion is in abutment on the recess gently-inclined surface of the disk recess, the shaft protrusion starts to slide with slow inclination with respect to the disk recess and slides by abutment of the protrusion gently-inclined surface and the recess gently-inclined surface. Further, as the rotation of the rotary shaft advances, the disk recess and the shaft protrusion shift from abutment between the recess gently-inclined surface and the protrusion gently-inclined surface to abutment between the steeply-inclined surfaces, and the shaft protrusion slides due to surface abutment.

(5) To achieve the foregoing purpose, in any one of the above-mentioned configurations (1) to (4), the drive disk and the rotary shaft are coupled with each other to be relatively movable in a rotation direction and an axial direction.

According to the above configuration (5), in addition to the operations of any one of the configurations (1) to (4), the drive disk and the rotary shaft are coupled to each other to be relatively movable in the rotation direction and the axial direction. Thus, when the drive disk is rotated and the seal member is subjected to the surface pressure, the drive disk moves in the rotation direction and the axial direction within the spacing between the housing and the fixed disk, and comes to a position that balances with the reaction force of the seal member.

(6) To achieve the foregoing purpose, in the above-mentioned configuration (5), a connection portion between the rotary shaft and the drive disk has a gap in the rotation direction.

According to the above configuration (6), in addition to the operations of the configuration (5), the connection portion between the rotary shaft and the drive disk has the gap in the rotation direction, so that the rotary shaft rotates idle, i.e., turns free, within the gap of the connection when the rotary shaft is rotated.

(7) To achieve the foregoing purpose, in the above-mentioned configuration (6), an idle-rotating angle at which the rotary shaft idle-rotates within the gap when the leading end portion of the rotary shaft shifts from a state of the engagement with the fixed disk to a state of the contact with the fixed disk and a switching angle to rotate the drive disk to switch the flow paths are set to a same angle.

According to the above configuration (7), in addition to the operations of the configuration (6), the idle-rotating angle of the rotary shaft when the leading end portion of the rotary shaft shifts from the engagement state to the contact state with the fixed disk, that is, when the fixed disk moves in the axial direction, widening the spacing between the housing and the drive disk and the spacing between the fixed disk and the drive disk, and the switching angle of the drive disk to switch the flow paths are set to the same angle. Thus, when the rotary shaft is rotated in an opposite direction by the switching angle and the idle-rotating angle, the rotational position of the rotary shaft and the rotational position of the drive disk can be returned to the original states.

(8) To achieve the foregoing purpose, the above-mentioned configuration (7), further comprises: drive means that rotationally drives the rotary shaft; and control means that controls the drive means, wherein the control means controls the drive means to rotate the rotary shaft to switch the flow paths with the leading end portion of the rotary shaft in the contact state with the fixed disk, and then to rotate the rotary shaft in an opposite direction and stop rotation of the rotary shaft with the leading end portion of the rotary shaft in the engagement state with the fixed disk.

According to the above configuration (8), in addition to the operations of the configuration (7), the control means controls the drive means to rotate the rotary shaft, switching the flow paths when the leading end portion of the rotary shaft contacts with the fixed disk (where the spacing between the housing and the drive disk and the spacing between the fixed disk and the drive disk are widened), and then rotate the rotary shaft reversely and stop rotation of the rotary shaft when the leading end portion of the rotary shaft engages with the fixed disk (when the spacing between the housing and the drive disk and the spacing between the fixed disk and the drive disk are returned to their original states). This can ensure that the spacing between the housing and the drive disk and the spacing between the fixed disk and the drive disk return to their original states after switching the flow paths.

### Effects of the Invention

According to the above configuration (1), when the drive disk rotates, the seal member can be prevented from undergoing sliding wear and dislodging or coming off by drag.

According to the above configuration (2), in addition to the effects of the configuration (1), the protrusion-protrusion contact state and the protrusion-recess engagement can be switched smoothly.

According to the above configuration (3), in addition to the effects of the configuration (2), the seal member can be further prevented from sliding wear.

According to the above configuration (4), in addition to the effects of the configuration (2), it is possible to reduce the drive torque required to rotate the rotary shaft when the rotary shaft starts to rotate from the engagement state of the shaft protrusion with the disk recess, and thus suppress wear of the shaft protrusion and the disk recess.

According to the above configuration (5), in addition to the effects of any one of the configurations (1) to (4), it is possible to further reduce the surface pressure applied on the seal member when the drive disk rotates, and enhance the durability of the seal member.

According to the above configuration (6), in addition to the effects of the configuration (5), the spacing between the housing and the drive disk and the spacing between the fixed disk and the drive disk can be set in a wider state without rotating the drive disk, even when the rotary shaft is rotated.

According to the above configuration (7), in addition to the effects of the configuration (6), the operation of switching a flow path by rotation of the rotary shaft in one direction can be matched with the operation of switching a flow path by rotation of the rotary shaft in an opposite direction.

According to the above configuration (8), in addition to the effects of the configuration (7), the sealing performance of the seal member can be ensured.

### BRIEF DESCRIPTION OF THE DRAWINGS

FIG. 1 is a perspective view showing a flow path switching device in a first embodiment;

FIG. 2 is a front view showing the flow path switching device in the first embodiment;

FIG. 3 is a plan view showing the flow path switching device in the first embodiment;

FIG. 4 is a bottom view showing the flow path switching device in the first embodiment;

FIG. 5 is an exploded perspective view showing the flow path switching device in the first embodiment;

FIG. 6 is a cross-sectional view showing the flow path switching device taken along a line A-A in FIG. 3 in the first embodiment;

FIG. 7 is a plan view showing a rotary disk in the first embodiment;

FIG. 8 is an exploded perspective view showing an upper housing and a rotary shaft in the first embodiment;

FIG. 9 is a perspective view showing a fixed disk in the first embodiment;

FIG. 10 is an enlarged view showing an engaged structure of the fixed disk shown in FIG. 9 in the first embodiment;

FIG. 11 is a front view showing the rotary shaft in the first embodiment;

FIG. 12 is a perspective view showing a part enclosed by a dashed line in FIG. 11 corresponding to an engaging structure in the first embodiment;

FIG. 13 is a simplified cross-sectional view showing a state before operation of the upper housing, rotary disk, fixed disk, rotary shaft, and others in the first embodiment;

FIG. 14 is a cross-sectional view showing the rotary disk and the rotary shaft taken along a line B-B in FIG. 13 in the first embodiment;

FIG. 15 is a simplified cross-sectional view showing an operation start state of the upper housing, rotary disk, fixed disk, rotary shaft, and others, in which only the rotary shaft rotates, in the first embodiment;

FIG. 16 is a cross-sectional view showing the rotary disk and the rotary shaft taken along a line C-C in FIG. 15 in the first embodiment;

FIG. 17 is a simplified cross-sectional view showing an operating state of the upper housing, rotary disk, fixed disk, rotary shaft, and others, in which the rotary disk rotates, in the first embodiment;

FIG. 18 is a cross-sectional view showing the rotary disk and the rotary shaft taken along a line D-D in FIG. 17 in the first embodiment;

FIG. 19 is a simplified cross-sectional view showing an operation end state of the upper housing, rotary disk, fixed disk, rotary shaft, and others, in which the rotary shaft and the rotary disk further rotate, in the first embodiment;

FIG. 20 is a cross-sectional view showing the rotary disk and the rotary shaft taken along a line E-E in FIG. 19 in the first embodiment;

FIG. 21 is a plan view showing a flow path switching device, from which an upper housing and a drive part are removed, in a second embodiment;

FIG. 22 is an enlarged plan view showing a part (a part enclosed by a dashed line) corresponding to a through hole and a rotary shaft in FIG. 21 in the second embodiment;

FIG. 23 is a perspective view showing the rotary shaft in the second embodiment;

FIG. 24 is an enlarged perspective view showing an engaging structure of a leading end portion of the rotary shaft shown in FIG. 23 in the second embodiment;

FIG. 25 is a plan view showing a fixed disk in the second embodiment;

FIG. 26 is an enlarged perspective view showing an engaged structure of the fixed disk shown in FIG. 25 in the second embodiment;

FIG. 27A is an image diagram showing an engagement relationship between the through hole of the rotary disk and the rotary shaft in an “initial state” of the flow path switching device in the second embodiment;

FIG. 27B is an image diagram showing changes in lifting of the rotary shaft with respect to a rotary shaft angle in the “initial state” of the flow path switching device in the second embodiment;

FIG. 27C is a plan diagram showing rotational positions of the through hole and the rotary shaft and a positional relationship between a disk protrusion and a disk recess and a shaft protrusion in the “initial state” of the flow path switching device in the second embodiment;

FIG. 27D is a plan diagram, similar to FIG. 21, showing a rotational position of the rotary disk and rotation communication paths in the “initial state” of the flow path switching device in the second embodiment;

FIG. 28A is an image diagram, similar to FIG. 27A, showing a “45° rotational state” of the flow path switching device in the second embodiment;

FIG. 28B is an image diagram, similar to FIG. 27B, showing the “45° rotational state” of the flow path switching device in the second embodiment;

FIG. 28C is a plan diagram, similar to FIG. 27C, showing the “45° rotational state” of the flow path switching device in the second embodiment;

FIG. 28D is a plan diagram, similar to FIG. 27D, showing the “45° rotational state” of the flow path switching device in the second embodiment;

FIG. 29A is an image diagram, similar to FIG. 27A, showing a “90° rotational state” of the flow path switching device in the second embodiment;

FIG. 29B is an image diagram, similar to FIG. 27B, showing the “90° rotational state” of the flow path switching device in the second embodiment;

FIG. 29C is a plan diagram, similar to FIG. 27C, showing the “90° rotational state” of the flow path switching device in the second embodiment;

FIG. 29D is a plan diagram, similar to FIG. 27D, showing the “90° rotational state” of the flow path switching device in the second embodiment;

FIG. 30A is an image diagram, similar to FIG. 27A, showing a “135° rotational state” of the flow path switching device in the second embodiment;

FIG. 30B is an image diagram, similar to FIG. 27B, showing the “135° rotational state” of the flow path switching device in the second embodiment;

FIG. 30C is a plan diagram, similar to FIG. 27C, showing the “135° rotational state” of the flow path switching device in the second embodiment;

FIG. 30D is a plan diagram, similar to FIG. 27D, showing the “135° rotational state” of the flow path switching device in the second embodiment;

FIG. 31A is an image diagram, similar to FIG. 27A, showing a “return-90° rotational state” of the flow path switching device in the second embodiment;

FIG. 31B is an image diagram, similar to FIG. 27B, showing the “return-90° rotational state” of the flow path switching device in the second embodiment;

FIG. 31C is a plan diagram, similar to FIG. 27C, showing the “return-90° rotational state” of the flow path switching device in the second embodiment;

FIG. 31D is a plan diagram, similar to FIG. 27D, showing the “return-90° rotational state” of the flow path switching device in the second embodiment;

FIG. 32A is an image diagram, similar to FIG. 27A, showing a “re-135° rotational state” of the flow path switching device in the second embodiment;

FIG. 32B is an image diagram, similar to FIG. 27B, showing the “re-135° rotational state” of the flow path switching device in the second embodiment;

FIG. 32C is a plan diagram, similar to FIG. 27C, showing the “re-135° rotational state” of the flow path switching device in the second embodiment;

FIG. 32D is a plan diagram, similar to FIG. 27D, showing the “re-135° rotational state” of the flow path switching device in the second embodiment;

FIG. 33A is an image diagram, similar to FIG. 27A, showing a “180° rotational state” of the flow path switching device in the second embodiment;

FIG. 33B is an image diagram, similar to FIG. 27B, showing the “180° rotational state” of the flow path switching device in the second embodiment;

FIG. 33C is a plan diagram, similar to FIG. 27C, showing the “180° rotational state” of the flow path switching device in the second embodiment;

FIG. 33D is a plan diagram, similar to FIG. 27D, showing the “180° rotational state” of the flow path switching device in the second embodiment;

FIG. 34A is an image diagram, similar to FIG. 27A, showing a “return-135° rotational state” of the flow path switching device in the second embodiment;

FIG. 34B is an image diagram, similar to FIG. 27B, showing the “return-135° rotational state” of the flow path switching device in the second embodiment;

FIG. 34C is a plan diagram, similar to FIG. 27C, showing the “return-135° rotational state” of the flow path switching device in the second embodiment;

FIG. 34D is a plan diagram, similar to FIG. 27D, showing the “return-135° rotational state” of the flow path switching device in the second embodiment;

FIG. 35A is an image diagram, similar to FIG. 27A, showing the “return-90° rotational state” of the flow path switching device in the second embodiment;

FIG. 35B is an image diagram, similar to FIG. 27B, showing the “return-90° rotational state” of the flow path switching device in the second embodiment;

FIG. 35C is a plan diagram, similar to FIG. 27C, showing the “return-90° rotational state” of the flow path switching device in the second embodiment;

FIG. 35D is a plan diagram, similar to FIG. 27D, showing the “return-90° rotational state” of the flow path switching device in the second embodiment;

FIG. 36A is an image diagram, similar to FIG. 27A, showing a “return-45° rotational state” of the flow path switching device in the second embodiment;

FIG. 36B is an image diagram, similar to FIG. 27B, showing the “return-45° rotational state” of the flow path switching device in the second embodiment;

FIG. 36C is a plan diagram, similar to FIG. 27C, showing the “return-45° rotational state” of the flow path switching device in the second embodiment;

FIG. 36D is a plan diagram, similar to FIG. 27D, showing the “return-45° rotational state” of the flow path switching device in the second embodiment;

FIG. 37A is an image diagram, similar to FIG. 27A, showing a “re-90° rotational state” of the flow path switching device in the second embodiment;

FIG. 37B is an image diagram, similar to FIG. 27B, showing the “re-90° rotational state” of the flow path switching device in the second embodiment;

FIG. 37C is a plan diagram, similar to FIG. 27C, showing the “re-90° rotational state” of the flow path switching device in the second embodiment;

FIG. 37D is a plan diagram, similar to FIG. 27D, showing the “re-90° rotational state” of the flow path switching device in the second embodiment;

FIG. 38A is an image diagram, similar to FIG. 27A, showing the “return-45° rotational state” of the flow path switching device in the second embodiment;

FIG. 38B is an image diagram, similar to FIG. 27B, showing the “return-45° rotational state” of the flow path switching device in the second embodiment;

FIG. 38C is a plan diagram, similar to FIG. 27C, showing the “return-45° rotational state” of the flow path switching device in the second embodiment;

FIG. 38D is a plan diagram, similar to FIG. 27D, showing the “return-45° rotational state” of the flow path switching device in the second embodiment;

FIG. 39A is an image diagram, similar to FIG. 27A, showing a “return-initial state” of the flow path switching device in the second embodiment;

FIG. 39B is an image diagram, similar to FIG. 27B, showing the “return-initial state” of the flow path switching device in the second embodiment;

FIG. 39C is a plan diagram, similar to FIG. 27C, showing the “return-initial state” of the flow path switching device in the second embodiment;

FIG. 39D is a plan diagram, similar to FIG. 27D, showing the “return-initial state” of the flow path switching device in the second embodiment;

FIG. 40A is an image diagram, similar to FIG. 27A, showing an “initial state” of the flow path switching device in a third embodiment;

FIG. 40B is an image diagram, similar to FIG. 27B, showing the “initial state” of the flow path switching device in the third embodiment;

FIG. 40C is a plan diagram, similar to FIG. 27D, showing the “initial state” of the flow path switching device in the third embodiment;

FIG. 41A is an image diagram, similar to FIG. 40A, showing a “45° rotational state” of the flow path switching device in the third embodiment;

FIG. 41B is an image diagram, similar to FIG. 40B, showing the “45° rotational state” of the flow path switching device in the third embodiment;

FIG. 41C is a plan diagram, similar to FIG. 40C, showing the “45° rotational state” of the flow path switching device in the third embodiment;

FIG. 42A is an image diagram, similar to FIG. 41A, showing a “90° rotational state” of the flow path switching device in the third embodiment;

FIG. 42B is an image diagram, similar to FIG. 41B, showing the “90° rotational state” of the flow path switching device in the third embodiment;

FIG. 42C is a plan diagram, similar to FIG. 41C, showing the “90° rotational state” of the flow path switching device in the third embodiment;

FIG. 43A is an image diagram, similar to FIG. 41A, showing a “return-45° rotational state” of the flow path switching device in the third embodiment;

FIG. 43B is an image diagram, similar to FIG. 41B, showing the “return-45° rotational state” of the flow path switching device in the third embodiment;

FIG. 43C is a plan diagram, similar to FIG. 41C, showing the “return-45° rotational state” of the flow path switching device in the third embodiment;

FIG. 44A is an image diagram, similar to FIG. 41A, showing a “return-initial state” of the flow path switching device in the third embodiment;

FIG. 44B is an image diagram, similar to FIG. 41B, showing the “return-initial state” of the flow path switching device in the third embodiment;

FIG. 44C is a plan diagram, similar to FIG. 41C, showing the “return-initial state” of the flow path switching device in the third embodiment;

FIG. 45A is an image diagram, similar to FIG. 40A, showing an “initial state” of a flow path switching device in a fourth embodiment;

FIG. 45B is an image diagram, similar to FIG. 40B, showing the “initial state” of the flow path switching device in the fourth embodiment;

FIG. 45C is a plan diagram, similar to FIG. 40C, showing the “initial state” of the flow path switching device in the fourth embodiment;

FIG. 46A is an image diagram, similar to FIG. 45A, showing a “22.5° rotational state” of the flow path switching device in the fourth embodiment;

FIG. 46B is an image diagram, similar to FIG. 45B, showing the “22.5° rotational state” of the flow path switching device in the fourth embodiment;

FIG. 46C is a plan diagram, similar to FIG. 45C, showing the “22.5° rotational state” of the flow path switching device in the fourth embodiment;

FIG. 47A is an image diagram, similar to FIG. 45A, showing a “67.5° rotational state” of the flow path switching device in the fourth embodiment;

FIG. 47B is an image diagram, similar to FIG. 45B, showing the “67.5° rotational state” of the flow path switching device in the fourth embodiment;

FIG. 47C is a plan diagram, similar to FIG. 45C, showing the “67.5° rotational state” of the flow path switching device in the fourth embodiment;

FIG. 48A is an image diagram, similar to FIG. 45A, showing the “return-45° rotational state” of the flow path switching device in the fourth embodiment;

FIG. 48B is an image diagram, similar to FIG. 45B, showing the “return-45° rotational state” of the flow path switching device in the fourth embodiment;

FIG. 48C is a plan diagram, similar to FIG. 45C, showing the “return-45° rotational state” of the flow path switching device in the fourth embodiment;

FIG. 49A is an image diagram, similar to FIG. 45A, showing a “return-initial state” of the flow path switching device in the fourth embodiment;

FIG. 49B is an image diagram, similar to FIG. 45B, showing the “return-initial state” of the flow path switching device in the fourth embodiment;

FIG. 49C is a plan diagram, similar to FIG. 45C, showing the “return-initial state” of the flow path switching device in the fourth embodiment;

FIG. 50A is an image diagram, similar to FIG. 40A, showing an “initial state” of the flow path switching device in a fifth embodiment;

FIG. 50B is an image diagram, similar to FIG. 40B, showing the “initial state” of the flow path switching device in the fifth embodiment;

FIG. 50C is a plan diagram, similar to FIG. 40C, showing the “return-initial state” of the flow path switching device in the fifth embodiment;

FIG. 51A is an image diagram, similar to FIG. 50A, showing a “45° rotational state” of the flow path switching device in the fifth embodiment;

FIG. 51B is an image diagram, similar to FIG. 50B, showing the “45° rotational state” of the flow path switching device in the fifth embodiment;

FIG. 51C is a plan diagram, similar to FIG. 50C, showing the “45° rotational state” of the flow path switching device in the fifth embodiment;

FIG. 52A is an image diagram, similar to FIG. 50A, showing a “90° rotational state” of the flow path switching device in the fifth embodiment;

FIG. 52B is an image diagram, similar to FIG. 50B, showing the “90° rotational state” of the flow path switching device in the fifth embodiment;

FIG. 52C is a plan diagram, similar to FIG. 50C, showing the “90° rotational state” of the flow path switching device in the fifth embodiment;

FIG. 53A is an image diagram, similar to FIG. 50A, showing a “135° rotational state” of the flow path switching device in the fifth embodiment;

FIG. 53B is an image diagram, similar to FIG. 50B, showing the “135° rotational state” of the flow path switching device in the fifth embodiment;

FIG. 53C is a plan diagram, similar to FIG. 50C, showing the “135° rotational state” of the flow path switching device in the fifth embodiment;

FIG. 54A is an image diagram, similar to FIG. 50A, showing a “return-90° rotational state” of the flow path switching device in the fifth embodiment;

FIG. 54B is an image diagram, similar to FIG. 50B, showing the “return-90° rotational state” of the flow path switching device in the fifth embodiment;

FIG. 54C is a plan diagram, similar to FIG. 50C, showing the “return-90° rotational state” of the flow path switching device in the fifth embodiment;

FIG. 55A is an image diagram, similar to FIG. 50A, showing a “return-45° rotational state” of the flow path switching device in the fifth embodiment;

FIG. 55B is an image diagram, similar to FIG. 50B, showing the “return-45° rotational state” of the flow path switching device in the fifth embodiment;

FIG. 55C is a plan diagram, similar to FIG. 50C, showing the “return-45° rotational state” of the flow path switching device in the fifth embodiment;

FIG. 56A is an image diagram, similar to FIG. 50A, showing a “re-90° rotational state” of the flow path switching device in the fifth embodiment;

FIG. 56B is an image diagram, similar to FIG. 50B, showing the “re-90° rotational state” of the flow path switching device in the fifth embodiment;

FIG. 56C is a plan diagram, similar to FIG. 50C, showing the “re-90° rotational state” of the flow path switching device in the fifth embodiment;

FIG. 57A is an image diagram, similar to FIG. 50A, showing the “return-45° rotational state” of the flow path switching device in the fifth embodiment;

FIG. 57B is an image diagram, similar to FIG. 50B, showing the “return-45° rotational state” of the flow path switching device in the fifth embodiment;

FIG. 57C is a plan diagram, similar to FIG. 50C, showing the “return-45° rotational state” of the flow path switching device in the fifth embodiment;

FIG. 58A is an image diagram, similar to FIG. 50A, showing a “return-initial state” of the flow path switching device in the fifth embodiment;

FIG. 58B is an image diagram, similar to FIG. 50B, showing the “return-initial state” of the flow path switching device in the fifth embodiment;

FIG. 58C is a plan diagram, similar to FIG. 50C, showing the “return-initial state” of the flow path switching device in the fifth embodiment;

FIG. 59 is a perspective view showing an upper side of a flow path switching device in a sixth embodiment;

FIG. 60 is a perspective view showing a bottom side of the flow path switching device in the sixth embodiment;

FIG. 61 is a plan view showing the flow path switching device in the sixth embodiment;

FIG. 62 is a plan view showing the flow path switching device, from which an upper housing and a drive part are removed, in the sixth embodiment;

FIG. 63 is an enlarged plan view showing the part corresponding to a through hole and a rotary shaft in FIG. 62 in the sixth embodiment;

FIG. 64 is a perspective view showing a rotary shaft in the sixth embodiment;

FIG. 65 is an enlarged perspective view showing an engaging structure of a leading end portion of the rotary shaft shown in FIG. 64 in the sixth embodiment;

FIG. 66 is a plan view showing a fixed disk in the sixth embodiment;

FIG. 67 is an enlarged perspective view showing an engaged structure of the fixed disk shown in FIG. 66 in the sixth embodiment;

FIG. 68A is an image diagram, similar to FIG. 27A, showing an “initial state” of the flow path switching device in the sixth embodiment;

FIG. 68B is an image diagram, similar to FIG. 27B, showing the “initial state” of the flow path switching device in the sixth embodiment;

FIG. 68C is a plane diagram, similar to FIG. 27C, showing the “initial state” of the flow path switching device in the sixth embodiment;

FIG. 68D is a plane diagram, similar to FIG. 27D, showing the “initial state” of the flow path switching device in the sixth embodiment;

FIG. 69A is an image diagram, similar to FIG. 68A, showing a “30° rotational state” of the flow path switching device in the sixth embodiment;

FIG. 69B is an image diagram, similar to FIG. 68B, showing the “30° rotational state” of the flow path switching device in the sixth embodiment;

FIG. 69C is a plane diagram, similar to FIG. 68C, showing the “30° rotational state” of the flow path switching device in the sixth embodiment;

FIG. 69D is a plane diagram, similar to FIG. 68D, showing the “30° rotational state” of the flow path switching device in the sixth embodiment;

FIG. 70A is an image diagram, similar to FIG. 68A, showing a “60° rotational state” of the flow path switching device in the sixth embodiment;

FIG. 70B is an image diagram, similar to FIG. 68B, showing the “60° rotational state” of the flow path switching device in the sixth embodiment;

FIG. 70C is a plan diagram, similar to FIG. 68C, showing the “60° rotational state” of the flow path switching device in the sixth embodiment;

FIG. 70D is a plan diagram, similar to FIG. 68D, showing the “60° rotational state” of the flow path switching device in the sixth embodiment;

FIG. 71A is an image diagram, similar to FIG. 68A, showing a “return-30° rotational state” of the flow path switching device in the sixth embodiment;

FIG. 71B is an image diagram, similar to FIG. 68B, showing the “return-30° rotational state” of the flow path switching device in the sixth embodiment;

FIG. 71C is a plan diagram, similar to FIG. 68C, showing the “return-30° rotational state” of the flow path switching device in the sixth embodiment;

FIG. 71D is a plan diagram, similar to FIG. 68D, showing the “return-30° rotational state” of the flow path switching device in the sixth embodiment;

FIG. 72A is an image diagram, similar to FIG. 68A, showing a “return-0° rotational state” of the flow path switching device in the sixth embodiment;

FIG. 72B is an image diagram, similar to FIG. 68B, showing the “return-0° rotational state” of the flow path switching device in the sixth embodiment;

FIG. 72C is a plan diagram, similar to FIG. 68C, showing the “return-0° rotational state” of the flow path switching device in the sixth embodiment;

FIG. 72D is a plan diagram, similar to FIG. 68D, showing the “return-0° rotational state” of the flow path switching device in the sixth embodiment;

FIG. 73A is an image diagram, similar to FIG. 68A, showing a “re-30° rotational state” of the flow path switching device in the sixth embodiment;

FIG. 73B is an image diagram, similar to FIG. 68B, showing the “re-30° rotational state” of the flow path switching device in the sixth embodiment;

FIG. 73C is a plan diagram, similar to FIG. 68C, showing the “re-30° rotational state” of the flow path switching device in the sixth embodiment;

FIG. 73D is a plan diagram, similar to FIG. 68D, showing the “re-30° rotational state” of the flow path switching device in the sixth embodiment;

FIG. 74A is an image diagram, similar to FIG. 68A, showing a “re-60° rotational state” of the flow path switching device in the sixth embodiment;

FIG. 74B is an image diagram, similar to FIG. 68B, showing the “re-60° rotational state” of the flow path switching device in the sixth embodiment;

FIG. 74C is a plan diagram, similar to FIG. 68C, showing the “re-60° rotational state” of the flow path switching device in the sixth embodiment;

FIG. 74D is a plan diagram, similar to FIG. 68D, showing the “re-60° rotational state” of the flow path switching device in the sixth embodiment;

FIG. 75A is an image diagram, similar to FIG. 68A, showing a “90° rotational state” of the flow path switching device in the sixth embodiment;

FIG. 75B is an image diagram, similar to FIG. 68B, showing the “90° rotational state” of the flow path switching device in the sixth embodiment;

FIG. 75C is a plan diagram, similar to FIG. 68C, showing the “90° rotational state” of the flow path switching device in the sixth embodiment;

FIG. 75D is a plan diagram, similar to FIG. 68D, showing the “90° rotational state” of the flow path switching device in the sixth embodiment;

FIG. 76A is an image diagram, similar to FIG. 68A, showing a “return-60° rotational state” of the flow path switching device in the sixth embodiment;

FIG. 76B is an image diagram, similar to FIG. 68B, showing the “return-60° rotational state” of the flow path switching device in the sixth embodiment;

FIG. 76C is a plan diagram, similar to FIG. 68C, showing the “return-60° rotational state” of the flow path switching device in the sixth embodiment;

FIG. 76D is a plan diagram, similar to FIG. 68D, showing the “return-60° rotational state” of the flow path switching device in the sixth embodiment;

FIG. 77A is an image diagram, similar to FIG. 68A, showing the “return-30° rotational state” of the flow path switching device in the sixth embodiment;

FIG. 77B is an image diagram, similar to FIG. 68B, showing the “return-30° rotational state” of the flow path switching device in the sixth embodiment;

FIG. 77C is a plan diagram, similar to FIG. 68C, showing the “return-30° rotational state” of the flow path switching device in the sixth embodiment;

FIG. 77D is a plan diagram, similar to FIG. 68D, showing the “return-30° rotational state” of the flow path switching device in the sixth embodiment;

FIG. 78A is an image diagram, similar to FIG. 68A, showing the “return-0° rotational state” of the flow path switching device in the sixth embodiment;

FIG. 78B is an image diagram, similar to FIG. 68B, showing the “return-0° rotational state” of the flow path switching device in the sixth embodiment;

FIG. 78C is a plan diagram, similar to FIG. 68C, showing the “return-0° rotational state” of the flow path switching device in the sixth embodiment;

FIG. 78D is a plan diagram, similar to FIG. 68D, showing the “return-0° rotational state” of the flow path switching device in the sixth embodiment;

FIG. 79A is an image diagram, similar to FIG. 68A, showing a “−30° rotational state” of the flow path switching device in the sixth embodiment;

FIG. 79B is an image diagram, similar to FIG. 68B, showing the “−30° rotational state” of the flow path switching device in the sixth embodiment;

FIG. 79C is a plan diagram, similar to FIG. 68C, showing the “−30° rotational state” of the flow path switching device in the sixth embodiment;

FIG. 79D is a plan diagram, similar to FIG. 68D, showing the “−30° rotational state” of the flow path switching device in the sixth embodiment;

FIG. 80A is an image diagram, similar to FIG. 68A, showing a “return-initial state” of the flow path switching device in the sixth embodiment;

FIG. 80B is an image diagram, similar to FIG. 68B, showing the “return-initial state” of the flow path switching device in the sixth embodiment;

FIG. 80C is a plan diagram, similar to FIG. 68C, showing the “return-initial state” of the flow path switching device in the sixth embodiment;

FIG. 80D is a plan diagram, similar to FIG. 68D, showing the “return-initial state” of the flow path switching device in the sixth embodiment;

FIG. 81 is a flowchart showing one example of contents of flow pass switching control in the sixth embodiment;

FIG. 82 is a flowchart showing one example of the contents of the flow pass switching control in the sixth embodiment;

FIG. 83 is a flowchart showing one example of the contents of the flow pass switching control in the sixth embodiment;

FIG. 84A is an image diagram, similar to FIG. 68A, showing an “initial state” of a flow path switching device in a seventh embodiment;

FIG. 84B is an image diagram, similar to FIG. 68B, showing the “initial state” of the flow path switching device in the seventh embodiment;

FIG. 84C is a plan diagram, similar to FIG. 68D, showing the “initial state” of the flow path switching device in the seventh embodiment;

FIG. 85A is an image diagram, similar to FIG. 84A, showing a “30° rotational state” of the flow path switching device in the seventh embodiment;

FIG. 85B is an image diagram, similar to FIG. 84B, showing the “30° rotational state” of the flow path switching device in the seventh embodiment;

FIG. 85C is a plan diagram, similar to FIG. 84C, showing the “30° rotational state” of the flow path switching device in the seventh embodiment;

FIG. 86A is an image diagram, similar to FIG. 84A, showing a “60° rotational state” of the flow path switching device in the seventh embodiment;

FIG. 86B is an image diagram, similar to FIG. 84B, showing the “60° rotational state” of the flow path switching device in the seventh embodiment;

FIG. 86C is a plan diagram, similar to FIG. 84C, showing the “60° rotational state” of the flow path switching device in the seventh embodiment;

FIG. 87A is an image diagram, similar to FIG. 84A, showing a “return-30° rotational state” of the flow path switching device in the seventh embodiment;

FIG. 87B is an image diagram, similar to FIG. 84B, showing the “return-30° rotational state” of the flow path switching device in the seventh embodiment;

FIG. 87C is a plan diagram, similar to FIG. 84C, showing the “return-30° rotational state” of the flow path switching device in the seventh embodiment;

FIG. 88A is an image diagram, similar to FIG. 84A, showing a “return-0° rotational state” of the flow path switching device in the seventh embodiment;

FIG. 88B is an image diagram, similar to FIG. 84B, showing the “return-0° rotational state” of the flow path switching device in the seventh embodiment;

FIG. 88C is a plan diagram, similar to FIG. 84C, showing the “return-0° rotational state” of the flow path switching device in the seventh embodiment;

FIG. 89A is an image diagram, similar to FIG. 84A, showing a “−30° rotational state” of the flow path switching device in the seventh embodiment;

FIG. 89B is an image diagram, similar to FIG. 84B, showing the “−30° rotational state” of the flow path switching device in the seventh embodiment;

FIG. 89C is a plan diagram, similar to FIG. 84C, showing the “−30° rotational state” of the flow path switching device in the seventh embodiment;

FIG. 90A is an image diagram, similar to FIG. 84A, showing a “return-initial state” of the flow path switching device in the seventh embodiment;

FIG. 90B is an image diagram, similar to FIG. 84B, showing the “return-initial state” of the flow path switching device in the seventh embodiment;

FIG. 90C is a plan diagram, similar to FIG. 84C, showing the “return-initial state” of the flow path switching device in the seventh embodiment;

FIG. 91A is an image diagram, similar to FIG. 40A, showing an “initial state” of a flow path switching device in an eighth embodiment;

FIG. 91B is an image diagram showing a relationship between an engaging structure and an engaged structure in the “initial state” of the flow path switching device in the eighth embodiment;

FIG. 91C is an image diagram, similar to FIG. 40B, showing the “initial state” of the flow path switching device in the eighth embodiment;

FIG. 92A is an image diagram, similar to FIG. 91A, showing a “45° rotational state” of the flow path switching device in the eighth embodiment;

FIG. 92B is an image diagram, similar to FIG. 91B, showing the “45° rotational state” of the flow path switching device in the eighth embodiment;

FIG. 92C is an image diagram, similar to FIG. 91C, showing the “45° rotational state” of the flow path switching device in the eighth embodiment;

FIG. 93A is an image diagram, similar to FIG. 91A, showing a “90° rotational state” of the flow path switching device in the eighth embodiment;

FIG. 93B is an image diagram, similar to FIG. 91B, showing the “90° rotational state” of the flow path switching device in the eighth embodiment;

FIG. 93C is an image diagram, similar to FIG. 91C, showing the “90° rotational state” of the flow path switching device in the eighth embodiment;

FIG. 94A is an image diagram, similar to FIG. 91A, showing a “return-45° rotational state” of the flow path switching device in the eighth embodiment;

FIG. 94B is an image diagram, similar to FIG. 91B, showing the “return-45° rotational state” of the flow path switching device in the eighth embodiment;

FIG. 94C is an image diagram, similar to FIG. 91C, showing the “return-45° rotational state” of the flow path switching device in the eighth embodiment;

FIG. 95A is an image diagram, similar to FIG. 91A, showing a “return-initial state” of the flow path switching device in the eighth embodiment;

FIG. 95B is an image diagram, similar to FIG. 91B, showing the “return-initial state” of the flow path switching device in the eighth embodiment;

FIG. 95C is an image diagram, similar to FIG. 91C, showing the “return-initial state” of the flow path switching device in the eighth embodiment;

FIG. 96 is an image diagram showing a relationship between an engaging structure and an engaged structure when a rotary shaft lifts down before switching flow paths in a ninth embodiment;

FIG. 97 is an image diagram showing a relationship between the engaging structure and the engaged structure in the process of lifting up the rotary shaft in switching flow paths in the ninth embodiment;

FIG. 98 is an image diagram showing a relationship between the engaging structure and the engaged structure when the rotary shaft lifts up in switching the flow paths in the ninth embodiment;

FIG. 99 is an image diagram showing a relationship between the engaging structure and the engaged structure when the rotary shaft lifts down before switching flow paths in a comparative example (the eighth embodiment);

FIG. 100 is an image diagram showing the relationship between the engaging structure and the engaged structure in the process of lifting up the rotary shaft in switching flow paths in the comparative example (the eighth embodiment);

FIG. 101 is an image diagram showing the relationship between the engaging structure and the engaged structure when the rotary shaft lifts up in switching flow paths in a comparative example (the eighth embodiment);

FIG. 102 is a graph showing a relationship between changes in rotating angle of the rotary shaft and changes in drive torque in the ninth embodiment;

FIG. 103 is an image diagram showing a relationship between an engaging structure and an engaged structure in a lift-down state before switching flow paths in a tenth embodiment;

FIG. 104 is an enlarged image diagram showing an abutting portion in FIG. 103 in the tenth embodiment;

FIG. 105 is an image diagram showing a relationship between the engaging structure and the engaged structure at the start of flow path switching (at the initial drive stage in which lift-up starts) in the tenth embodiment;

FIG. 106 is an image diagram showing the relationship between the engaging structure and the engaged structure in the process of flow path switching (in the process of lift-up) in the tenth embodiment;

FIG. 107 is an image diagram showing the relationship between the engaging structure and the engaged structure in the process of flow path switching (in the process of lift-up) in the tenth embodiment;

FIG. 108 is an enlarged image diagram showing an abutting portion in FIG. 107 in the tenth embodiment;

FIG. 109 is an image diagram showing the relationship between the engaging structure and the engaged structure in the process of flow path switching and just after a top portion of a shaft protrusion overrides a top portion of a disk protrusion (starts to lift down) in the tenth embodiment;

FIG. 110 is an enlarged image diagram showing an abutting portion in FIG. 109 in the tenth embodiment;

FIG. 111 is an image diagram showing the relationship between the engaging structure and the engaged structure in the process of flow path switching (in the process of lift-down) in the tenth embodiment;

FIG. 112 is an image diagram showing the relationship between the engaging structure and the engaged structure before completion of flow path switching (before completion of lift-down) in the tenth embodiment;

FIG. 113 is an image diagram showing the relationship between the engaging structure and the engaged structure on completion of flow path switching (on completion of lift-down) in the tenth embodiment;

FIG. 114 is an image diagram, similar to FIG. 107, showing the relationship between an engaging structure and an engaged structure in the process of flow path switching (in the process of lift-up) in an eleventh embodiment; and

FIG. 115 is an enlarged image diagram showing an abutting portion in FIG. 114 in the eleventh embodiment,

### MODE FOR CARRYING OUT THE INVENTION

A detailed description of several embodiments of a flow path switching device will now be given referring to the accompanying drawings.

### First Embodiment

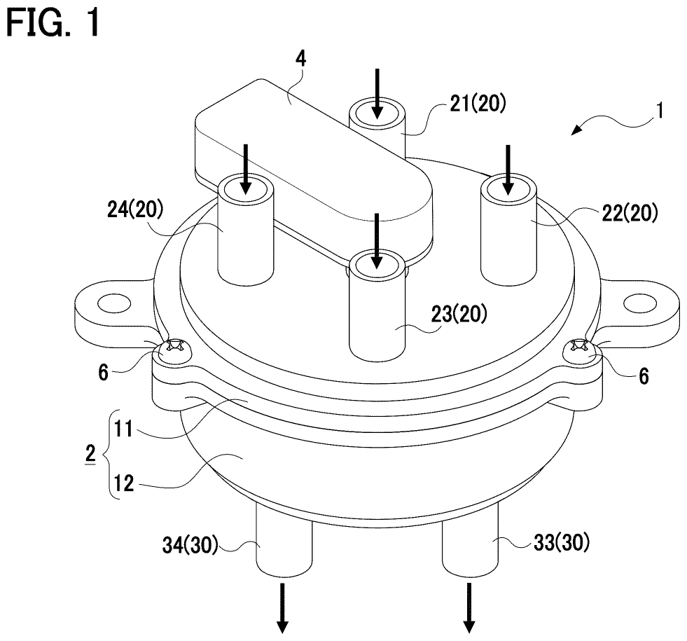

A first embodiment will be described first in detail, referring to FIGS. 1 to 20.

### Brief Overview of Flow Path Switching Device

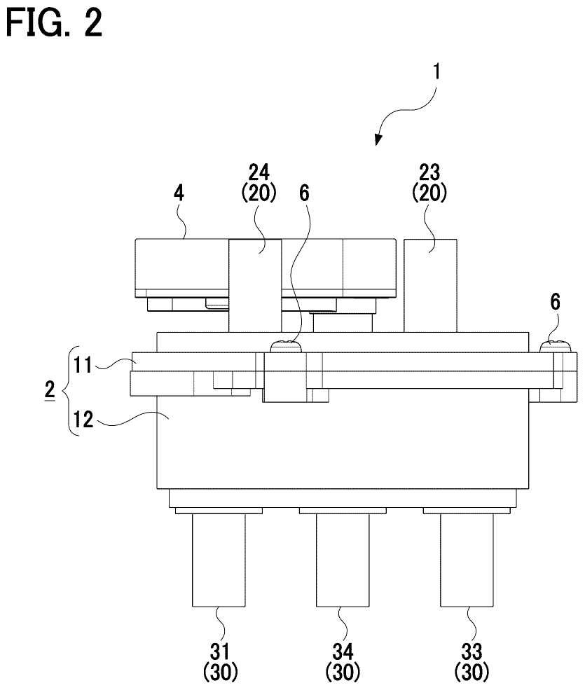

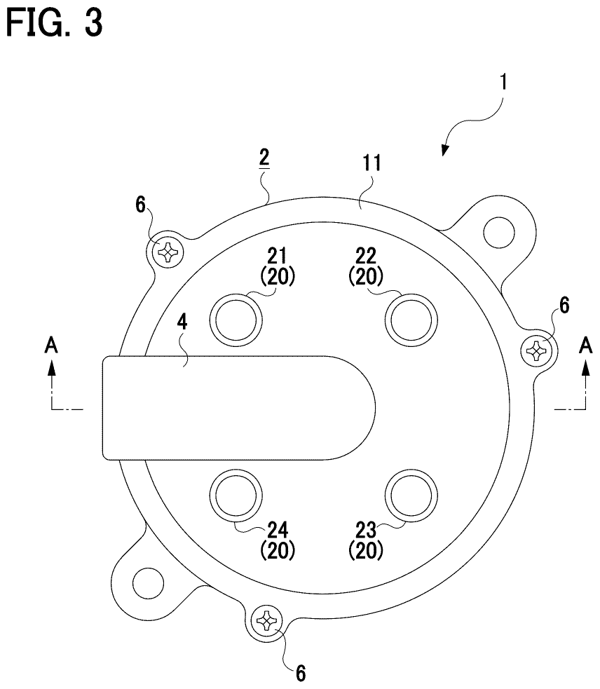

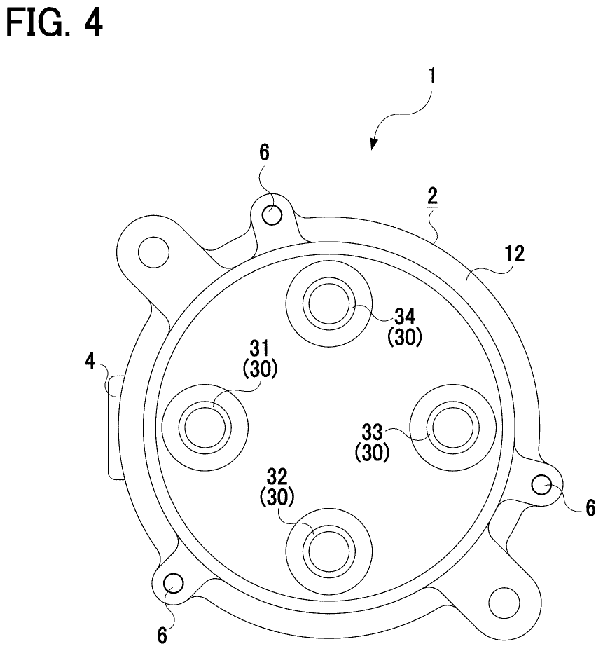

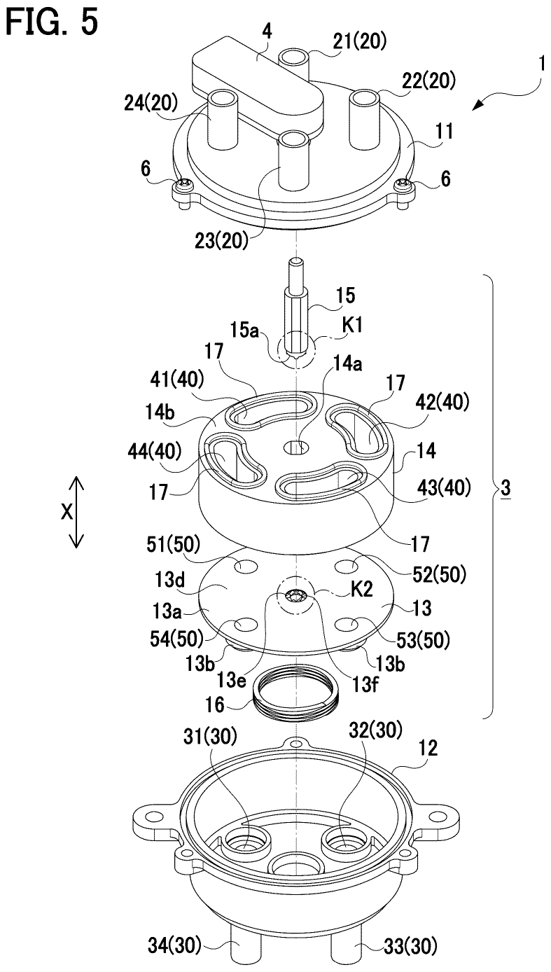

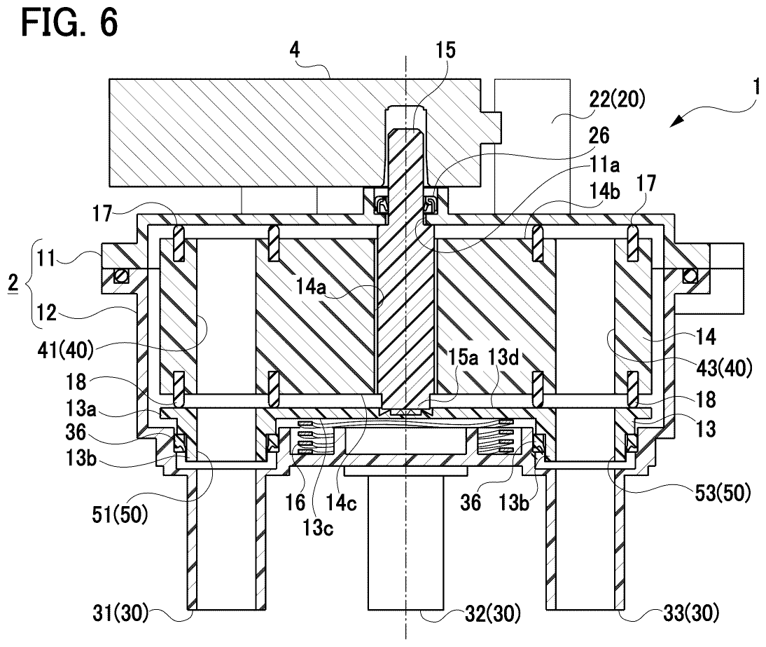

FIG. 1 is a perspective view showing a flow path switching device. FIG. 2 is a front view showing the flow path switching device 1. FIG. 3 is a plan view showing the flow path switching device 1. FIG. 4 is a bottom view showing the flow path switching device 1. FIG. 5 is an exploded perspective view showing the flow path switching device 1. FIG. 6 is a cross-sectional view showing the flow path switching device 1 taken along a line A-A in FIG. 3. As shown in FIGS. 1 to 6, the flow path switching device 1 is provided with a housing 2, a valve body part 3 placed in the housing 2, and a drive part 4 that drives the valve body part 3.

### Housing

The housing 2 is constituted of an upper housing 11 and a lower housing 12, which are fastened to each other by a plurality of screws 6. The housing 2 includes inflow paths 20 through which a fluid flows therein and outflow paths 30 through which a fluid flows therefrom. Herein, the flow path switching device 1 is constituted as an eight-way valve, for example, and the housing 2 has four inflow paths 20 and four outflow paths 30. As the four inflow paths 20, a first inflow path 21, a second inflow path 22, a third inflow path 23, and a fourth inflow path 24 are provided in the upper housing 11. Further, as the four outflow paths 30, a first outflow path 31, a second outflow path 32, a third outflow path 33, and a fourth outflow path 34 are provided in the lower housing 12. The inflow paths 20 and the outflow paths 30 correspond to one example of “communication paths” provided in a “housing” of this disclosure. In this embodiment, the housing 2 is made of resin, for example.

### Valve Body Part

The valve body part 3 includes, as shown in FIGS. 5 and 6, a fixed disk 13 that does not rotate in the housing 2, a rotary disk 14 that is stacked on the fixed disk 13 and can rotate with respect to the fixed disk 13, and a rotary shaft 15 for rotating the rotary disk 14. The rotary disk 14 and the fixed disk 13 are placed by stacking in the axial direction X. The rotary disk 14 corresponds to one example of a “drive disk” of this disclosure. The rotary disk 14 and the fixed disk 13 are made of resin, for example.

### Rotary Disk

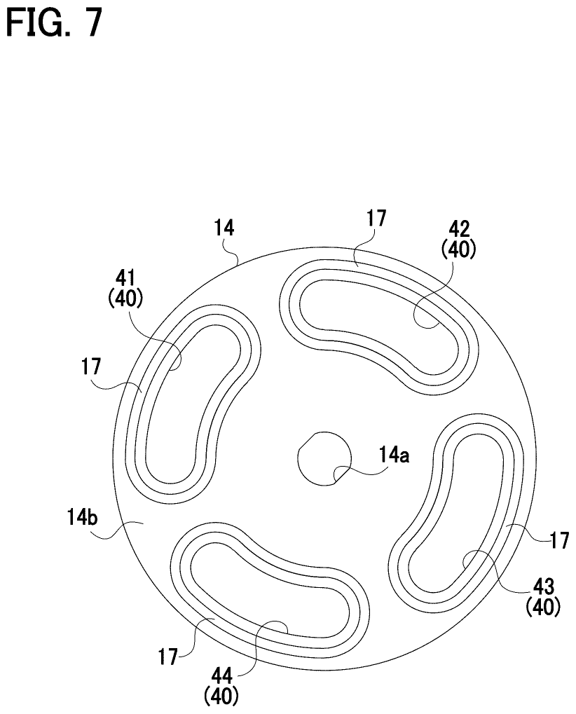

FIG. 7 is a plan view showing the rotary disk 14. As shown in FIGS. 6 and 7, the rotary disk 14 is housed in the housing 2. The rotary disk 14 is formed of a thick circular plate and includes four rotation communication paths 40 extending therethrough in the axial direction X. As the four rotation communication paths 40, a first rotation communication path 41, a second rotation communication path 42, a third rotation communication path 43, and a fourth rotation communication path 44 are provided. Each rotation communication path 40 is in the form of a lightly-curved elongated hole in plan view. The rotation communication paths 40 correspond to “communication paths” provided in a “drive disk” of this disclosure. The rotary disk 14 is formed, at its center, with a through hole 14a through which the rotary shaft 15 extends. This through hole 14a has a width across flat shape in cross-section (an oval shape) larger than the outer diameter of the rotary shaft 15.

### Rotary Shaft

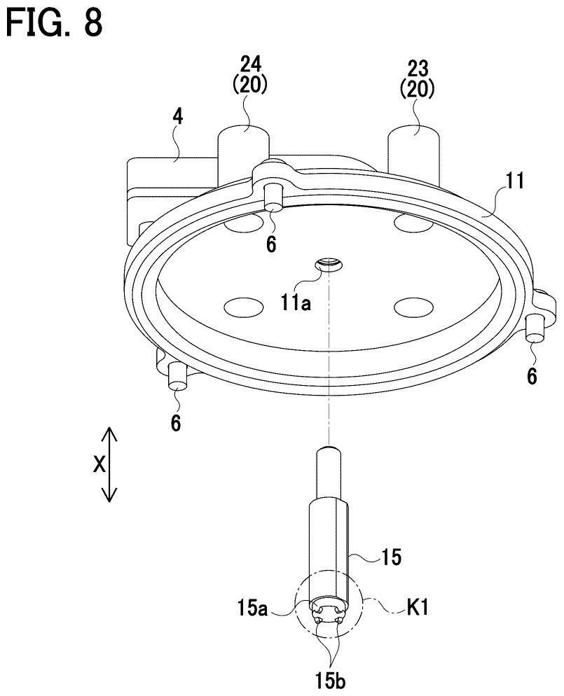

FIG. 8 is an exploded perspective view showing the upper housing 11 and the rotary shaft 15. In this embodiment, the rotary shaft 15 is made of resin. The rotary shaft 15 is provided extending through the upper housing 11 and the rotary disk 14, and connected at its one end (a lower end in FIGS. 5 and 6) in the axial direction X to the fixed disk 13 and the rotary disk 14 while connected at its the other end (an upper end in FIGS. 5 and 6) to the drive part 4. As shown in FIG. 8, the other end of the rotary shaft 15 is extended upward through a through hole 11a formed in the upper housing 11 and is connected to the drive part 4. As shown in FIG. 6, a lip seal 26 is provided between the upper housing 11 and the rotary shaft 15. The rotary shaft 15 may be made of metal.

In this embodiment, the rotary disk 14 and the rotary shaft 15 are coupled with each other to be relatively rotatable in the rotation direction and the axial direction. Specifically, as shown in FIGS. 5 to 8, the one end of the rotary shaft 15 (the lower end in FIGS. 5 and 6) has a width across flat shape (an oval shape), similar to the through hole 14a of the rotary disk 14, and has a cross-section smaller than the through hole 14a. In other words, a connection portion between the rotary shaft 15 and the rotary disk 14 (the through hole 14a and the corresponding lower part of the rotary shaft 15) has a gap 28 (see FIGS. 13 to 20 mentioned later). The rotary shaft 15 is coupled with the through hole 14a to be relatively rotatable in the rotation direction and the axial direction. This rotary shaft 15 is inserted in the through hole 14a of the rotary disk 14 so that the central axis of the rotary shaft 15 coincides with the central axis of the rotary disk 14. The rotary shaft 15 is configured to rotate by the drive power obtained from the drive unit 4, idle-rotate by the gap 28 within the through hole, then engage with the inner wall of the through hole 14a and rotate together with the rotary disk 14.

### Fixed Disk

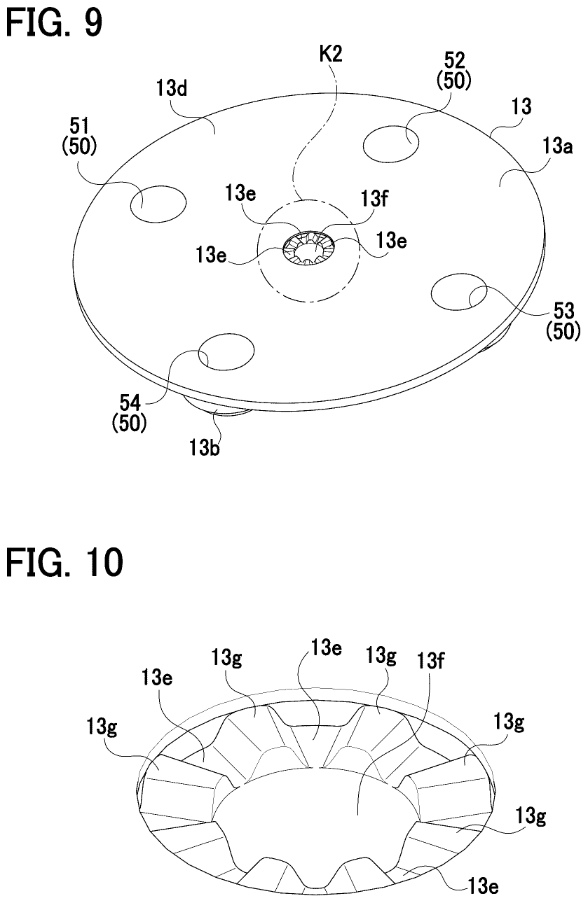

FIG. 9 is a perspective view showing the fixed disk 13. As shown in FIG. 6, the fixed disk 13 is housed in the lower housing 12. As shown in FIGS. 5, 6, and 9, the fixed disk 13 includes a circular plate part 13a and a plurality of cylindrical parts 13b extending downward from the circular plate part 13a. The circular plate part 13a is formed like a circular plate and includes four fixed communication paths 50 each extending therethrough in the axial direction. As shown in FIGS. 5 and 8, as the four fixed communication paths 50, a first fixed communication path 51, a second fixed communication path 52, a third fixed communication path 53, and a fourth fixed communication path 54 are provided. The fixed communication paths 50 correspond to one example of “communication paths” provided in a “fixed disk” of this disclosure.

The four cylindrical parts 13b of the fixed disk 13 are formed integral with the circular plate part 13a and internally provide the fixed communication paths 50. Each cylindrical part 13b is placed to communicate with each corresponding outflow path 30. Between the fixed disk 13 and the lower housing 12, a spring 16 is provided to bias the fixed disk 13 toward the rotary disk 14. The spring 16 is placed on the center of the lower surface 13c of the fixed disk 13 and surrounded by the cylindrical parts 13b. Further, between each cylindrical part 13b and the lower housing 12, a lip seal 36 is provided to ensure the sealing property of the fixed communication paths 50.

### Drive Part

The drive part 4 includes a motor and a reduction mechanism (not shown) to provide the drive power to rotate the rotary shaft 15. The flow path switching device 1 causes the drive part 4 to rotationally drive the rotary disk 14 via the rotary shaft 15 to change communication combinations of the four rotation communication paths 40, the four inflow paths 20, and the four fixed communication paths 50 to switch between several patters of a flow path for a fluid. Herein, the description on switching of the flow path patterns is omitted.

### Seal Member

In this embodiment, in the flow paths, seal members 17, 18 are provided to prevent fluid leakage among the housing 2, the fixed disk 13, and the rotary disk 14. As shown in FIGS. 5 to 7, in this embodiment, the seal members 17, 18 are provided in the rotary disk 14. Specifically, on an upper end face 14b and a lower end face 14c of the rotary disk 14, the seal members 17, 18 are arranged around openings of the rotation communication paths 40 and protruding from the upper and lower end faces 14b, 14c. In FIG. 6, on the upper end face 14b of the rotary disk 14, four upper seal members 17 provided corresponding to the four rotation communication paths 40. On the lower end face 14c of the rotary disk 14, four lower seal members 18 are provided corresponding to the four rotation communication paths 40. Both the upper and lower seal members 17, 18 are made of fluorine resin (e.g., Teflon (registered trademark)). Further, the upper and lower seal members 17, 18 may also be made of rubber coated with fluorine resin. Still further, the upper and lower seal members 17, 18 may be made of rubber alone.

In this embodiment, the seal members 17 and the seal members 18 provided respectively protruding from the upper end face 14b and the lower end face 14c of the rotary disk 14 abut on the inner surface of the upper housing 11 and the upper surface 13d of the fixed disk 13. Thus, when the rotary disk 14 rotates, large sliding resistance occurs between the seal members 17 and the upper housing 11 and between the seal members 18 and the fixed disk 13. In particular, the sliding resistance is greater when the rotary disk 14 starts to rotate. To overcome this sliding resistance, the output of the drive part 4 may be increased. In this case, however, the drive part 4 is increased in size and manufacturing cost. Therefore, to solve those issues, in the embodiment, the flow path switching device 1 is provided with a sliding resistance reducing structure for reducing the sliding resistance of each of the seal members 17, 18.

### Sliding Resistance Reducing Structure

In this embodiment, specifically, as shown in FIGS. 5, 6, and 8, a leading end portion 15a (a lower end portion in the figures) of the rotary shaft 15 is provided to be able to contact and engage with the fixed disk 13. The leading end portion 15a is provided with an engaging structure K1 (see FIG. 8) with respect to the fixed disk 13. The fixed disk 13 is configured to move reciprocally in the axial direction X when the leading end portion 15a of the rotary shaft 15 contacts and engages with the fixed disk 13 in association with rotation of the rotary shaft 15. The fixed disk 13 is provided, at its center on the upper surface, with an engaged structure K2 (see FIG. 9) with which the engaging structure K1 of the rotary shaft 15 engages. The sliding resistance reducing structure is constituted of the engaging structure K1 and the engaged structure K2.

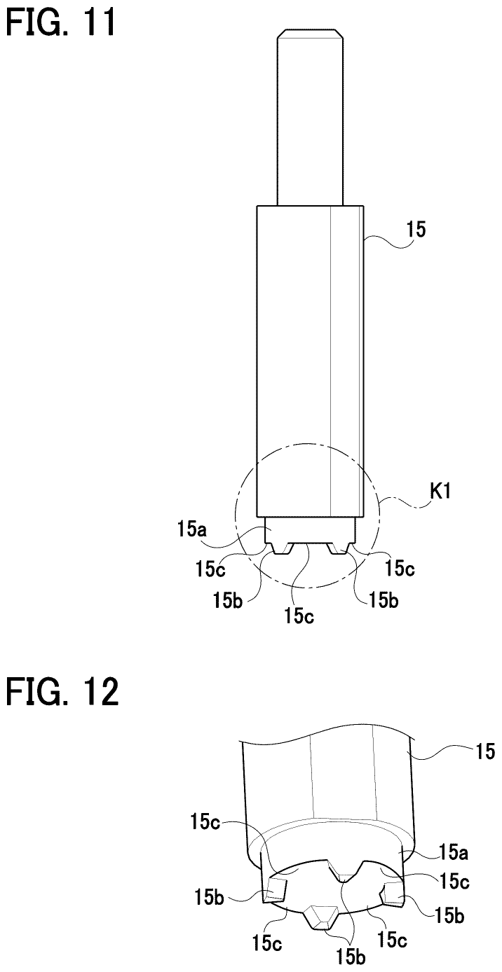

FIG. 10 is an enlarged view showing the engaged structure K2 of the fixed disk 13 shown in FIG. 9. FIG. 11 is a front view showing the rotary shaft 15. FIG. 12 is a perspective view showing a part enclosed by a dashed line in FIG. 11 corresponding to the engaging structure K1 (the leading end portion 15a). As shown in FIGS. 11 and 12, The distal end face (the lower end face) of the leading end portion 15a of the rotary shaft 15 is formed with a plurality of (four in this embodiment) protrusions (shaft protrusions) 15b, which are arranged along the outer peripheral edge thereof in the circumferential direction and each protrude downward in a chevron shape. Those shaft protrusions 15b are arranged alternately at equal angular intervals. Each shaft protrusion 15b has the shape that converges toward the top. A plurality of (four in this embodiment) shaft recesses 15c are each arranged between adjacent ones of the shaft protrusions 15b at equal angular intervals. Those shaft protrusions 15b and shaft recesses 15c constitute the engaging structure K1 of the rotary shaft 15.

On the other hand, the upper surface 13d of the fixed disk 13, with which the leading end portion 15a of the rotary shaft 15 contacts and engages, is formed at its center, as shown in FIG. 10, with a plurality of grooves (disk recesses) 13e arranged annularly and radially at equal angular intervals, with which the shaft protrusions 15b of the rotary shaft 15 contact and engage in association of rotation of the rotary shaft 15. Disk protrusions 13g are arranged at equal angular intervals, each between adjacent ones of the disk recesses 13e. Those disk recesses 13e and disk protrusions 13g are located in a depressed portion 13f, which is circular in plan view and formed at the center of the upper surface 13d of the fixed disk 13. Those disk recesses 13e and disk protrusion 13g constitute the engaged structure K2 of the fixed disk 13.

### Operations and Effects of Flow Path Switching Device

According to the configuration of the flow path switching device 1 in this embodiment described above, the valve body part 3 provided in the housing 2 includes the fixed disk 13 and the rotary disk 14, which are stacked vertically, and the rotary shaft 15. The valve body part 3 has a vertically stacked disk structure as above and thus enables complicated switching of flow paths with fewer components. Since the flow paths can be switched by simply rotating the rotary disk 14 to change the positions of the rotation communication paths 40. Therefore, there is no need to provide additional components for switching the flow paths. This allows the flow path switching device 1 to easily switch between various flow paths while ensuring a reduced size.

According to the configuration of this embodiment, each of the shaft protrusions 15b of the leading end portion 15a of the rotary shaft 15 is configured to engage with the disk recesses 13e of the fixed disk 13 and separate from the disk recesses 13e as the rotary shaft 15 rotates. Herein, the fixed disk 13 is biased by the spring 16 in a direction to come near the leading end portion 15a of the rotary shaft 15. Thus, when each of the shaft protrusions 15b becomes aligned with each of the disk recesses 13e from a state where each shaft protrusion 15b is not aligned with each of the disk recesses 13e, each shaft protrusion 15b engages with each of the disk recesses 13e and the fixed disk 13 is pushed up in the direction to come near the rotary disk 14 by the biasing force of the spring 16, so that the fixed disk 13 comes into contact with the lower seal member 18. In contrast, when each of the shaft protrusions 15b separates from the corresponding disk recess 13e and rides, or rides, on the disk protrusion 13g between the disk recess 13e and the disk recess 13e, the fixed disk 13 is pushed down in a direction to separate from the rotary disk 14 against the biasing force of the spring 16. The fixed disk 13 is thus separated from the lower seal member 18.

Herein, FIGS. 13 to 20 show in stages the operations of the sliding resistance reducing structure in the flow path switching device 1 when a flow path is shifted from a certain switching state to another switching state and the operations of the rotary shaft 15, rotary disk 14, and fixed disk 13 when the rotary shaft 15 rotates and accordingly the rotary disk 14 rotates.

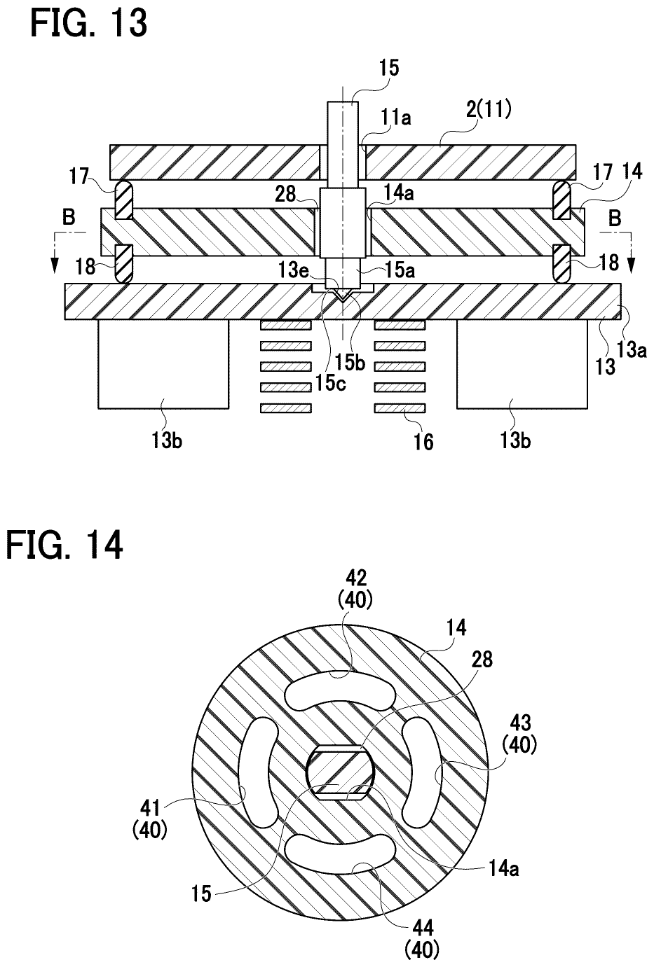

FIG. 13 is a simplified cross-sectional view showing a state before operation of the upper housing 11, the rotary disk 14, the fixed disk 13, the rotary shaft 15, and others. FIG. 14 is a cross-sectional view showing the rotary disk 14 and the rotary shaft 15 taken along a line B-B in FIG. 13. FIGS. 13 and 14 show a state where both the rotary disk 14 and the rotary shaft 15 are stopped, and the upper seal member 17 and the lower seral member 18 are in contact with the upper housing 11 and the fixed disk 13, respectively.

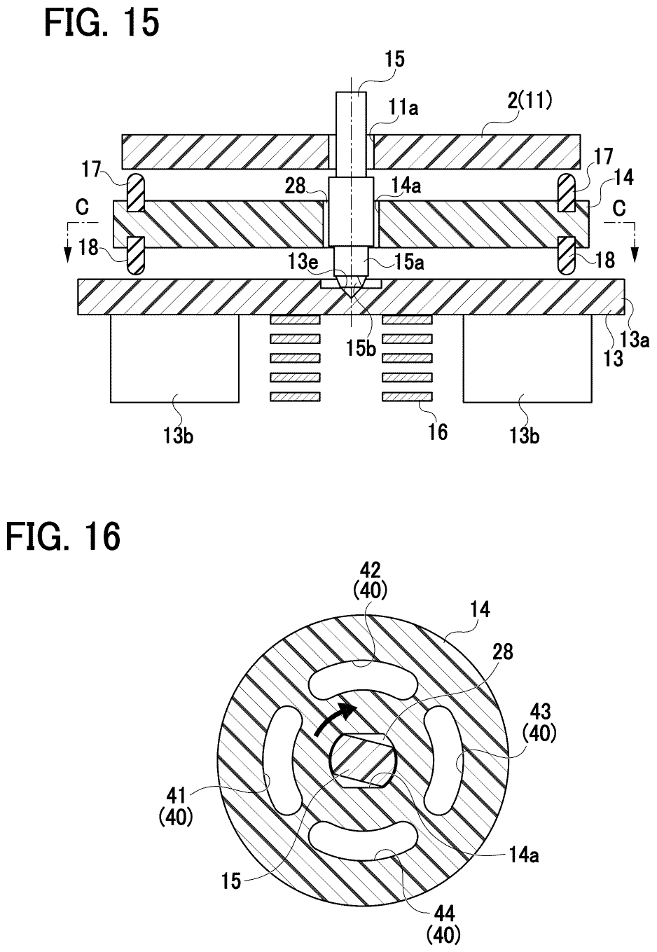

FIG. 15 is a simplified cross-sectional view showing an operation start state of the upper housing 11, the rotary disk 14, the fixed disk 13, the rotary shaft 15, and others, in which only the rotary shaft 15 starts to rotate. IG. 16 is a cross-sectional view showing the rotary disk 14 and the rotary shaft 15 taken along a line C-C in FIG. 15. FIGS. 15 and 16 show a state where only the rotary shaft 15 rotates by a predetermined angle in the through hole 14a, causing the leading end portion 15a of the rotary shaft 15 to push down the fixed disk 13 from a contact relationship of the shaft protrusions 15b and the disk recesses 13e. At that time, the shaft protrusions 15b separate from the disk recesses 13e and ride on the disk protrusions 13g each between adjacent ones of the disk recesses 13e, pushing down the fixed disk 13 against the biasing force of the spring 16, so that the upper seal member 17 separates from the upper housing 11 and the lower seal member 18 separates from the fixed disk 13.

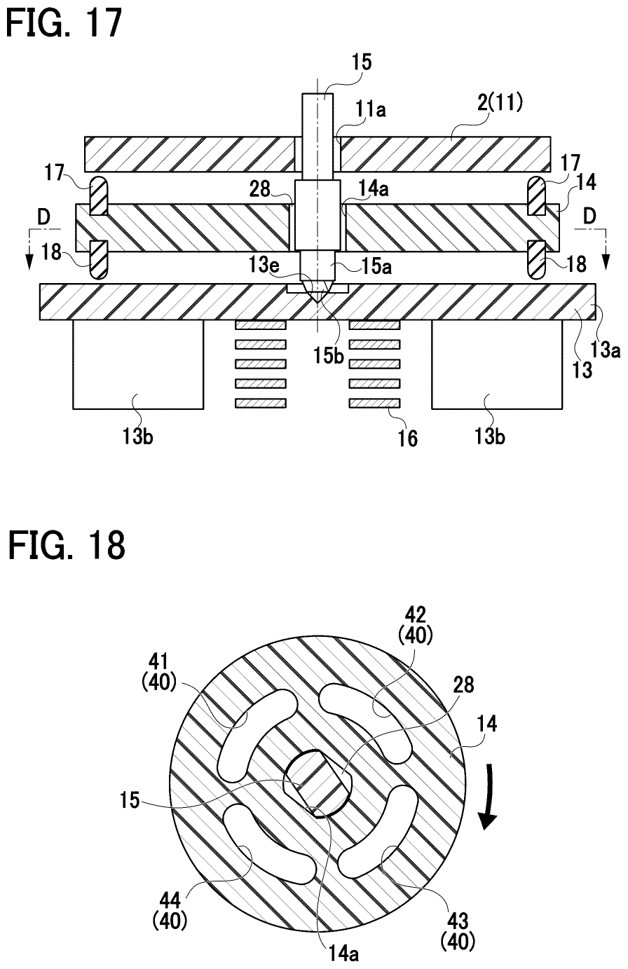

FIG. 17 is a simplified cross-sectional view showing an operation state of the upper housing 11, the rotary disk 14, the fixed disk 13, the rotary shaft 15, and others, in which the rotary disk 15 further rotates. FIG. 18 is a cross-sectional view showing the rotary disk 14 and the rotary shaft 15 taken along a line D-D in FIG. 17. FIGS. 17 and 18 show that when the rotary shaft 15 further rotates by a predetermined angle, the rotary disk 14 rotates together with the rotation communication paths 40. At that time, the rotary disk 14 rotates after the fixed disk 13 is pushed down. Thus, the spacing between the upper housing 11 and the fixed disk 13 and the spacing between the rotary disk 14 and the fixed disk 13 are widened, so that the sliding resistance of the upper seal member 17 and the lower seal member 18 during rotation of the rotary disk 14 is reduced and sliding wear of the upper and lower seal members 17, 18 are also decreased.

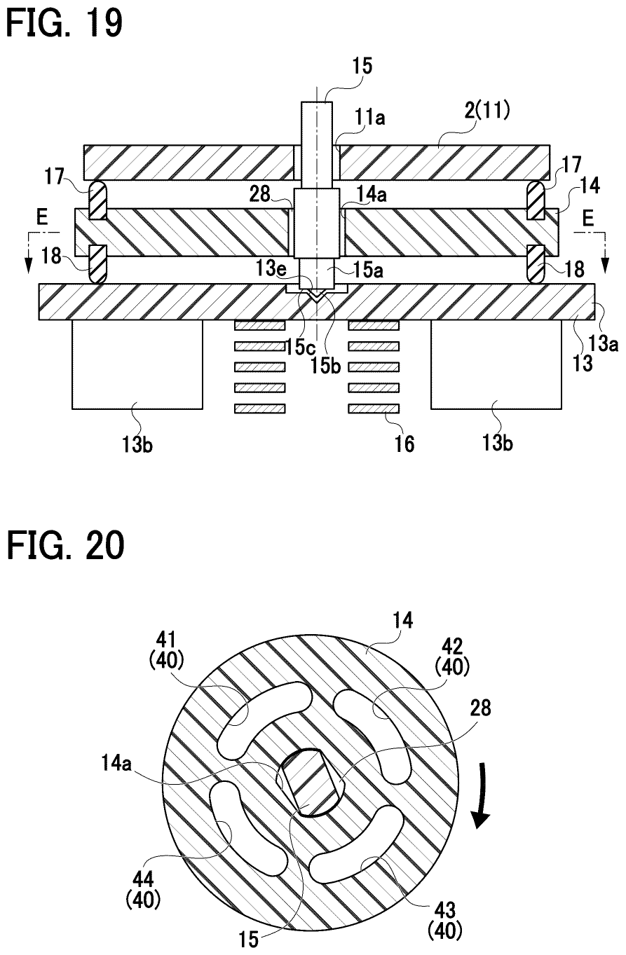

FIG. 19 is a simplified cross-sectional view showing an operation end state of the upper housing 11, the rotary disk 14, the fixed disk 13, the rotary shaft 15, and others after further rotation of the rotary shaft 15 and the rotary disk 14. FIG. 20 is a cross-sectional view showing the rotary disk 14 and the rotary shaft 15 taken along a line E-E in FIG. 19. FIGS. 19 and 20 show that when the rotary shaft 15 further rotates by a predetermined angle, the rotary disk 14 further rotates together with the rotation communication paths 40 by a predetermined angle. At that time, each of the shaft protrusions 15b of the rotary shaft 15 enters each of the disk recesses 13e of the fixed disk 13, and the fixed disk 13 is pushed up by the biasing force of the spring 16, causing the upper seal member 17 to contact with the upper housing 11 and the lower seal member 18 to contact the rotary disk 14.

According to the configuration of this embodiment, as described above, the rotary disk 14 rotates with respect to the fixed disk 13 when the rotary shaft 15 rotates. At that time, sliding resistance associated by the rotation of the rotary disk 14 is reduced on the lower seal member 18 between the fixed disk 13 and the rotary disk 14. Specifically, according to the above-described configuration, the leading end portion 15a of the rotary shaft 15 is provided to contact and engage with the fixed disk 13, and the fixed disk 13 is configured to reciprocally move in the axial direction by contacting and engaging with the leading end portion 15a of the rotary shaft 15 in association with rotation of the rotary shaft 15. Accordingly, when the rotary disk 14 rotates as the rotary shaft 15 rotates, the fixed disk 13 moves reciprocally in the axial direction X, widening the spacing between the upper housing 11 and the rotary disk 14 and the spacing between the fixed disk 13 and the rotary disk 14. This reduces the surface pressure on the upper seal member 17 between the upper housing 11 and the rotary disk 14 and the surface pressure on the lower seal member 18 between the fixed disk 13 and the rotary disk 14, so that the sliding resistance of each seal member 17, 18 is reduced. This can prevent sliding wear on each seal member 17, 18 or dislodgement of each seal member 17, 18 by drag when the rotary disk 14 rotates.

According to the configuration of this embodiment, the rotary disk 14 and the rotary shaft 15 are coupled with be relatively movable in the rotation direction and the axial direction X. Therefore, when the rotary disk 14 rotates and the surface pressure is applied on each of the seal members 17, 18, the rotary disk 14 moves in the rotation direction and the axial direction X within the spacing between the housing 2 and the fixed disk 13, and is disposed in balance with the reaction forces of the seal members 17, 18. This can further reduce the surface pressure on each of the seal members 17, 18 during the rotation of the rotary disk 14, and the durability of each seal member 17, 18 can be enhanced.

According to the configuration of this embodiment, in the axial direction X of the flow path switching device 1, the seal member 17 is provided between the housing 2 (the upper housing 11) and the rotary disk 14 and the seal member 18 is provided between the rotary disk 14 and the fixed disk 13. In the axial direction X, the seal members 17, 18 are provided respectively between the upper housing 11 and the rotary disk 14 and between the rotary disk 14 and the fixed disk 13, so that the rotary disk 14 is supported in a floating state by the upper seal member 17 and the lower seal member 18. Therefore, the floating effect during rotation of the rotary disk 14 can reduce the sliding resistance due to application of fluid pressure, and can prevent uneven wear of each seal member 17, 18 that ensures the sealing property of the rotation communication paths 40 and the fixed communication paths 50. These seal members 17, 18 can reliably prevent fluid leakage from the rotation communication paths 40 and fixed communication paths 50. This can ensure the sealing property of the flow paths formed by the inflow paths 20, rotation communication paths 40, and fixed communication paths 50.

According to the configuration of this embodiment, each seal member 17, 18 can also be used as an elastic member for retaining the postures of the fixed disk 13 and the rotary disk 14. Thus, no elastic member needs to be additionally provided, the number of components can be suppressed from increasing, and the flow path switching device 1 can be made compact. Furthermore, since the axial direction X of the fixed disk 13 and the rotary disk 14 coincides with the sealing direction of each seal member 17, 18, even if the central axis deviation occurs while the rotary disk 14 is rotationally driven, the sealing property can be ensured.

According to the configuration of this embodiment, the upper seal member 17 provided between the upper housing 11 and the rotary disk 14 and the lower seal member 18 provided between the rotary disk 14 and the fixed disk 13 are placed at the same position in the radial direction of the rotary disk 14. Thus, the rotation communication paths 40 are sealed at the same positions on both the upper end face 14b and the lower end face 14c of the rotary disk 14 by each seal member 17, 18, so that the area of the upper end face 14b and the area the lower end face 14c of the rotary disk 14 subjected to the action of fluid pressure are equal to each other. This cancels out the fluid pressure acting on the upper end face 14b and the lower end face 14c, and only the biasing force of the spring 16 acts on the rotary disk 14, retaining the posture of the rotary disk 14. This decreases the sliding resistance between the rotary disk 14 and the fixed disk 13 during rotation of the rotary disk 14. As a result, the power of the drive part 4 that drives the rotary disk 14 to rotate can be suppressed, resulting in a reduced power consumption of the drive part 4. Furthermore, the load imparted by the rotary disk 14 to each seal member 17, 18 is reduced, which improves the reliability of sealing property of each seal member 17, 18.

According to the configuration of this embodiment, furthermore, at least a part of the cylindrical part 13b of the fixed disk 13 is inserted in the outflow path 30. This can prevent positional displacement of the fixed disk 13 in the circumferential direction caused by rotational driving of the rotary disk 14. Further, the direction in which the rotary disk 14 may be axially displaced (that is, right and left directions intersecting the axial direction X) and the sealing direction of each seal member 17, 18 (that is, the axial direction X) are different from each other. Thus, even if the rotary disk 14 is axially displaced, the sealing property of each seal member 17, 18 can be maintained.

According to the configuration of this embodiment, the upper seal member 17 provided between the upper housing 11 and the rotary disk 14 and the lower seal member 18 provided between the rotary disk 14 and the fixed disk 13 are placed at the same positions in the radial direction of the 1rotary disk 14. Therefore, even if the rotary disk 14 tilts due to fluid pressure or other reasons, the repulsive force of each seal member 17, 18 can return the rotary disk 14 to a horizontal posture. Further, each seal member 17, 18 applies uniform surface pressure on the upper housing 11 and the fixed disk 13 in the horizontal direction while making a seal in the circumferential direction. Thus, each seal member 17, 18 is reduced in sliding resistance and subjected to uniform wearing. Therefore, the rotary disk 14 can be maintained in a horizontal state even after aging.

According to the configuration of this embodiment, the connection portion between the rotary shaft 15 and the rotary disk 14 (a portion of the rotary shaft 15 and a portion of the through hole 14a that correspond to each other) has the gap 28 in the rotation direction. Thus, when the rotary shaft 15 is rotated, the rotary shaft 15 idle-rotates by the gap 28 in the connection. This can set a state where the spacing between the upper housing 11 and the rotary disk 14 and the spacing between the fixed disk 13 and the rotary disk 14 are widened without rotating the rotary disk 14 even when the rotary shaft 15 rotates idle. As a result, a zone for widening the spacing between the upper housing 11 and the rotary disk 14 and the spacing between the fixed disk 13 and the rotary disk 14 can be provided before the rotary shaft 15 is rotationally driven.

### Second Embodiment

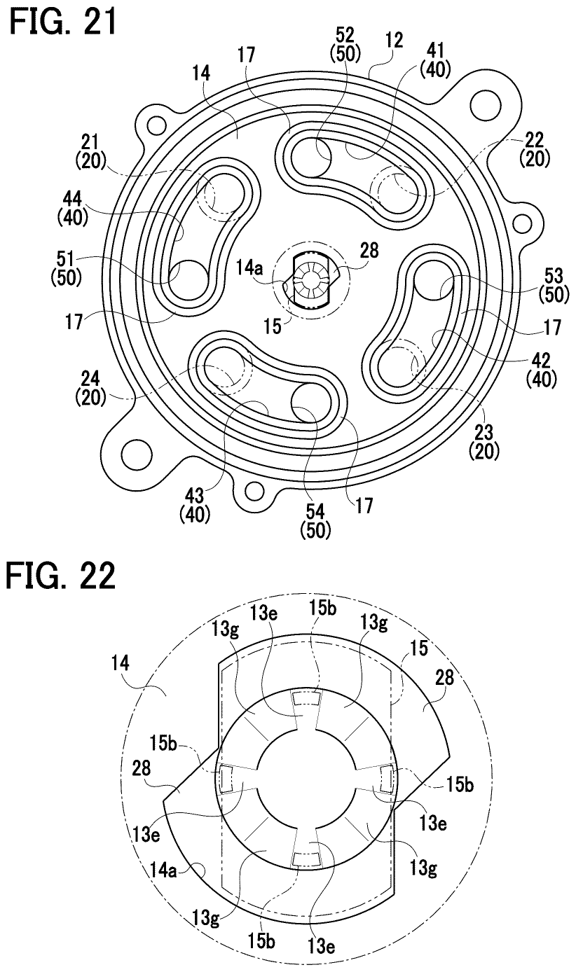

Next, a second embodiment will be described in detail below, referring to FIGS. 21 to 39D. In the following description, identical or similar elements to those in the first embodiment will be assigned the same reference signs as in the first embodiment and their details are omitted. The following description is given with a focus on differences from the first embodiment.

### Sliding Resistance Reducing Structure

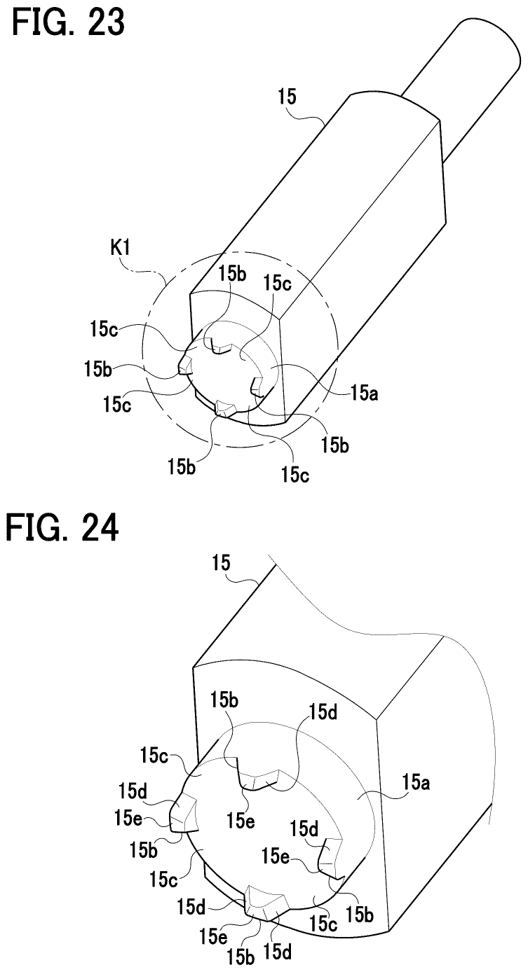

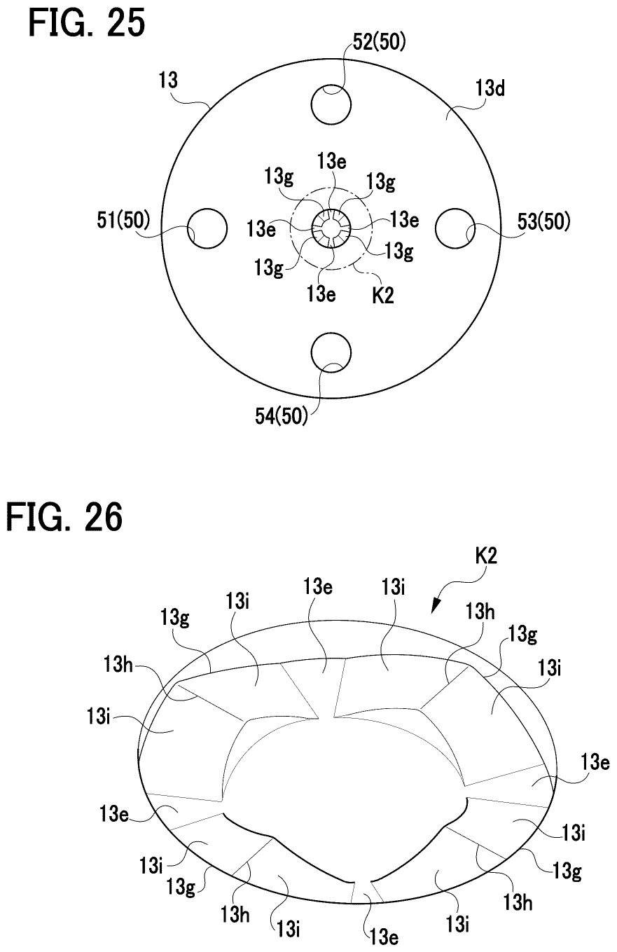

A flow path switching device 1 in this embodiment is identical in the outer appearance and the inner basic structure to that in the first embodiment, but differs from the first embodiment in the above-described “sliding resistance reducing structure”. FIG. 21 is a plan view showing the flow path switching device 1, from which the upper housing 11 and the drive part 14 are removed, in the second embodiment. FIG. 22 is an enlarged plan view showing a part (a part enclosed by a dashed line) corresponding to the through hole 14a and the rotary shaft 15 in FIG. 21. FIG. 23 is a perspective view showing the rotary shaft 15 in this embodiment. FIG. 24 is an enlarged perspective view showing the engaging structure K1 of a leading end portion of the rotary shaft 15 shown in FIG. 23. FIG. 25 is a plan view showing the fixed disk 13 in this embodiment. FIG. 26 is an enlarged perspective view showing the engaged structure K2 of the fixed disk 13 shown in FIG. 25.

In this embodiment, the fixed disk 13, rotary disk 14, rotary shaft 15, upper seal member 17, and lower seal member 18 are identical in basic structure to those in the first embodiment. As shown in FIGS. 21 to 26, however, the cross-sectional shape of the through hole 14a of the rotary disk 14, the shape of a part of the rotary shaft 15 that engages in the through hole 14a, the engaging structure K1 of the rotary shaft 15 and the engaged structure K2 of the fixed disk 13 differ from those in the first embodiment.

Specifically, the cross-sectional shape of the through hole 14a is a butterfly-wing shape with two fan shapes arranged rotationally symmetrically about the axis, as shown in FIG. 22. The cross-sectional shape of the part of the rotary shaft 15 that engages in the through hole 14a has a width across flat shape (an oval shape) that can revolve within the through hole 14a. In this embodiment, the connection portion between the rotary shaft 15 and the rotary disk 14 (the corresponding portions of the rotary shaft 15 and the through hole 14a) has predetermined gaps 28 between the rotary shaft 15 and the inner wall of the through hole 14a. When the rotary shaft 15 rotates by the drive power from the drive part 4, the rotary shaft 15 idle-rotates by the gap 28 in the through hole 14a, and further engages with the inner wall of the through hole 14a and integrally rotates together with the rotary disk 14.

As shown FIGS. 23 and 24, the engaging structure K1 provided in the leading end portion of the rotary shaft 15 has almost the same shape as that in the first embodiment, and includes four recesses (shaft recesses) 15c and four protrusions (shaft protrusion) 15b, which are arranged in the circumferential direction. The shaft protrusions 15b are arranged at equal angular (90°) intervals, forming the shaft recesses 15c between the shaft protrusions 15b. The shaft recesses 15c and the shaft protrusion 15b each include side surfaces 15d inclined in their circumferential direction (the arrangement direction). In this embodiment, the top portion 15e of each shaft protrusion 15b is formed with a protruding curved surface that protrudes outward, and includes side surfaces 15d inclined from the top portion 15e to both sides of the top portion 15e. The inclination angles of those side surfaces 15d are set equal. Those side surfaces 15d are also side surfaces of the shaft recesses 15c. Each shaft recess 15c has a flat surface on its bottom.

In contrast, as shown in FIGS. 25 and 26, the engaged structure K2 provided in the center of the upper surface 13d of the fixed disk 13 includes four protrusions (disk protrusions) 13g and four recesses (disk recesses) 13e, which can contact and engage with the shaft recesses 15c and the shaft protrusions 15b as the rotary shaft 15 rotates. The disk protrusions 13g are arranged at equal angular (90°) intervals, forming the disk recesses 13e between the disk protrusions 13g. In this embodiment, each disk protrusion 13g includes side surfaces 13i inclined from the top portion 13h to both sides of the top portion 13h in the circumferential direction (the arrangement direction). The inclination angles of those side surfaces 13i are set equal. Those side surfaces 13i are also side surfaces of the disk recesses 13e. Each disk recess 13e has a flat surface on its bottom.

### Switching of Flow Path Patterns

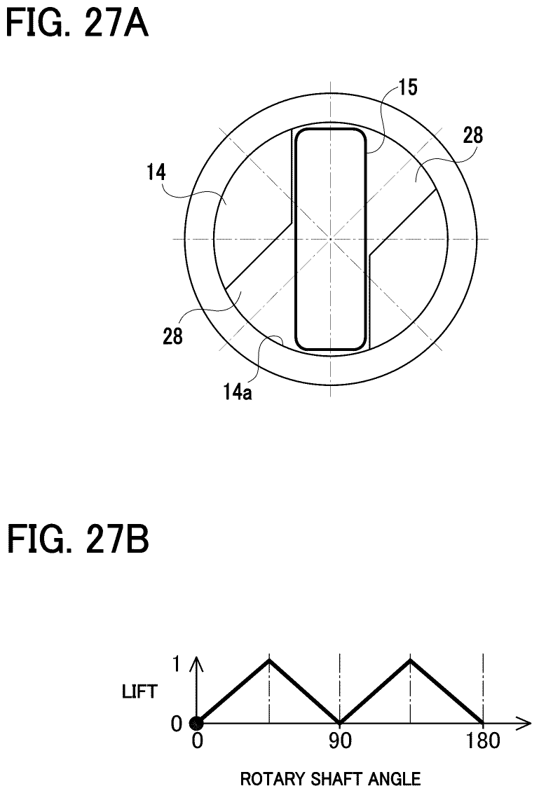

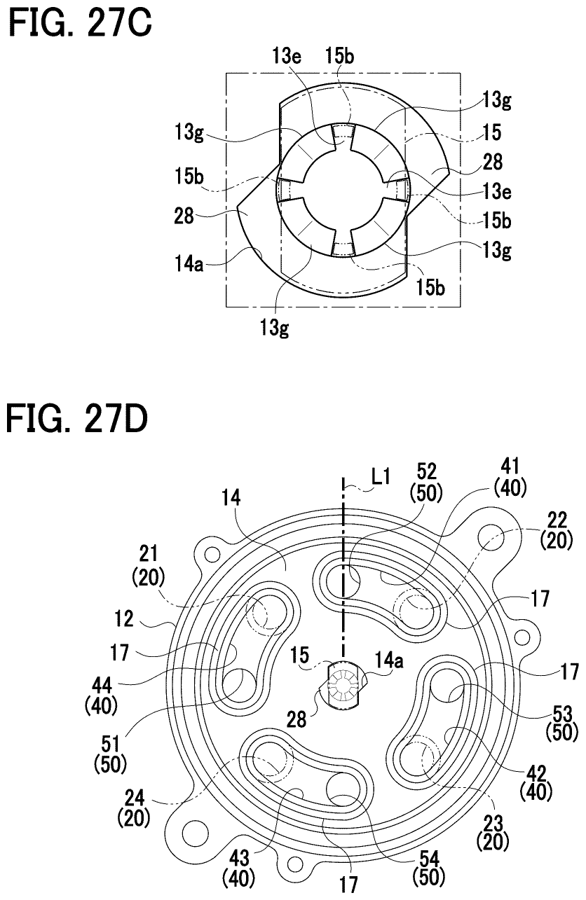

The flow path switching device 1 in this embodiment configured as above can switch a flow path for a fluid between four patterns. FIGS. 27A to 39D show operation diagrams related to switching of flow path patterns.

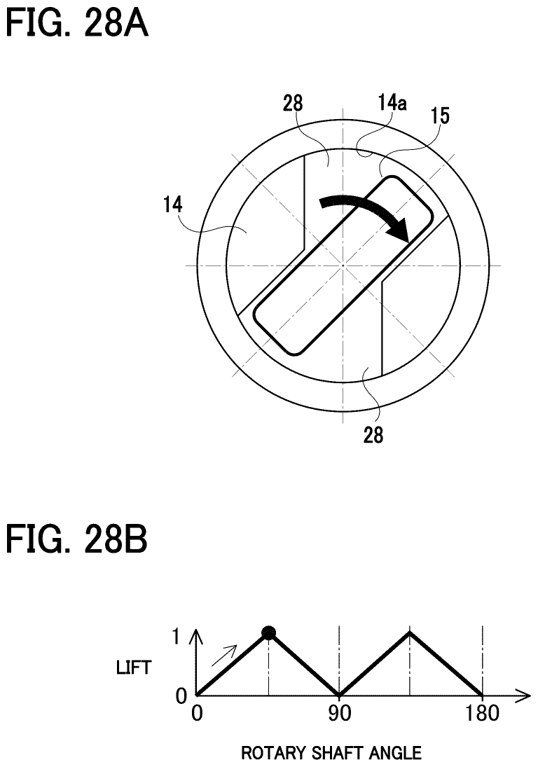

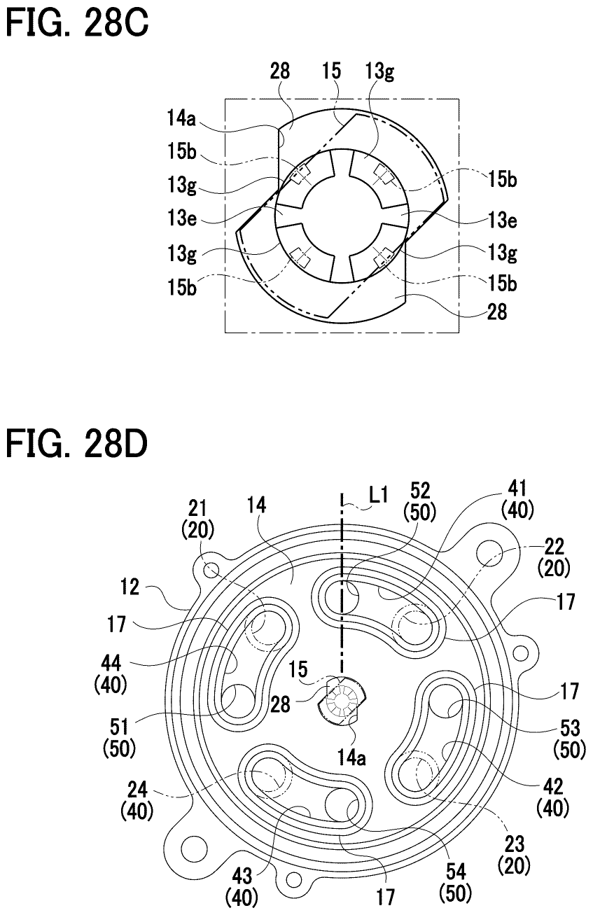

FIGS. 27A to 27D shows an “initial state” of the flow path switching device 1 in this embodiment; FIG. 27A is an image diagram showing an engagement relationship between the through hole 14a of the rotary disk 14 and the rotary shaft 15. FIGS. 28A, 29A, 30A, 31A, 32A, 33A, 34A, 35A, 36A, 37A, 38A, and 39A are image diagrams similar to FIG. 27A. FIG. 27B is an image diagram showing changes in lifting (pushing-up) of the rotary shaft 15 relative to the rotating angle of the rotary shaft 15 (the rotary shaft angle). In FIG. 27B, the peaks and the valleys of the thick line correspond to the disk protrusions 13g and the disk recesses 13e respectively, and the black point corresponds to the position of the shaft protrusion 15b (the same applies to similar figures described below). FIGS. 28B, 29B, 30B, 31B, 32B, 33B, 34B, 35B, 36B, 37B, 38B, and 39B are image diagrams similar to FIG. 27B. FIG. 27C is a plan diagram showing the rotational positions of the through hole 14a and the rotary shaft 15, and the relationship between the disk protrusions 13g and the disk recesses 13e and the shaft protrusions 15b. FIGS. 28C, 29C, 30C, 31C, 32C, 33C, 34C, 35C, 36C, 37C, 38C, and 39C are plan diagrams similar to FIG. 27C. FIG. 27D is a plan diagram, similar to FIG. 21, showing the rotational positions of the rotary disk 14 and the rotation communication paths 40. In FIG. 27D, the basic line L1 indicated by a thick dashed line represents a reference position in the rotary disk 14 (the same applies to similar figures described later). FIGS. 28D, 29D, 30D, 31D, 32D, 33D, 34D, 35D, 36D, 37D, 38D, and 39D are plan diagrams similar to FIG. 27D.

In this “initial state”, as shown FIG. 27A, the rotary shaft 15 engages with one of the inner walls of the through hole 14a, and the rotary shaft 15 is in a lift-down position as shown in FIG. 27B. Further, as shown in FIG. 27C, the shaft protrusions 15b ride down, i.e., lower, into the disk recesses 13e. Furthermore, the rotary disk 14 and the rotation communication paths 40 are disposed in a state shown in FIG. 27D. At that time, the first rotation communication path 41 communicates with the second inflow path 22 and the second fixed communication path 52, the second rotation communication path 42 communicates with the third inflow path 23 and the third fixed communication path 53, the third rotation communication path 43 communicates with the fourth inflow path 24 and the fourth fixed communication path 54, and the fourth rotation communication path 44 communicates with the first inflow path 21 and the first fixed communication path 51. The rotating angle of the rotary disk 14 (the disk rotating angle) is defined as 0°, and this switching state of flow paths is defined as a “pattern A”.

Next, changes from the “initial state” will be described in sequence. FIGS. 28A to 28D show a “45° rotational state” to which the rotary shaft 15 rotates 45° clockwise from the “initial state”. In this state, as shown in FIG. 28A, the rotary shaft 15 idle-rotates 45° clockwise from the “initial state” and engages with the other inner wall of the through hole 14a, and the rotary shaft 15 lifts up as shown in FIG. 28B. Further, as shown in FIG. 28C, the shaft protrusions 15b ride on the disk protrusions 13g. Still further, as shown in FIG. 28D, the disk rotating angle remains 0°, and the flow path switching state of the rotation communication paths 40 is the pattern A, which is the same in the “initial state”.

In this embodiment, as described above, when shifting the leading end portion of the rotary shaft 15 from the state of engagement with the fixed disk 13 to the state of contact with the fixed disk 13, that is, when causing the shaft protrusions 15b to ride on the disk protrusions 13g from the disk recesses 13e, the “idle-rotating angle” to idle-rotate the rotary shaft 15 clockwise is set to 45°. In this embodiment, further, in the “initial state” shown in FIG. 27A, a “one-way idle-rotating type” that the rotary shaft 15 can idle-rotate clockwise only.

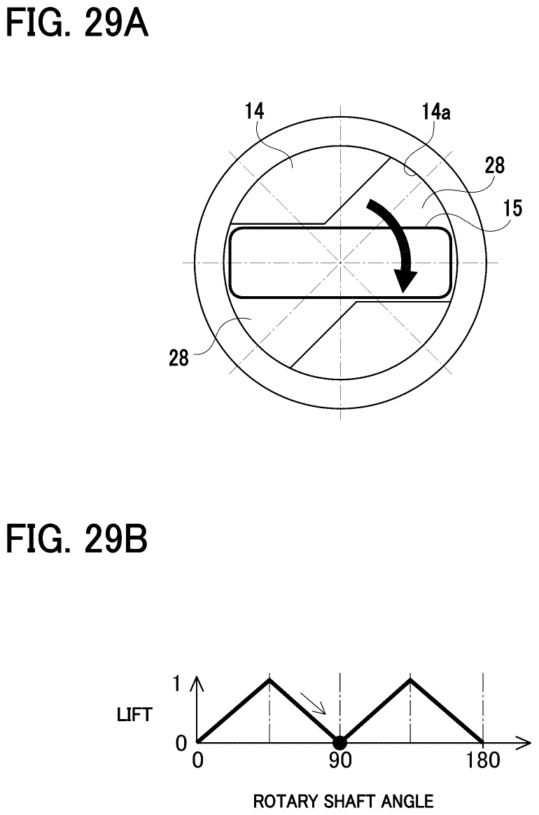

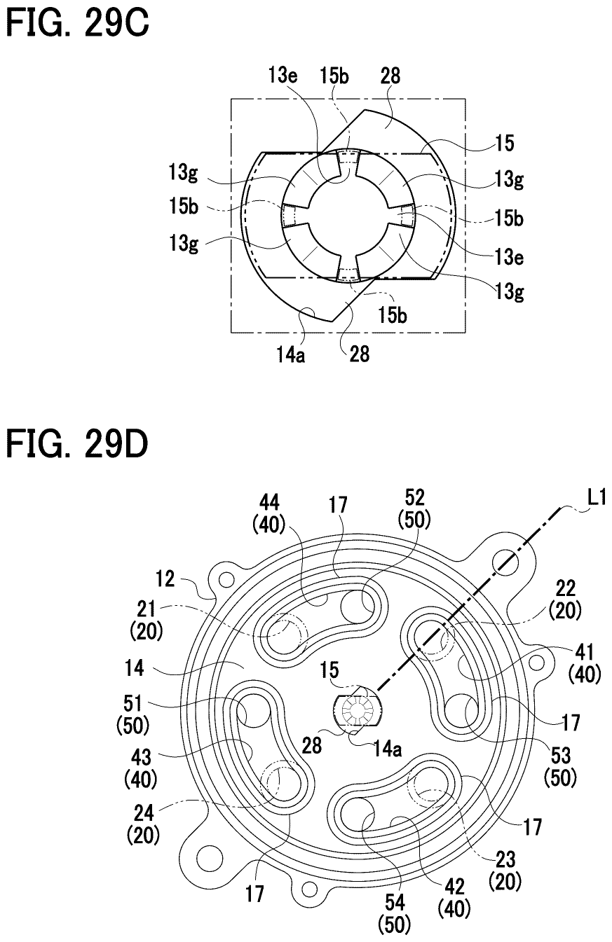

Next, FIGS. 29A to 29D show a “90° rotational state” to which the rotary shaft 15 further rotates 45° clockwise from the “45° rotational state”. In this state, as shown in FIG. 29A, the rotary shaft 15 rotates 45° clockwise together with the rotary disk 14, and the rotary shaft 15 lift up as shown in FIG. 29B. Further, as shown in FIG. 29C, the shaft protrusions 15b are lifted down in the disk recesses 13e. Still further, as shown in FIG. 29D, the rotation communication paths 40 are rotated 45° clockwise. In this “90° rotational state”, the first rotation communication path 41 communicates with the second inflow path 22 and the third fixed communication path 53, the second rotation communication path 42 communicates with the third inflow path 23 and the fourth fixed communication path 54, the third rotation communication path 43 communicates with the fourth inflow path 24 and the first fixed communication path 51, and the fourth rotation communication path 44 communicates with the first inflow path 21 and the second fixed communication path 52. The disk rotating angle at that time is 45°, and this flow path switching state is defined as a “pattern B”. That is, between the “45° rotational state” and the “90° rotational state”, lifting down of the rotary shaft 15 and switching of the flow paths are performed simultaneously.

In this embodiment, as described above, the “switching angle” for rotating the rotary disk 14 to switch the flow paths of the flow path switching device 1 is set to 45°. In this embodiment, specifically, the clockwise “idle-rotating angle” of the rotary shaft 15 and the “switching angle” of the rotary disk 14 to switch the flow paths are set to the same 45°.

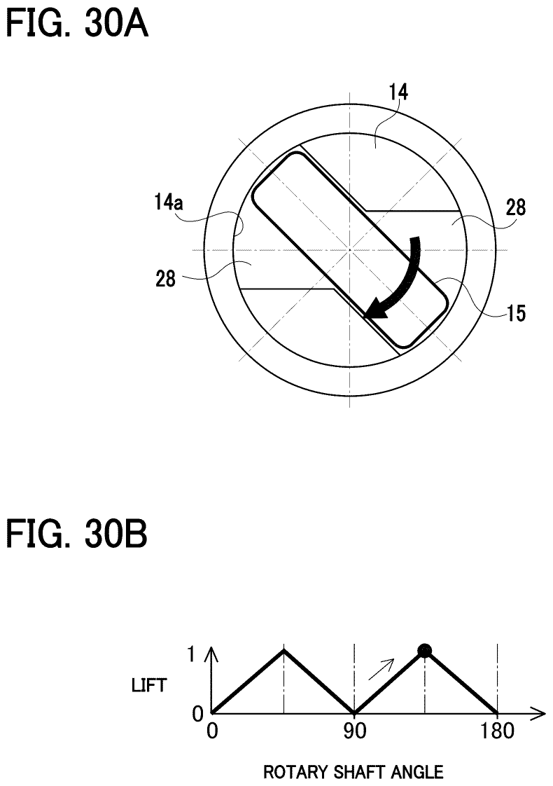

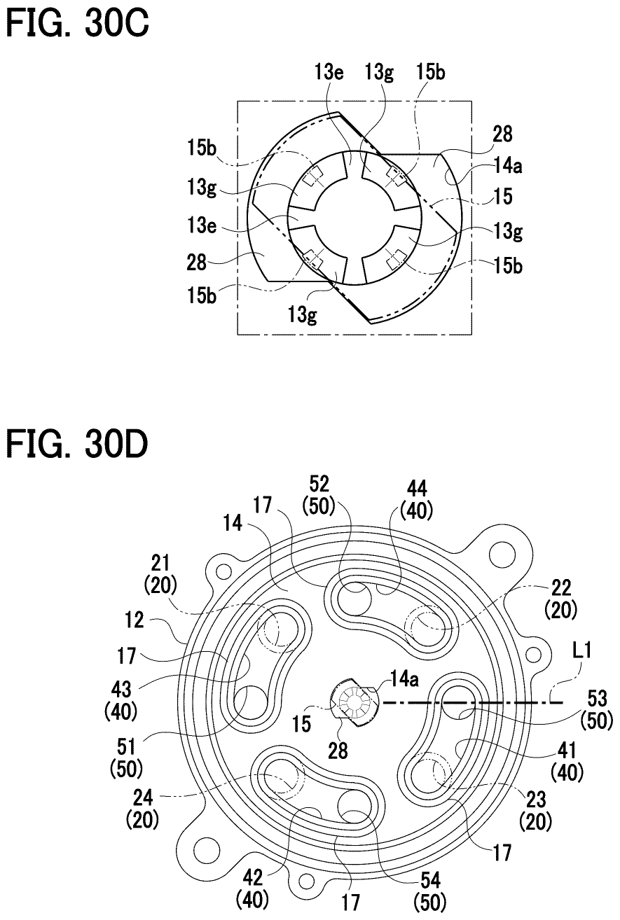

Next, FIGS. 30A to 30D show a “135° rotational state” to which the rotary shaft 15 further rotates 45° clockwise from the “90° rotational state”. In this state, as shown in FIG. 30A, the rotary shaft 15 rotates 45° clockwise together with the rotary disk 14, and the rotary shaft 15 lifts up as shown in FIG. 30B. Further, as shown in FIG. 30C, the shaft protrusions 15b ride on the disk protrusions 13g. Still further, as shown in FIG. 30D, the rotation communication paths 40 are rotated 45° clockwise. In this “135° rotational state”, the first rotation communication path 41 communicates with the third inflow path 23 and the third fixed communication path 53, the second rotation communication path 42 communicates with the fourth inflow path 24 and the fourth fixed communication path 54, the third rotation communication path 43 communicates with the first inflow path 21 and the first fixed communication path 51, and the fourth rotation communication path 44 communicates with the second inflow path 22 and the second fixed communication path 52. The disk rotating angle at that time is 90°, and this flow path switching state is defined as a “pattern C”. That is, between the “90° rotational state” and the “135° rotational state”, lifting up of the rotary shaft 15 and switching of the flow paths are performed simultaneously.

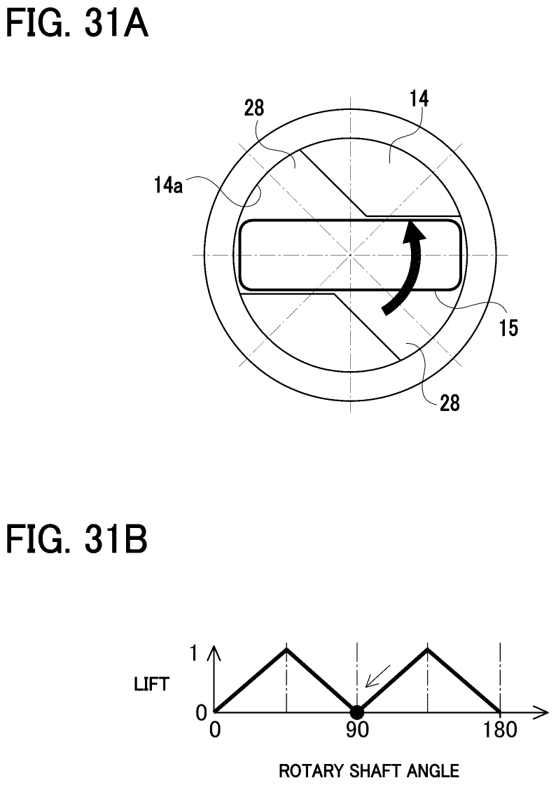

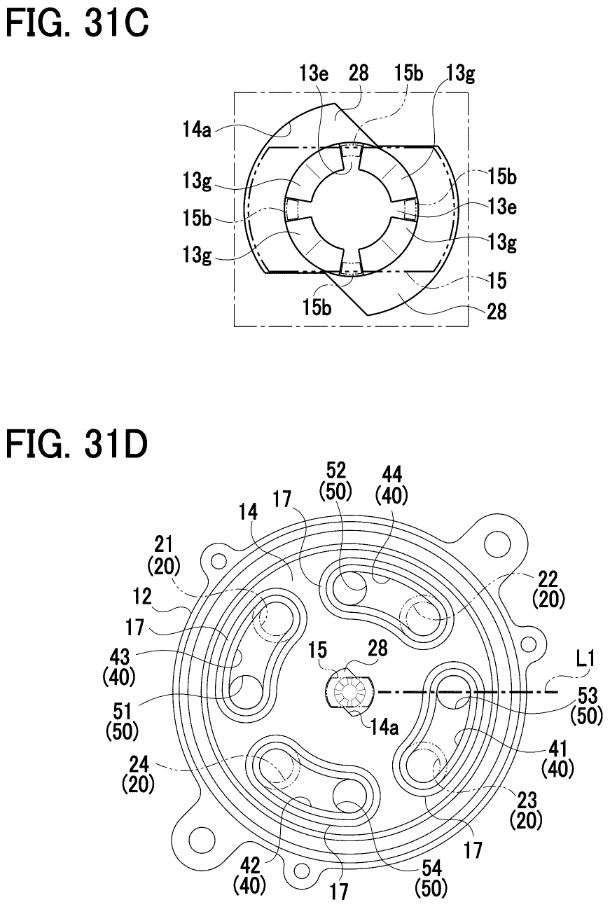

Next, FIGS. 31A to 31D show a “return-90° rotational state” to which the rotary shaft 15 rotates 45° counterclockwise from the “135° rotational state”. In this state, as shown in FIG. 31A, the rotary shaft 15 idle-rotates 45° counterclockwise and engages with one inner wall of the through hole 14a, and the rotary shaft 15 lifts down as shown in FIG. 31B. Further, as shown in FIG. 31C, the shaft protrusions 15b ride down into the disk recesses 13e. Still further, as shown in FIG. 31D, the rotation communication paths 40 stay at the same positions as the “135° rotational state”, and the disk rotating angle remains 90°. The flow path switching state at that time is the same “pattern C” as in the “135° rotational state”.

In this embodiment, as described above, the “idle-rotating angle” to idle-rotate the rotary shaft 15 counterclockwise to cause the shaft protrusions 15b to ride down from the disk protrusions 13g into the disk recesses 13e is also set to 45°. In this embodiment, specifically, the counterclockwise “idle-rotating angle” of the rotary shaft 15 and the “switching angle” of the rotary disk 14 to switch flow paths are set to the same 45°.

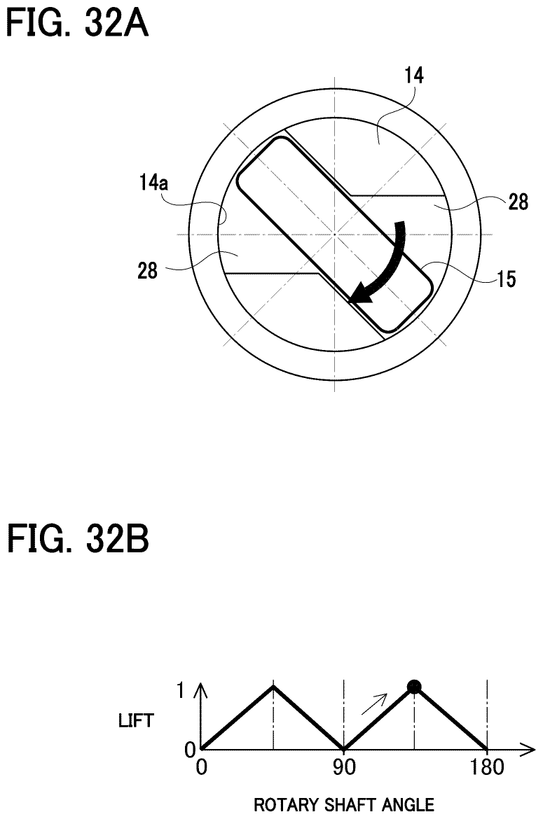

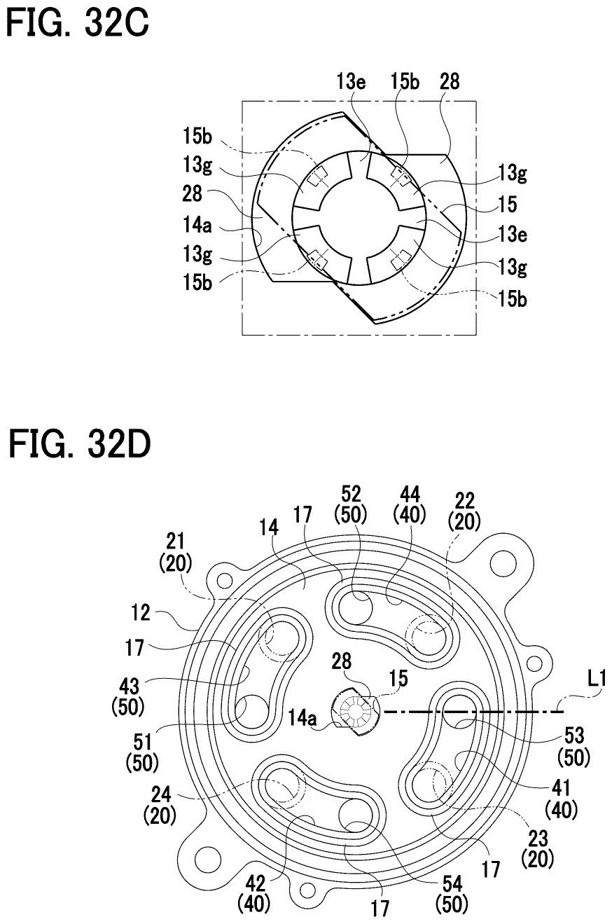

Next, FIG. 32A to 32D show a “re-135° rotational state” to which the rotary shaft 15 rotates 45° clockwise from the “return-90° rotational state”. In this state, as shown in FIG. 32A, the rotary shaft 15 idle-rotates 45° clockwise and engages with the other inner wall of the through hole 14a, and the rotary shaft 15 lifts up as shown in FIG. 32B. Still further, as shown in FIG. 32C, the shaft protrusions 15b ride on the disk protrusions 13g. Furthermore, as shown in FIG. 32D, the rotation communication paths 40 stay at the same positions as in the “return-90° rotational state”, and the disk rotating angle remains 90°. The flow path switching state at that time is the “pattern C”.

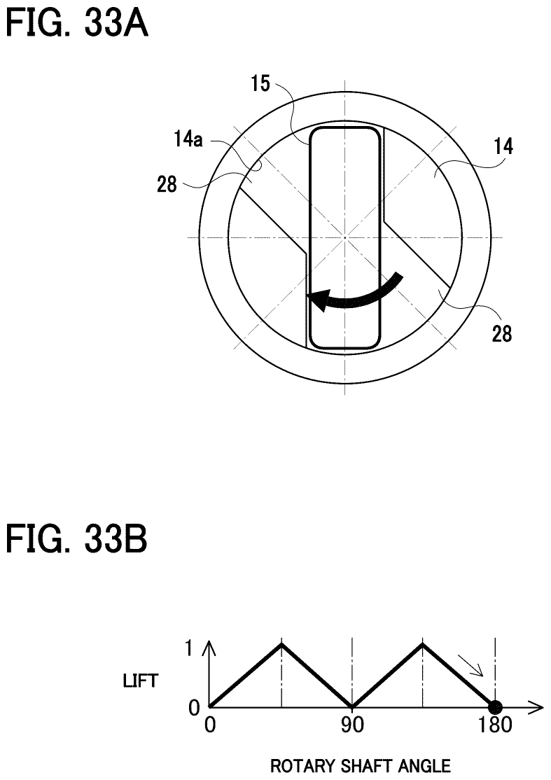

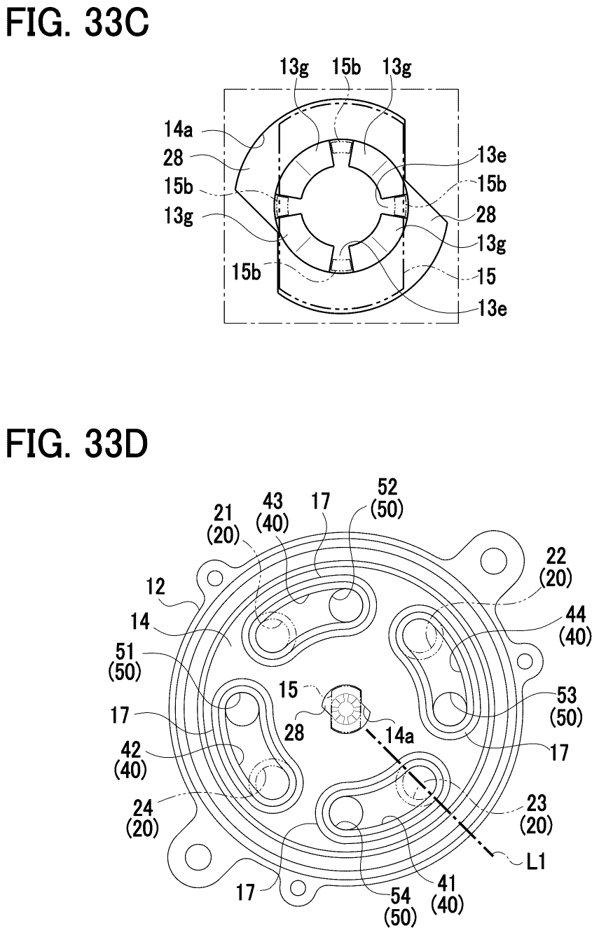

Next, FIG. 33A to 33D show a “180° rotational state” to which the rotary shaft 15 rotates 45° clockwise from the “re-135° rotational state”. In this state, as shown in FIG. 33A, the rotary shaft 15 rotates 45° clockwise together with the rotary disk 14, and the rotary shaft 15 lifts down as shown in FIG. 33B. Further, as shown in FIG. 33C, the shaft protrusions 15b ride down into the disk recesses 13e. Still further, as shown in FIG. 33D, the rotation communication paths 40 are further rotated 45° clockwise. In this “180° rotational state”, the first rotation communication path 41 communicates with the third inflow path 23 and the fourth fixed communication path 54, the second rotation communication path 42 communicates with the fourth inflow path 24 and the first fixed communication path 51, the third rotation communication path 43 communicates with the first inflow path 21 and the second fixed communication path 52, and the fourth rotation communication path 44 communicates with the second inflow path 22 and the third fixed communication path 53. The disk rotating angle at that time is 135°, and this flow path switching state is defined as a “pattern D”. Specifically, between the “re-135° rotational state” and the “180° rotational state”, lifting down of the rotary shaft 15 and switching of the flow paths are performed simultaneously.

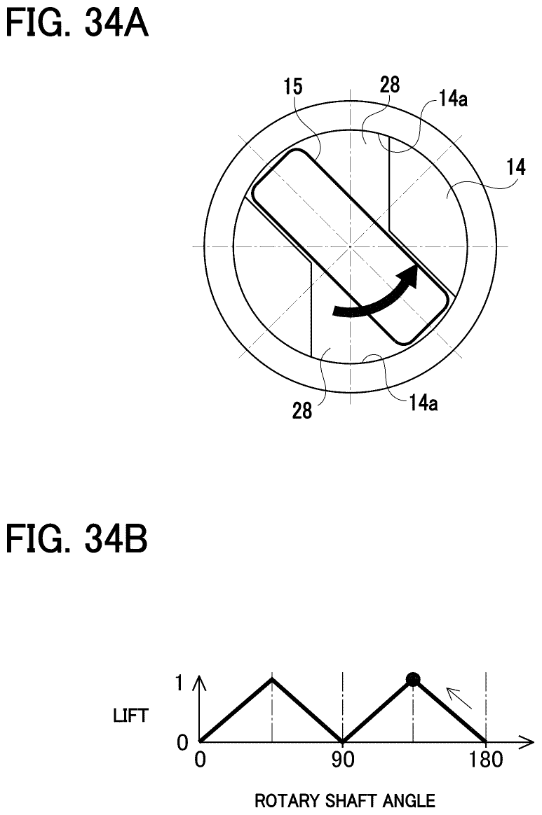

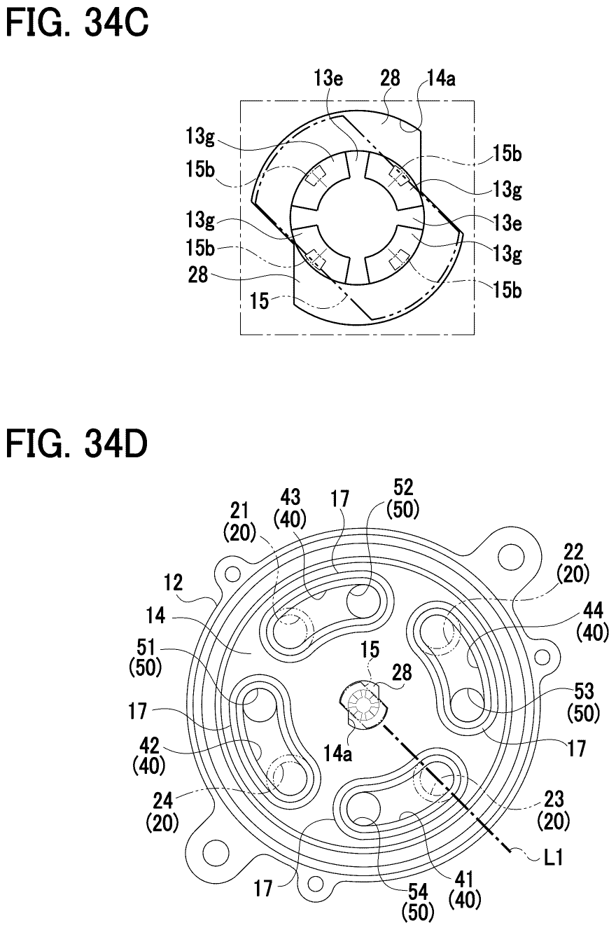

Next, FIGS. 34A to 34D show a “re-135° rotational state” to which the rotary shaft 15 rotates 45° counterclockwise from the “180° rotational state”. In this state, as shown in FIG. 34A, the rotary shaft 15 idle-rotates 45° counterclockwise and engages with one inner wall of the through hole 14a, and the rotary shaft 15 lifts up as shown in FIG. 34B. Further, as shown in FIG. 34C, the shaft protrusions 15b ride on the disk protrusions 13g. Further, as shown in FIG. 34D, the rotation communication paths 40 stay at the same position as in the “180° rotational state”, and the disk rotating angle remains 135°. The flow path switching state at that time is the same “pattern D” as in the “180° rotational state”.

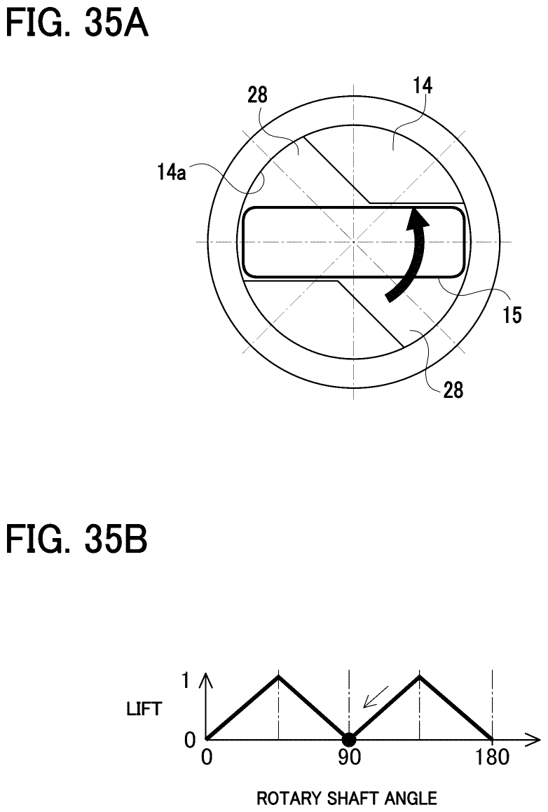

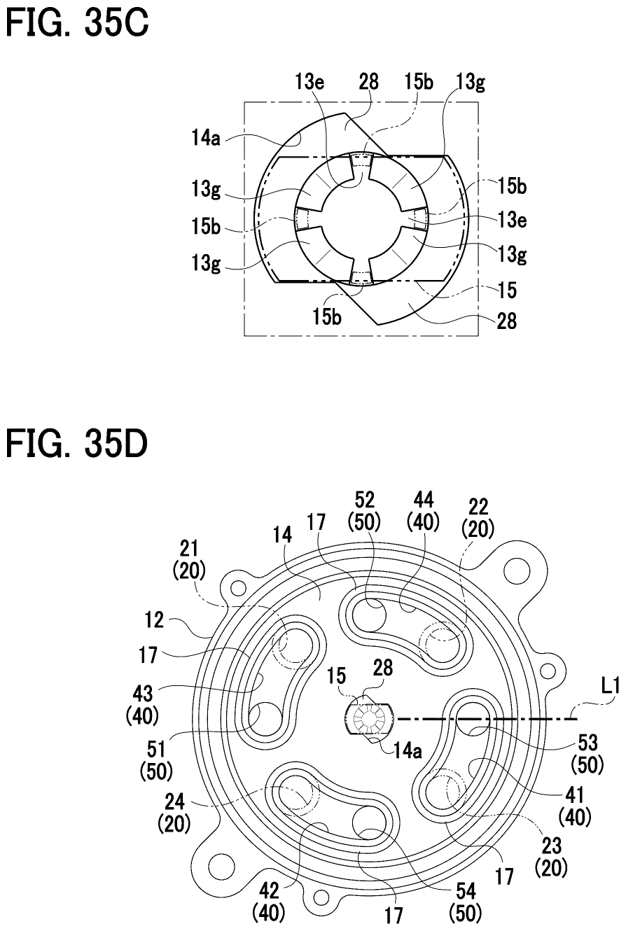

Next, FIGS. 35A to 35D show the “re-90° rotational state” to which the rotary shaft 15 rotates 45° counterclockwise from the “135° rotational state”. In this state, as shown in FIG. 35A, the rotary shaft 15 rotates 45° counterclockwise together with the rotary disk 14, and the rotary shaft 15 lifts down as shown in FIG. 35B. Further, as shown in FIG. 35C, the shaft protrusions 15b ride down into the disk recesses 13e. Further, as shown in FIG. 35D, the rotation communication paths 40 are at the same positions as in the “re-135° rotational state”, and the disk rotating angle is 90°. The flow path switching state at that time is the same “patten C” as in the “re-135° rotational state”. Specifically, between the “return-135° rotational state” and the “return-90° rotational state”, lifting down of the rotary shaft 15 and switching of the flow paths are performed simultaneously.

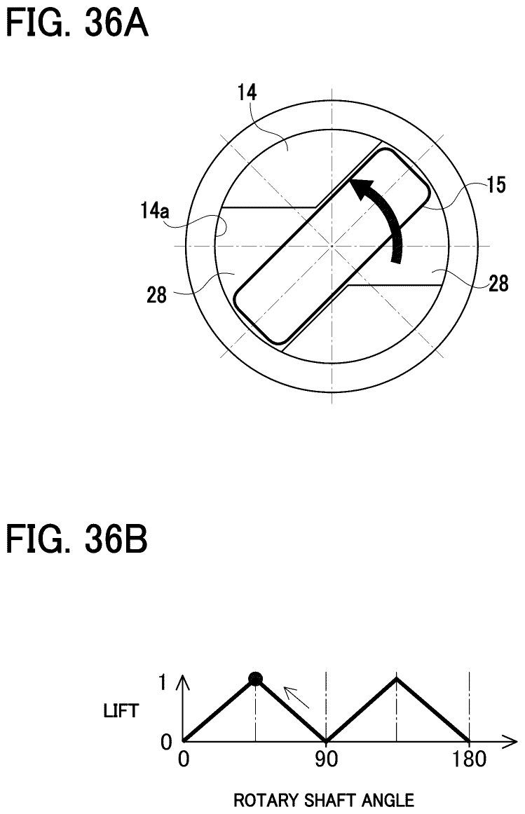

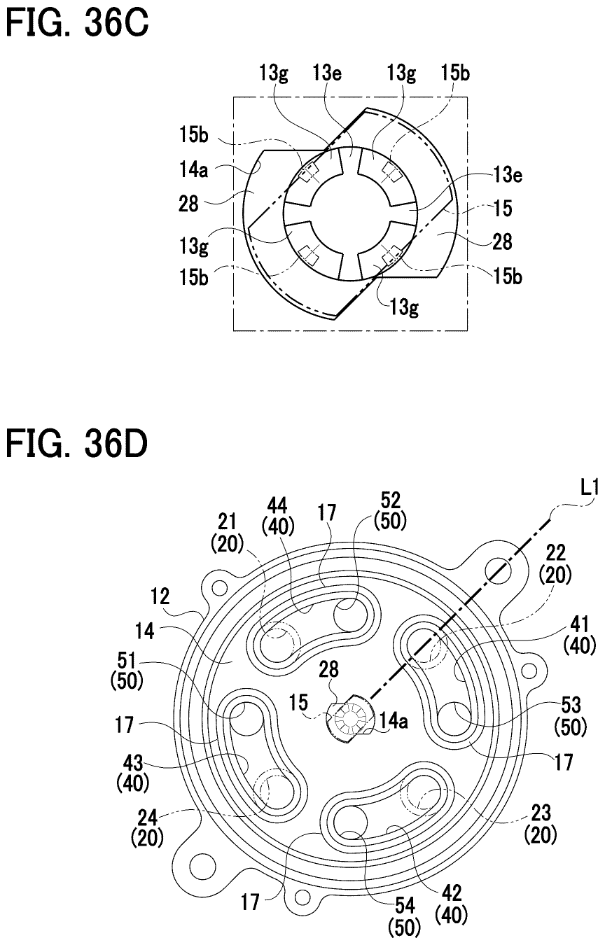

Next, FIGS. 36A to 36D show a “return-45° rotational state” to which the rotary shaft 15 further rotates 45° counterclockwise from the “return-90° rotational state”. In this state, as shown in FIG. 36A, the rotary shaft 15 rotates 45° counterclockwise together with the rotary disk 14, and the rotary shaft 15 lifts up as shown in FIG. 36B. Further, as shown in FIG. 36C, the shaft protrusions 15b ride on the disk protrusions 13g. Furthermore, as shown in FIG. 36D, the rotation communication paths 40 are positioned at the same positions as in the “90° rotational state”, and the disk rotating angle is 45°. The flow path switching state at that time is the same “pattern B” as in the “90° rotational state”. Specifically, between the “return-90° rotational state” and the “return-45° rotational state”, lifting up of the rotary shaft 15 and switching of the flow paths are performed simultaneously.

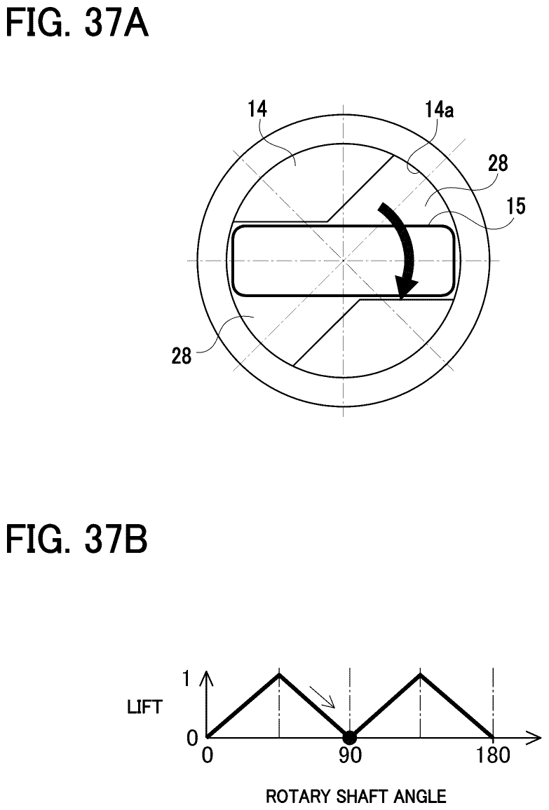

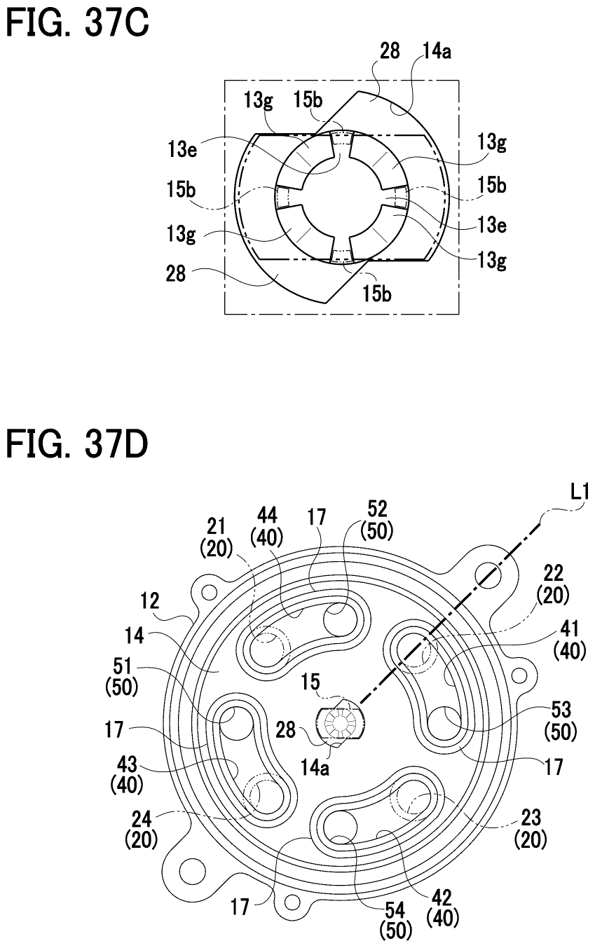

Next, FIGS. 37A to 37D show a “re-90° rotational state” to which the rotary shaft 15 rotates 45° clockwise from the “return-45° rotational state”. In this state, as shown in FIG. 37A, the rotary shaft 15 idle-rotates 45° clockwise and engages with the other inner wall of the through hole 14a, and the rotary shaft 15 lifts down as shown in FIG. 37B. Further, as shown in FIG. 37C, the shaft protrusions 15b ride down into the disk recesses 13e. Furthermore, as shown in FIG. 37D, the rotation communication paths 40 stay at the same positions as in the “return-45° rotational state”, and the disk rotating angle remains 45°. The flow path switching state at that time is the same “pattern B” as in the “return-45° rotational state”.

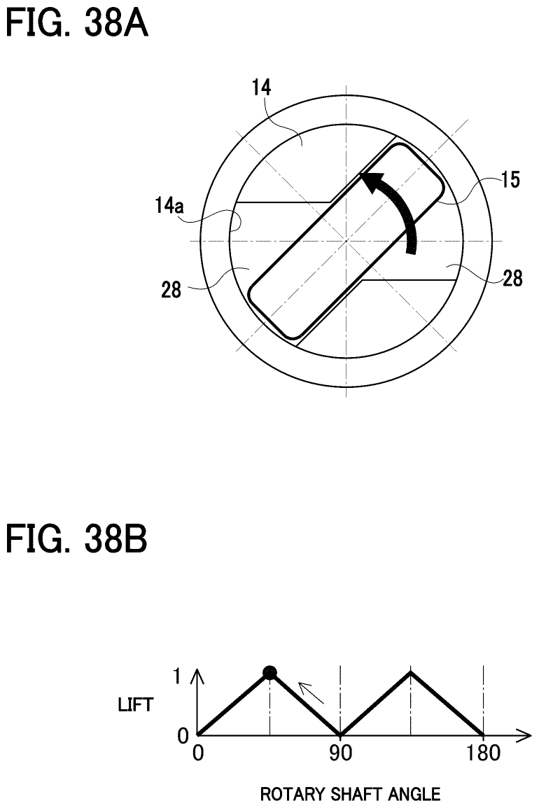

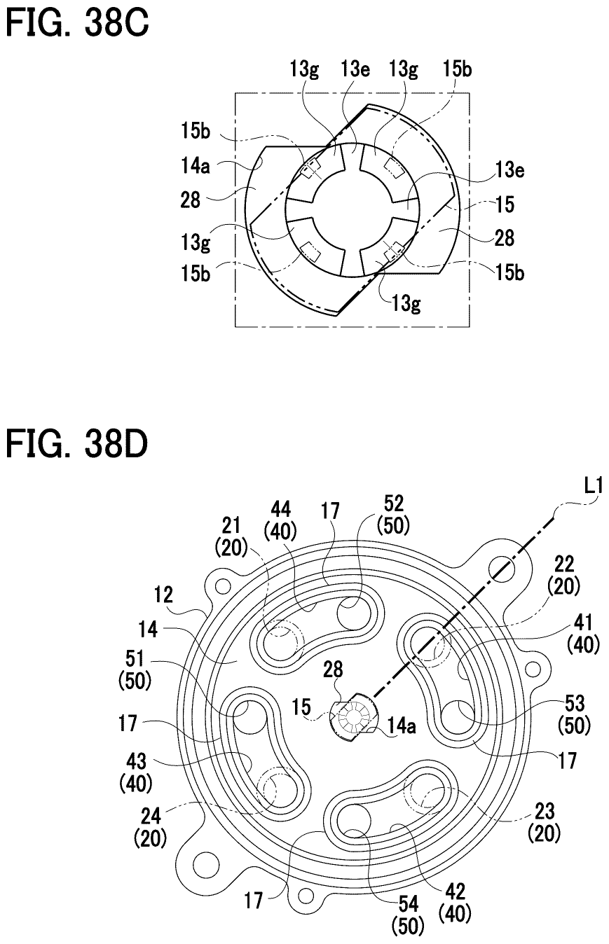

Next, FIGS. 38A to 38D show the “return-45° rotational state” to which the rotary shaft 15 rotates 45° counterclockwise from the “re-90° rotational state”. In this state, as shown in FIG. 38A, the rotary shaft 15 idle-rotates 45° counterclockwise and engages with one inner wall of the through hole 14a, and the rotary shaft 15 lifts up as shown in FIG. 38B. Further, as shown in FIG. 38C, the shaft protrusions 15b ride on the disk protrusions 13g. Furthermore, as shown in FIG. 38D, the rotation communication paths 40 stay at the same positions as in the “re-90° rotational state”, and the disk rotating angle remains 45°. The flow path switching state at that time is the “pattern B”.

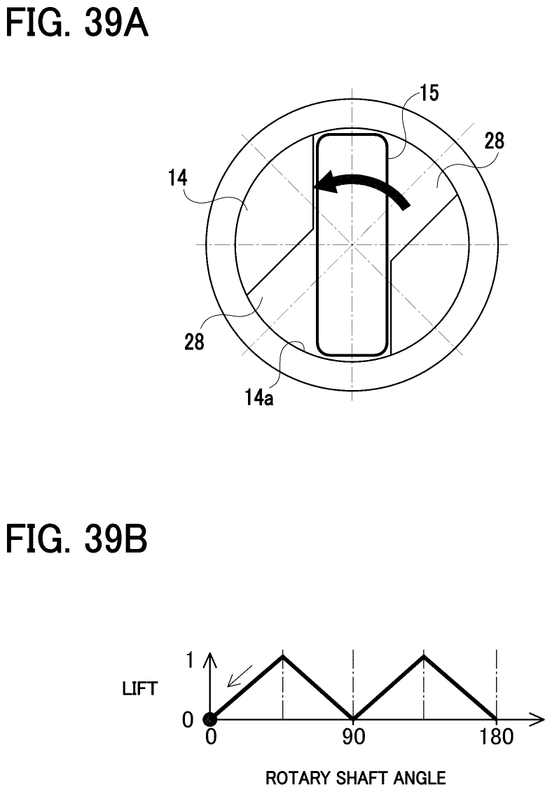

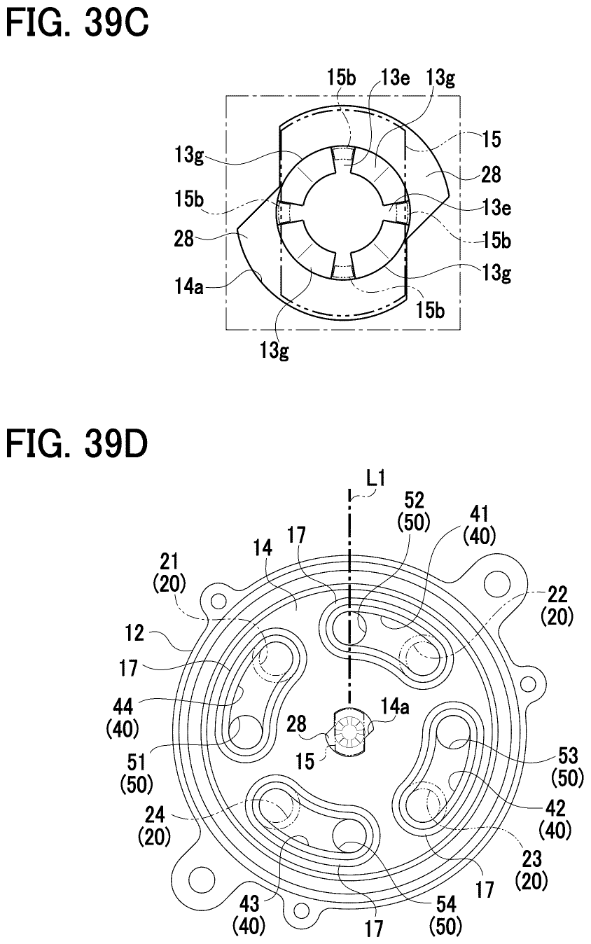

Then, FIGS. 39A to 39D show a “return-initial state” to which the rotary shaft 15 rotates 45° counterclockwise from the “return-45° rotational state”. In this state, as shown in FIG. 39A, the rotary shaft 15 rotates 45° counterclockwise together with the rotary disk 14, and the rotary shaft 15 lifts down as shown in FIG. 39B. Further, as shown in FIG. 39C, the shaft protrusions 15b ride down into the disk recesses 13e. Furthermore, as shown in FIG. 39D, the rotation communication paths 40 return to the same positions as in the “initial state” and the disk rotating angle is 0°. The flow path switching state at that time is the same “pattern A” as in the “initial state”. Specifically, between the “return-45° rotational state” and the “return-initial state”, lifting down of the rotary shaft 15 and the switching of the flow paths are performed simultaneously.

### Operations and Effects of Flow Path Switching Device

According to the configuration of the flow path switching device 1 in this embodiment described above, the following operations and effects can be achieved in addition to the operations and effects of the first embodiment. Specifically, according to the configuration of the flow path switching device 1, rotating the rotary shaft 15 can establish the following states: the contact state of the shaft protrusions 15b with the disk protrusions 13g (a protrusion-protrusion contact state) and the engagement state of the shaft protrusions 15b and the shaft recesses 15c with the disk recesses 13e and the disk protrusions 13g (a protrusion-recess engagement state). Herein, in the protrusion-protrusion contact state, the fixed disk 13 moves in the axial direction to widen the spacing between the upper housing 11 and the rotary disk 14 and the spacing between the fixed disk 13 and the rotary disk 14, which reduces the surface pressure applied on the upper seal member 17 between the upper housing 11 and the rotary disk 14 and the surface pressure applied on the lower seal member 18 between the fixed disk 13 and the rotary disk 14. In the protrusion-recess engagement state, in contrast, the fixed disk 13 moves in the axial direction to return the spacing between the upper housing 11 and the rotary disk 14 and the spacing between the fixed disk 13 and the rotary disk 14 to respective original spacings, which returns the surface pressure applied on the upper seal member 17 between the upper housing 11 and the rotary disk 14 and the surface pressure applied on the lower seal member 18 between the fixed disk 13 and the rotary disk 14 to respective original levels. In switching between the protrusion-protrusion contact state and the protrusion-recess engagement state, the side surfaces 15d of the shaft protrusions 15b and shaft recesses 15c and the side surfaces 13i of the disk recesses 13e and disk protrusions 13g go through a state of contacting with each other. Therefore, the protrusion-protrusion contact state and the protrusion-recess engagement state can be smoothly switched over.

According to the configuration of this embodiment, the top portion 15e of each shaft protrusion 15b has a protruding curved surface. While the shaft protrusions 15b and the disk protrusions 13g are in contact, therefore, when the rotary shaft 15 is rotated from this state, the position of the rotary shaft 15 in the axial direction does not change suddenly. Further, since the bottom portion of each of the disk recesses 13e and the shaft recesses 15c has a flat surface, when the rotary shaft 15 is rotated with the shaft protrusions 15b and the shaft recesses 15c respectively engaged with the disk recesses 13e and the disk protrusions 13g, the position of the rotary shaft 15 in the axial direction does not change suddenly. This can suppress sliding wear of the lower seal member 18.

According to the configuration of this embodiment, when the shaft protrusions 15b ride on the disk protrusions 13g from the disk recesses 13e, that is, when the spacing between the upper housing 11 and the rotary disk 14 and the spacing between the fixed disk 13 and the rotary disk 14 are widened by movement of the fixed disk 13 in the axial direction, the idle-rotating angle of the rotary shaft 15 and the switching angle of the rotary disk 14 to switch the flow paths are set to the same angle (45°). Thus, as long as the rotary shaft 15 is rotated counterclockwise (in the opposite direction) by the switching angle and the idle-rotating angle (45°), the rotational position of the rotary shaft 15 and the rotational position of the rotary disk 14 can be returned to their former positions. This allows the flow path switching operation by clockwise rotation (in one way) of the rotary shaft 15 to match the flow path switching operation by counterclockwise rotation of the rotary shaft 15.

In this embodiment, as shown in FIGS. 29A to 29D, FIGS. 33A to 33D, FIGS. 35A to 35D, and FIGS. 39A to 39D, when the rotary disk 14 rotates, the rotary shaft 15 lifts down (the spacing between the fixed disk 13 and the rotary disk 14 returns to the original spacing). This reduces the surface pressure on the seal member 17 between the upper housing 11 and the rotary disk 14 and the surface pressure on the seal member 18 between the fixed disk 13 and the rotary disk 14, which can prevent each seal member 17, 18 from undergoing sliding wear and dislodging or coming off by drag. As shown in FIGS. 30A to 30D and FIGS. 36A to 36D, the same as above applies to when the rotary disk 14 rotates and the rotary shaft 15 lifts up (the spacing between the fixed disk 13 and the rotary disk 14 is widened).

In this embodiment, in the configuration that is the “one-way idle-rotating type” and allows the flow paths to be switched between two pattens, the clockwise “idle-rotating angle” of the rotary shaft 15 and the “switching angle” to switch the flow paths are set to the same 45°. Thus, as shown in FIGS. 29A to 29D, FIGS. 33A to 33D, FIGS. 35A to 35D, and FIGS. 39A to 39D, in switching the flow paths, after lifting up the rotary shaft 15, switching of the flow paths and lifting down of the rotary shaft 15 can be performed simultaneously. This can reduce the drive torque of the rotary shaft 15 (the drive torque of the drive part 4), and make the drive part 4 (the motor) compact.

In this embodiment, as in the first embodiment, the connection portion between the rotary shaft 15 and the rotary disk 14 (between the rotary shaft 15 and the inner wall of the through hole 14a) has a predetermined gap 28. The rotary shaft 15 is configured to rotate by the drive power obtained from the drive part 4, idle-rotate by the gap 28 within the through hole 14a, then engage with the inner wall of the through hole 14a and rotate together with the rotary disk 14. This can set a state where the spacing between the upper housing 11 and the rotary disk 14 and the spacing between the fixed disk 13 and the rotary disk 14 are widened without rotating the rotary disk 14 even when the rotary shaft 15 rotates. Consequently, the lifting up or lifting down can be performed without rotating the rotary disk 14.

Herein, it is assumed that the connection portion between the rotary shaft and the rotary disk has no gap in the rotation direction. For example, the rotary disk is assumed to be configured to rotate 45° to switch flow paths. In this case, at the time of flow path switching, the rotary shaft has to lift up and lift down while the rotary disk rotates 45°. In this case, the rotary shaft is lifted up to rotate 22.5°. To increase the lift amount of the rotary shaft at that time, the drive torque of the rotary shaft has to be increased. In other words, unless the drive torque of the rotary shaft is increased, the lift amount of the rotary shaft cannot be increased. This leads to a small surface pressure decreasing allowance of the seal members at the time of switching flow paths. In contrast, in the present embodiment, since the gap 28 is located in the rotation direction of the rotary shaft 15, that is, the rotary shaft 15 can idle, the lift amount of the rotary shaft 15 (widening allowance of spacing between the fixed disk 13 and the rotary disk 14) can be increased without particularly increasing the drive torque of the rotary shaft 15 (the drive torque of the drive part 4).

### Third Embodiment

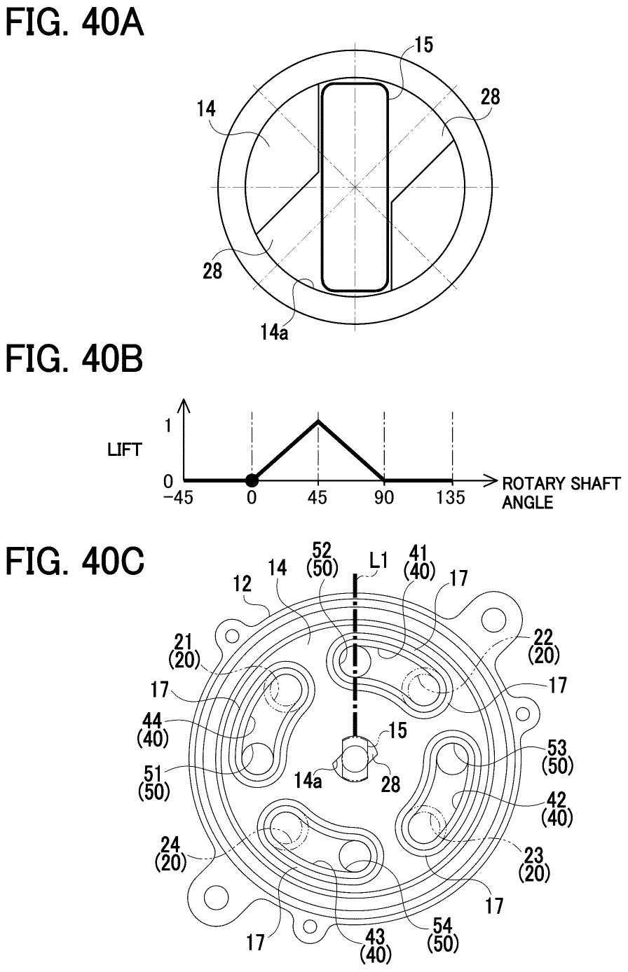

Next, a third embodiment will be described in detail below, referring to FIGS. 40A to 44C.

The flow path switching device 1 in this embodiment is basically identical in its outer appearance and inner structure to that in the first embodiment, but differs from the second embodiment in the above-described “sliding resistance reducing structure”, i.e., the engaging structure K1 and the engaged structure K2.

### Switching of Flow Path Patterns

The flow path switching device 1 in this embodiment is configured to switch the flow paths of a fluid between two patterns by the above structure differences. FIGS. 40A to 44C show operational diagrams related to switching of flow path patterns. The flow path switching device 1 in this embodiment is the “one-way idle-rotating type” as in the second embodiment.

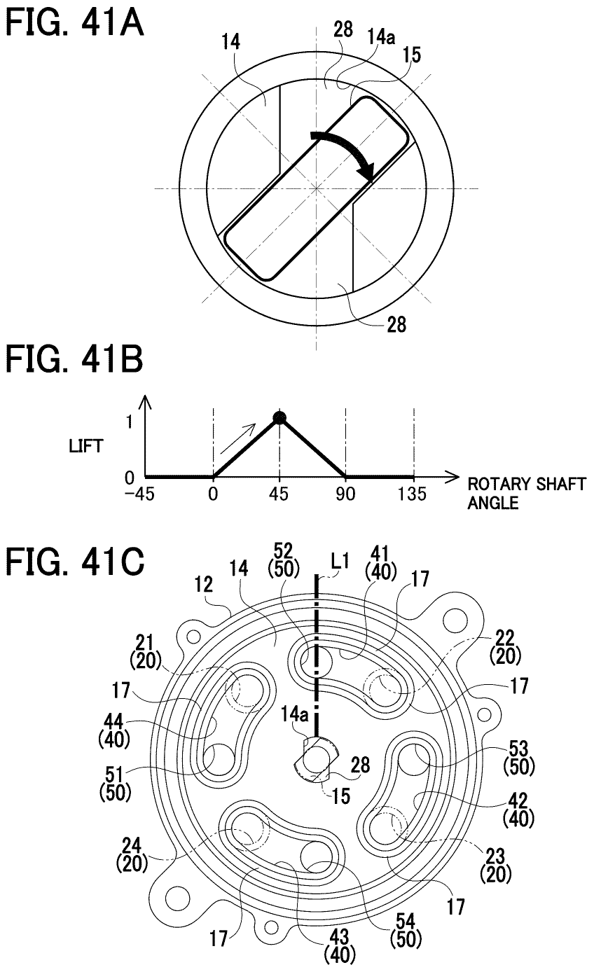

FIGS. 40A to 40C show the “initial state” of the flow path switching device 1 in this embodiment; FIG. 40A is an image diagram showing an engagement relationship between the through hole 14a of the rotary disk 14 and the rotary shaft 15. FIGS. 41A, 42A, 43A, and 44A, which will be described later, are image diagrams similar to FIG. 40A. FIG. 40B is an image diagram showing changes in lifting of the rotary shaft 15 with respect to the rotary shaft angle. FIGS. 41B, 42B, 43B, and 44B, which will be described later, are image diagrams similar to FIG. 40B. FIG. 40C is a plan diagram, similar to FIG. 21, showing the rotational position of the rotary disk 14 and the rotation communication paths 40. FIGS. 41C, 42C, 43C, and 44C, which will be described later, are plan diagrams similar to FIG. 40C.

In this “initial state”, as shown in FIG. 40A, the rotary shaft 15 engages one inner wall of the through hole 14a and the shaft protrusions 15b ride down into the disk recesses 13e, and hence the rotary shaft 15 lifts down as shown in FIG. 40B. Further, the rotary disk 14 and the rotation communication paths 40 are placed in a state shown in FIG. 40C. The disk rotating angle at that time is 0°, and the flow path switching state is the same as the “pattern A” in the second embodiment.

Next, changes from the “initial state” will be described in sequence. FIGS. 41A to 41C show a “45° rotational state” to which the rotary shaft 15 rotates 45° clockwise from the “initial state”. In this state, as shown in FIG. 41A, the rotary shaft 15 idle-rotates 45° clockwise from the “initial state” and engages the other inner wall of the through hole 14a, the shaft protrusions 15b ride on the disk protrusions 13g, and hence the rotary shaft 15 lifts up as shown in FIG. 41B. Further, as shown in FIG. 41C, the disk rotating angle remains 0°, and the flow path switching state of the rotation communication paths 40 is the same “pattern A” as in the “initial state”.

Also in this embodiment, as described above, the “idle-rotating angle” to idle-rotate the rotary shaft 15 clockwise when the shaft protrusions 15b ride on the disk protrusions 13g is set to 45°.

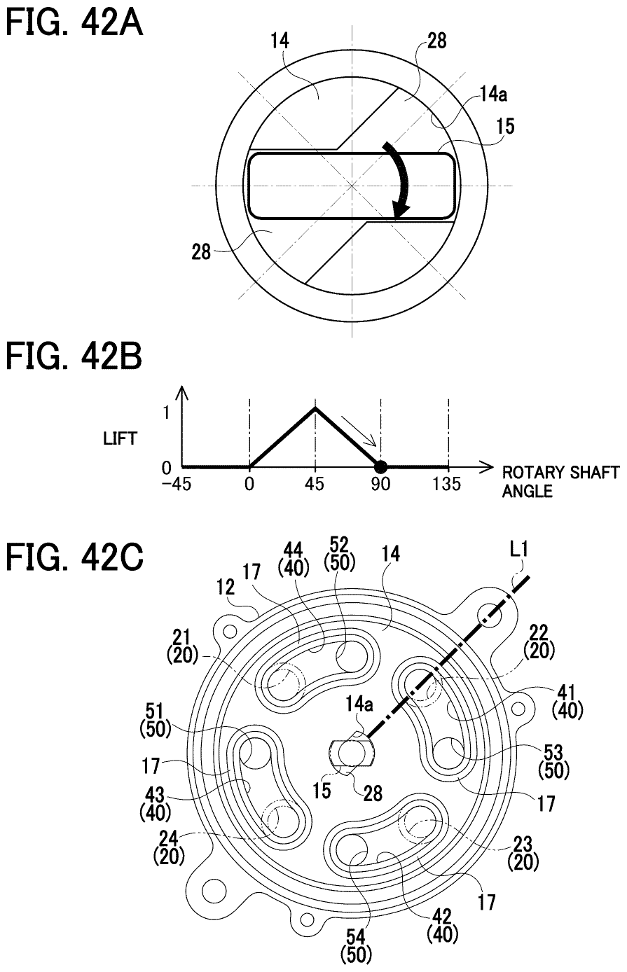

Next, FIGS. 42A to 42C show a “90° rotational state” to which the rotary shaft 15 further rotates 45° clockwise from the “45° rotational state”. In this state, as shown in FIG. 42A, the rotary shaft 15 rotates 45° clockwise together with the rotary disk 14, the shaft protrusions 15b ride down into the disk recesses 13e, and hence the rotary shaft 15 lifts down as shown in FIG. 42B. Further, as shown in FIG. 42C, the disk rotating angle is 45°, and the flow path switching state of the rotation communication paths 40 is the same as the “pattern B” in the second embodiment. Specifically, between the “45° rotational state” and the “90° rotational state”, lifting down of the rotary shaft 15 and switching of the flow paths are performed simultaneously.

In this embodiment, as described above, the clockwise “idle-rotating angle” of the rotary shaft 15 and the “switching angle” of the rotary disk 14 to switch the flow paths are set to the same 45°.

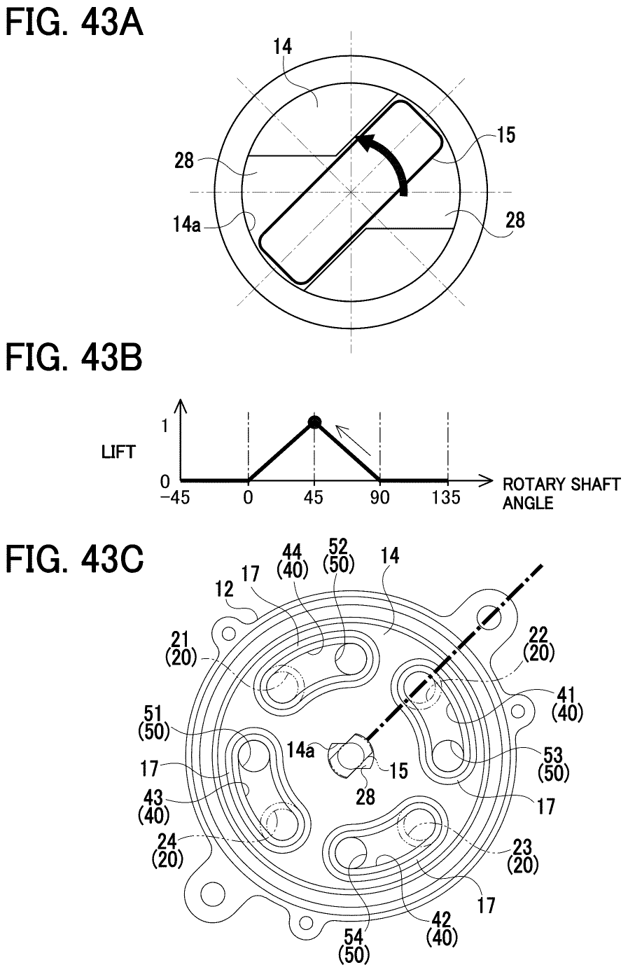

Next, FIGS. 43A to 43C show a “return-45° rotational state” to which the rotary shaft 15 rotates 45° counterclockwise from the “90° rotational state”. In this state, as shown in FIG. 43A, the rotary shaft 15 rotates 45° counterclockwise and engages with one inner wall of the through hole 14a, the shaft protrusions 15b ride on the disk protrusions 13g, and hence the rotary shaft 15 lifts up as shown in FIG. 43B. Further, as shown in FIG. 43C, the disk rotating angle is 45°, and the flow path switching state of the rotation communication paths 40 is the same “pattern B” as in the “90° rotational state”.

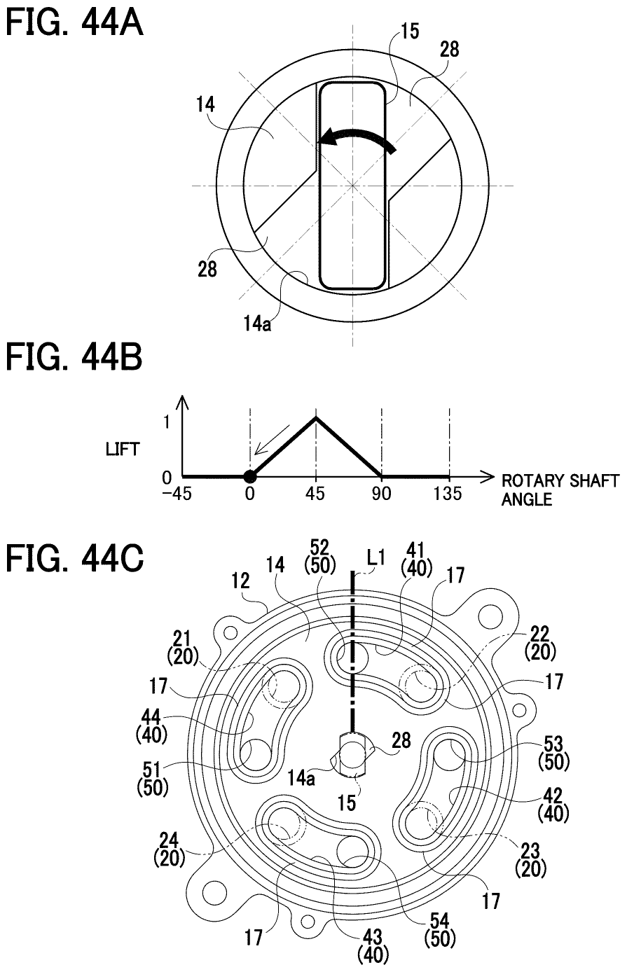

FIGS. 44A to 44C show a “return-initial state” to which the rotary shaft 15 further rotate 45° counterclockwise from the “return-45° rotational state”. In this state, as shown in FIG. 44A, the rotary shaft 15 rotates 45° counterclockwise together with the rotary disk 14, the shaft protrusions 15b ride down into the disk recesses 13e, and hence the rotary shaft 15 lifts down as shown in FIG. 44B. Further, as shown in FIG. 44C, the disk rotating angle is 0°, and the flow path switching state of the rotation communication paths 40 is the same “pattern A” as in the “initial state”.

### Operations and Effects of Flow Path Switching Device

The flow path switching device 1 in this embodiment described above differs in the configuration that the flow paths of a fluid can be switched between two patterns from the second embodiment in which the flow path can be switched between four patterns, but can achieve the same operations and effects as in the second embodiment.

In this embodiment, as shown in FIGS. 42A to 42C and FIGS. 44A to 44C, when the rotary disk 14 rotates (when the flow paths are switched), the rotary shaft 15 lifts down (the spacing between the fixed disk 13 and the upper housing 11 returns to its original state). This reveals that when the rotary disk 14 rotates, the surface pressure applied on each seal member 17, 18 between the fixed disk 13 and the upper housing 11 is reduced, which can prevent each seal member 17, 18 from undergoing sliding wear and dislodging or coming off by drag.

In this embodiment, in the configuration that is the “one-way idle-rotating type” and allows the flow paths to be switched between two pattens, the clockwise “idle-rotating angle” of the rotary shaft 15 and the “switching angle” of the flow path are set to the same 45°. Thus, as shown in FIGS. 42A to 42C and FIGS. 44A to 44C, in switching the flow paths, after lifting up the rotary shaft 15, switching of the flow paths and lifting down of the rotary shaft 15 can be performed simultaneously. This can reduce the drive torque of the rotary shaft 15 (the drive torque of the drive part 4), and make the drive part 4 (the motor) compact.

### Fourth Embodiment

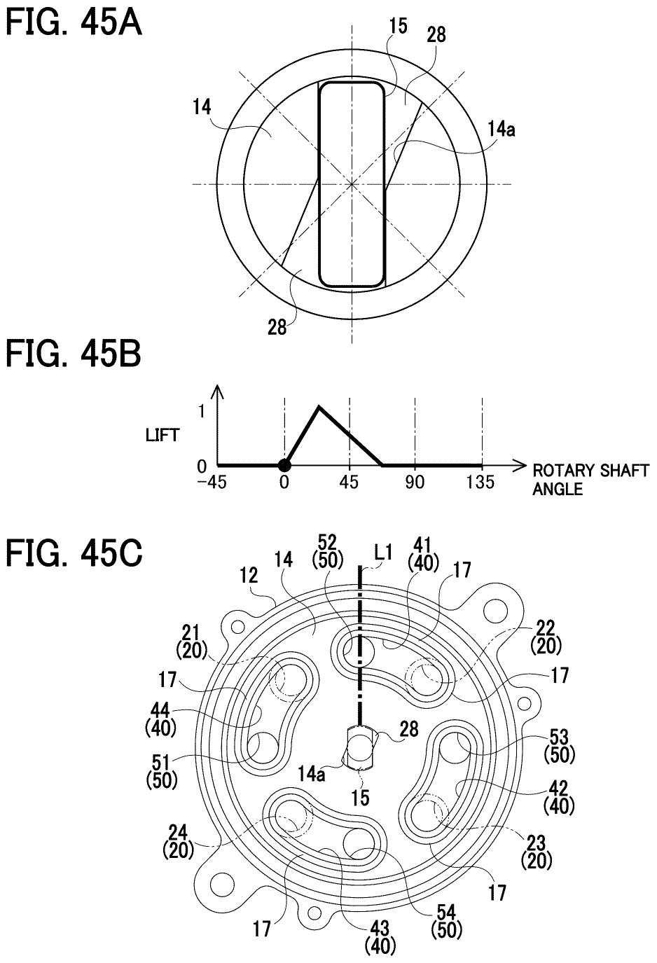

Next, a fourth embodiment will be described below in detail, referring to FIGS. 45A to 49C.

A flow path switching device 1 in this embodiment differs from the third embodiment in the above-described “sliding resistance reducing structure”, i.e., the engaging structure K1 and the engaged structure K2.

### Switching of Flow Path Patterns

The flow path switching device 1 in this embodiment is configured to switch the flow paths of a fluid between two patterns as in the third embodiment. FIGS. 45A to 49C show operational diagrams related to switching of flow path patterns. The flow path switching device 1 in this embodiment is the “one-way idle-rotating type” as in the third embodiment.

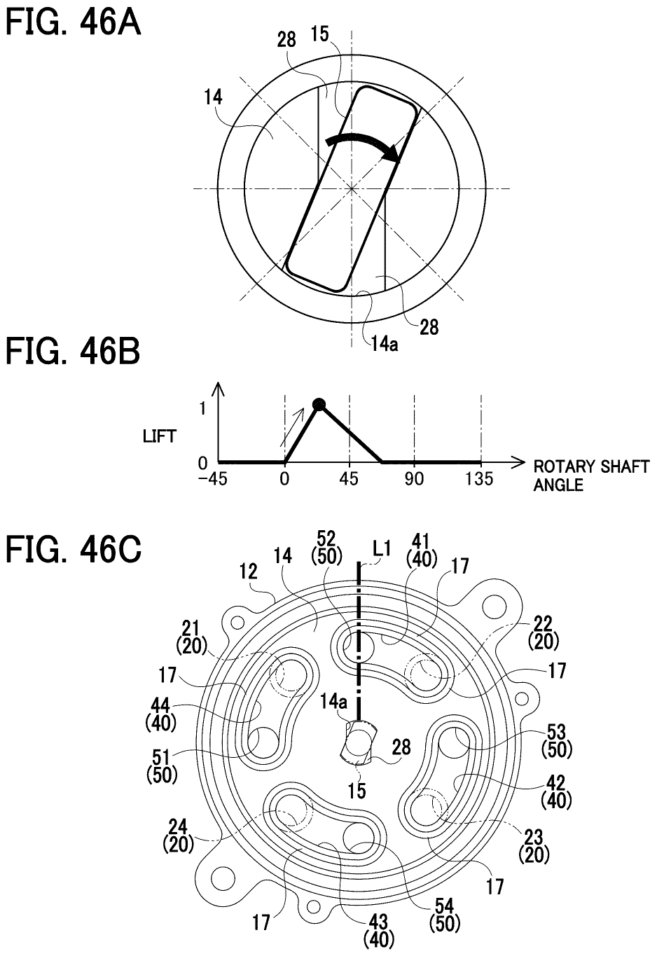

FIGS. 45A to 45C show the “initial state” of the flow path switching device 1 in this embodiment; FIG. 45A is an image diagram showing an engagement relationship between the through hole 14a of the rotary disk 14 and the rotary shaft 15. FIGS. 46A, 47A, 48A, and 49A, which will be described later, are image diagrams similar to FIG. 45A. FIG. 45B is an image diagram showing changes in lifting of the rotary shaft 15 with respect to the rotary shaft angle. FIGS. 46B, 47B, 48B, and 49B, which will be described later, are image diagrams similar to FIG. 45B. FIG. 45C is a plan diagram, similar to FIG. 21, showing the rotational position of the rotary disk 14 and the rotation communication paths 40. FIGS. 46C, 47C, 48C, and 49C, which will be described later, are plan diagrams similar to FIG. 45C.

In this “initial state”, as shown in FIG. 45A, the rotary shaft 15 engages with one inner wall of the through hole 14a and the shaft protrusions 15b ride down into the disk recesses 13e, and hence the rotary shaft 15 lifts down as shown in FIG. 45B. Further, the rotary disk 14 and the rotation communication paths 40 are placed in a state shown in FIG. 45C. The disk rotating angle at that time is 0°, and the flow path switching state is the same as the “pattern A” in the third embodiment.

Next, changes from the “initial state” will be described in sequence. FIG. 46A to 46C show a “22.5° rotational state” to which the rotary shaft 15 rotates 22.5° clockwise from the “initial state”. In this state, as shown in FIG. 46A, the rotary shaft 15 idle-rotates 22.5° clockwise from the “initial state” and engages the other inner wall of the through hole 14a, the shaft protrusions 15b ride on the disk protrusions 13g, and hence the rotary shaft 15 lifts up as shown in FIG. 46B. Further, as shown in FIG. 46C, the disk rotating angle remains 0°, and the flow path switching state of the rotation communication paths 40 is the same “pattern A” as in the “initial state”.

In this embodiment, as described above, the “idle-rotating angle” to idle-rotate the rotary shaft 15 clockwise when the shaft protrusions 15b ride on the disk protrusions 13g is set to 22.5°.

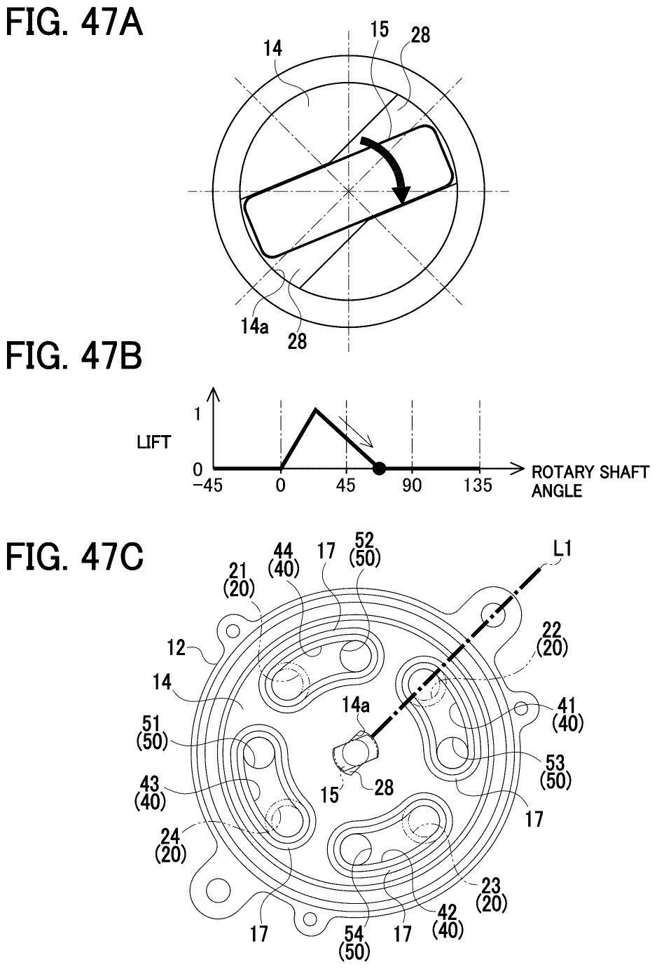

Next, FIGS. 47A to 47C show a “67.5° rotational state” to which the rotary shaft 15 further rotates 45° clockwise from the “22.5° rotational state”. In this state, as shown in FIG. 47A, the rotary shaft 15 rotates 45° clockwise together with the rotary disk 14 and the shaft protrusions 15b ride down into the disk recesses 13e, and hence the rotary shaft 15 lifts down as shown in FIG. 47B. Further, as shown in FIG. 47C, the disk rotating angle is 45°, and the flow path switching state of the rotation communication paths 40 is the same as the “pattern B” in the third embodiment. Specifically, between the “22.5° rotational state” and the “67.5° rotational state”, lifting down of the rotary shaft 15 and switching of the flow paths are performed simultaneously.

In this embodiment, the “switching angle” of the rotary disk 14 to switch the flow paths is set to 45°. Specifically, in this embodiment, the “switching angle” to switch the flow paths is set to a larger angle than the “idle-rotating angle” to idle-rotate the rotary shaft 15 clockwise.

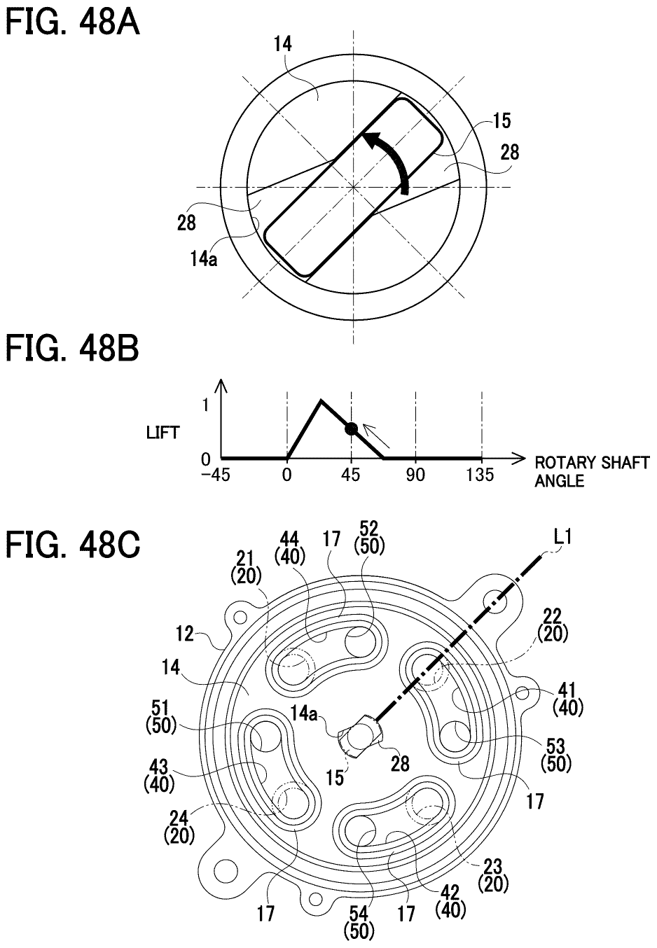

Next, FIGS. 48A to 48C show a “return-45° rotational state” to which the rotary shaft 15 rotates 22.5° counterclockwise from the “67.5° rotational state”. In this state, as shown in FIG. 48A, the rotary shaft 15 rotates 22.5° counterclockwise and engages with one inner wall of the through hole 14a, the shaft protrusions 15b start to move toward the disk protrusions 13g, and hence the rotary shaft 15 lifts up halfway as shown in FIG. 48B. Further, as shown in FIG. 48C, the disk rotating angle remains 45°, and the flow path switching state of the rotation communication paths 40 is the same “pattern B” as in the “67.5° rotational state”.

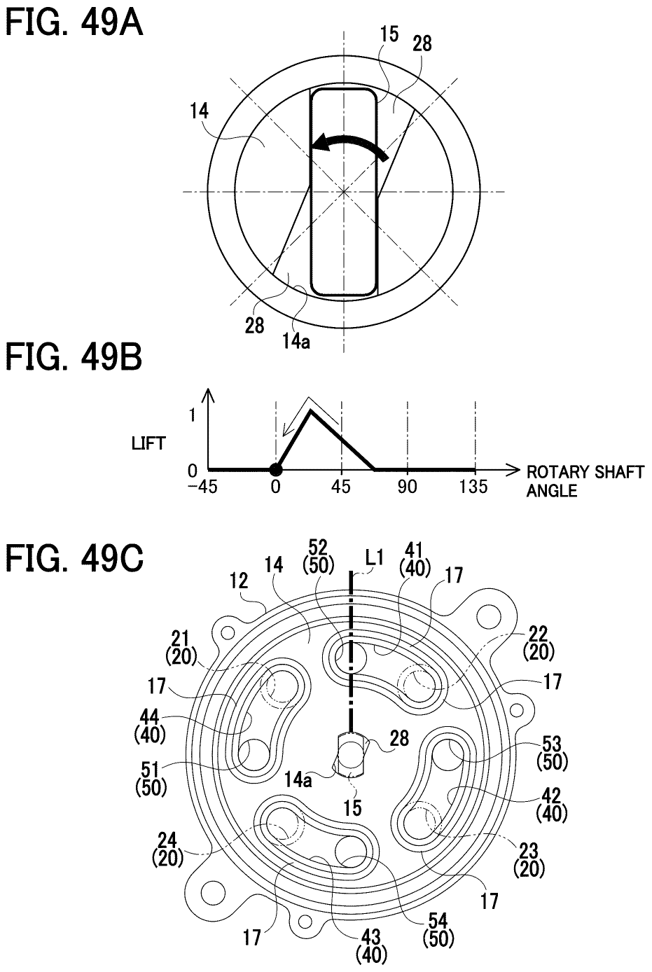

FIGS. 49A to 49C show a “return-initial state” to which the rotary shaft 15 rotates 45° counterclockwise from the “return-45° rotational state”. In this state, as shown in FIG. 49A, the rotary shaft 15 rotates 45° counterclockwise together with the rotary disk 14, the shaft protrusions 15b run over the disk protrusions 13g and ride down into the disk recesses 13e, and hence the rotary shaft 15 lifts up and lifts down as shown in FIG. 49B. Further, as shown in FIG. 49C, the disk rotating angle is 0°, and the flow path switching state of the rotation communication paths 40 is the same “pattern A” as in the “initial state”. Specifically, between the “return-45° rotational state” and the “return-initial state”, lifting up and lifting down of the rotary shaft 15 and switching of the flow paths are performed simultaneously.

### Operations and Effects of Flow Path Switching Device

The flow path switching device 1 in this embodiment described above is configured, as in the third embodiment, to switch the flow paths of a fluid between two patterns, and the rotary shaft 15 is the “one-way idle-rotating type”, and can achieve the same operations and effects as in the third embodiment. However, in this embodiment, the “switching angle” of flow paths differs from the “idle-rotating angle” of the rotary shaft 15 and thus the operations of the rotary disk 14 and the rotary shaft 15 to switch the flow paths are different from those in the third embodiment.

In this embodiment, as shown in FIGS. 47A to 47C, when the rotary disk 14 rotates, the rotary shaft 15 lifts down (the spacing between the fixed disk 13 and the upper housing 11 returns to the original state), and the rotary shaft 15 lifts up and lifts down (the spacing between the fixed disk 13 and the upper housing 11 widens once and then returns to the original state) as shown in FIGS. 49A to 49C. This configuration can reduce the surface pressure applied on each seal member 17, 18 between the fixed disk 13 and the rotary disk 14 when the rotary disk 14 rotates, which can prevent each seal member 17, 18 from undergoing sliding wear and dislodging or coming off by drag.

### Fifth Embodiment

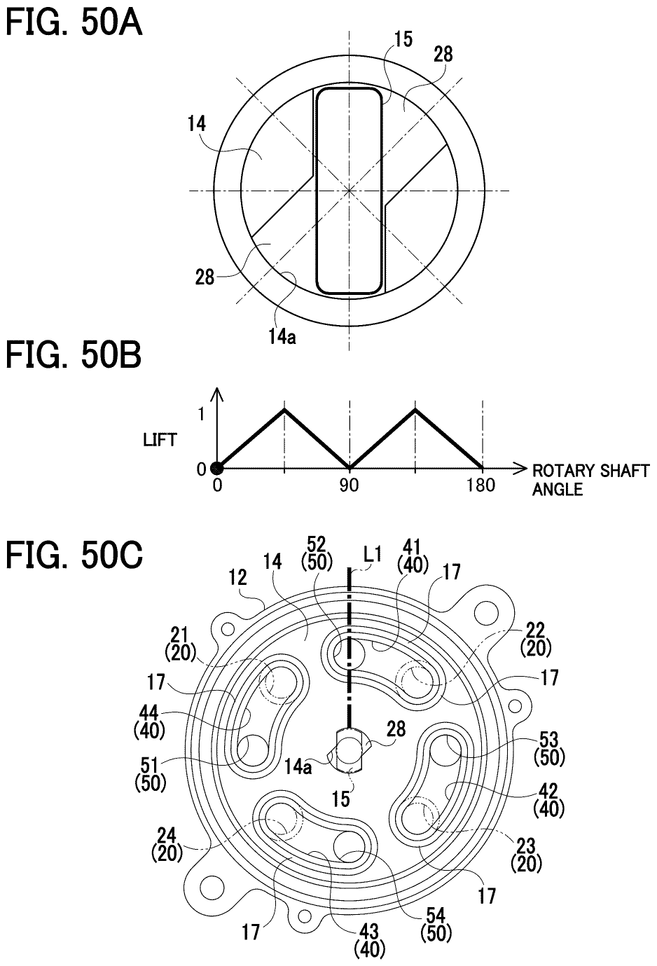

Next, a fifth embodiment will be described below in detail, referring to FIGS. 50A to 58C.

### Switching of Flow Path Patterns

A flow path switching device 1 in this embodiment differs from that in the second embodiment in the switching patterns of flow paths of a fluid, and is configured to switch the fluid flow paths between three patterns. FIGS. 50A to 58C show operation diagrams related to switching of flow path patterns. The flow path switching device 1 in this embodiment is the same “one-way idle-rotating type” as in the second embodiment.

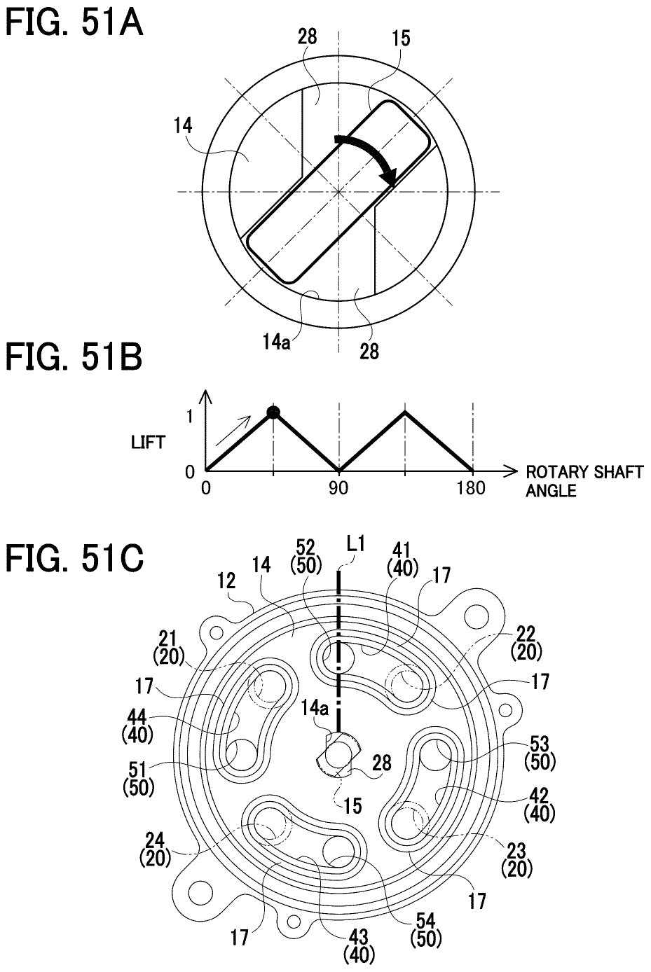

FIGS. 50A to 50C show the “initial state” of the flow path switching device 1 in this embodiment; FIG. 50A is an image diagram showing an engagement relationship between the through hole 14a of the rotary disk 14 and the rotary shaft 15. FIGS. 51A, 52A, 53A, 54A, 55A, 56A, 57A, and 58A, which will be described later, are image diagrams similar to FIG. 50A. FIG. 50B is an image diagram showing changes in lifting of the rotary shaft 15 with respect to the rotary shaft angle. FIGS. 51B, 52B, 53B, 54B, 55B, 56B, 57B, and 58B, which will be described later, are image diagrams similar to FIG. 50B. FIG. 50C is a plan diagram, similar to FIG. 21, showing the rotational position of the rotary disk 14 and the rotation communication paths 40. FIGS. 51C, 52C, 53C, 54C, 55C, 56C, 57C, and 58C, which will be described later, are plan diagrams similar to FIG. 50C.

In this “initial state”, as shown in FIG. 50A, the rotary shaft 15 engages with one inner wall of the through hole 14a and the shaft protrusions 15b ride down into the disk recesses 13e, and hence the rotary shaft 15 lifts down as shown in FIG. 50B. Further, the rotary disk 14 and the rotation communication paths 40 are placed in a state shown in FIG. 50C. The disk rotating angle at that time is 0°, and the flow path switching state is the same as the “pattern A” in the third embodiment.

Next, changes from the “initial state” will be described in sequence. FIGS. 51A to 51C show a “45° rotational state” to which the rotary shaft 15 rotates 45° clockwise from the “initial state”. In this state, as shown in FIG. 51A, the rotary shaft 15 idle-rotates 45° clockwise from the “initial state” and engages the other inner wall of the through hole 14a, the shaft protrusions 15b ride on the disk protrusions 13g, and hence the rotary shaft 15 lifts up as shown in FIG. 51B. Further, as shown in FIG. 51C, the disk rotating angle remains 0°, and the flow path switching state of the rotation communication paths 40 is the same “pattern A” as in the “initial state”.

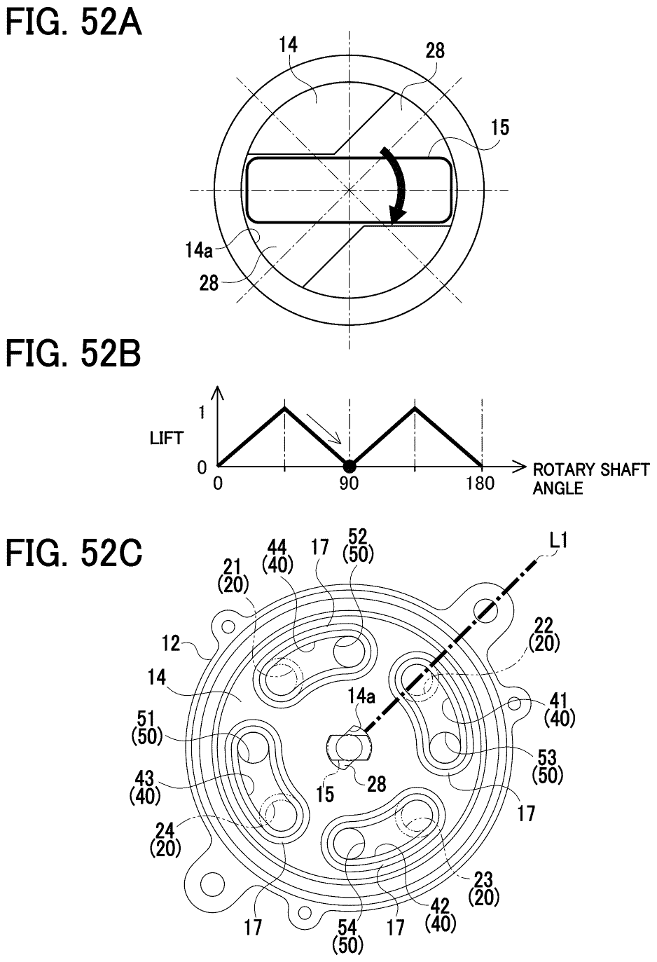

Next, FIGS. 52A to 52C show a “90° rotational state” to which the rotary shaft 15 further rotates 45° clockwise from the “45° rotational state”. In this state, as shown in FIG. 52A, the rotary shaft 15 rotates 45° clockwise together with the rotary disk 14 and the shaft protrusions 15b ride down into the disk recesses 13e, and hence the rotary shaft 15 lifts down as shown in FIG. 52B. Further, as shown in FIG. 52C, the disk rotating angle is 45°, and the flow path switching state of the rotation communication paths 40 is the same as the “pattern B” in the second embodiment. Specifically, between the “45° rotational state” and the “90° rotational state”, lifting down of the rotary shaft 15 and switching of the flow paths are performed simultaneously.

In this embodiment, as described above, the “switching angle” to switch the flow paths and the “idle-rotating angle” to idle-rotate the rotary shaft 15 clockwise are the same 45°.

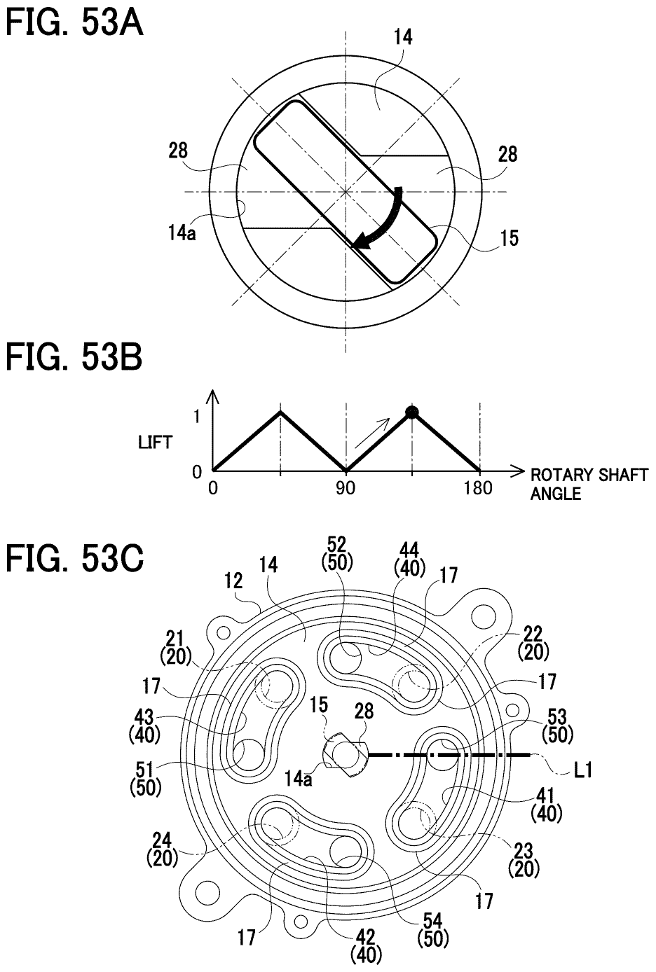

Next, FIGS. 53A to 53C show a “135° rotational state” to which the rotary shaft 15 further rotates 45° clockwise from the “90° rotational state”. In this state, as shown in FIG. 53A, the rotary shaft 15 rotates 45° clockwise together with the rotary disk 14, the shaft protrusions 15b ride on the disk protrusions 13g, and hence the rotary shaft 15 lifts up as shown in FIG. 53B. Further, as shown in FIG. 53C, the disk rotating angle is 90°, and the flow path switching state of the rotation communication paths 40 is the same as the “pattern C” in the second embodiment. Specifically, between the “90° rotational state” and the “135° rotational state”, lifting up of the rotary shaft 15 and switching of the flow paths are performed simultaneously.

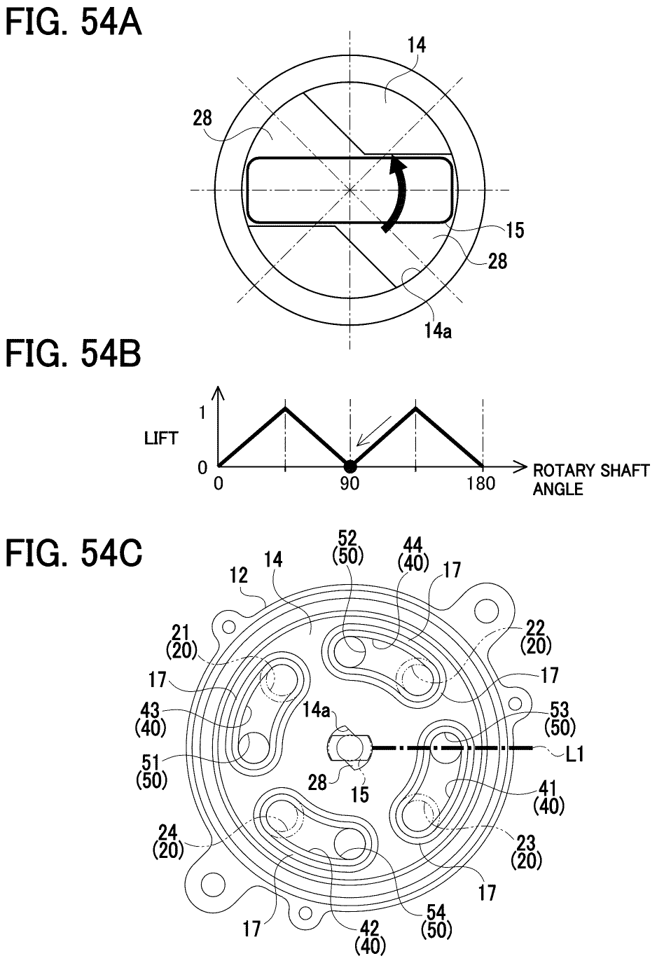

Next, FIGS. 54A to 54C show a “return-90° rotational state” to which the rotary shaft 15 rotates 45° counterclockwise from the “135° rotational state”. In this state, as shown in FIG. 54A, the rotary shaft 15 rotates 45° counterclockwise and engages with one inner wall of the through hole 14a, the shaft protrusions 15b ride down into the disk recesses 13e, and hence the rotary shaft 15 lifts down as shown in FIG. 54B. Further, as shown in FIG. 54C, the disk rotating angle remains 90°, and the flow path switching state of the rotation communication paths 40 is the “pattern C”.

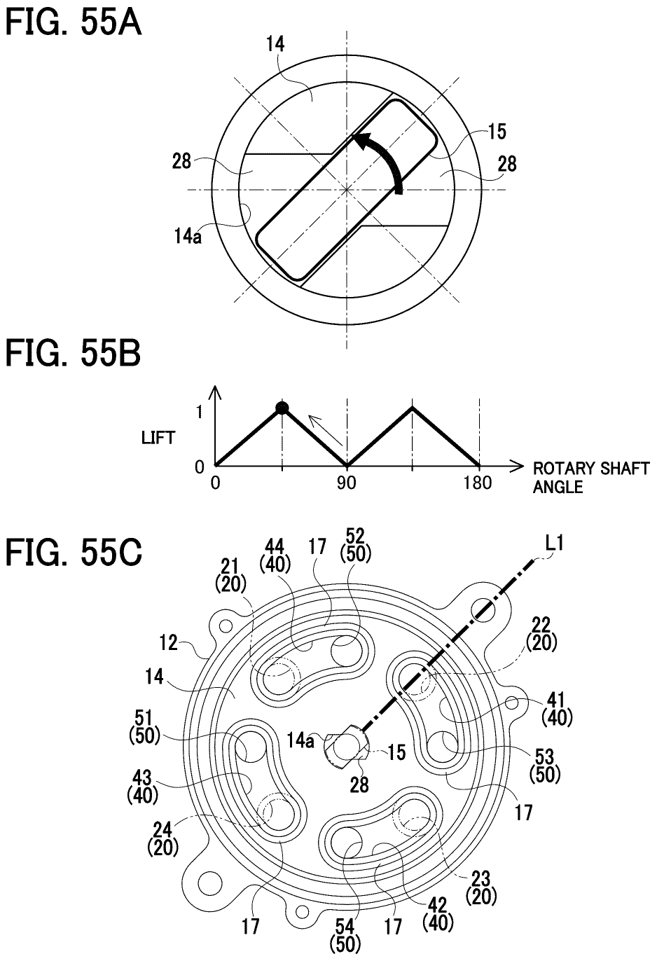

Next, FIGS. 55A to 55C show a “return-45° rotational state” to which the rotary shaft 15 rotates 45° counterclockwise from the “return-90° rotational state”. In this state, as shown in FIG. 55A, the rotary shaft 15 rotates 45° counterclockwise together with the rotary disk 14, the shaft protrusions 15b ride on the disk protrusions 13g, and hence the rotary shaft 15 lifts up as shown in FIG. 55B. Further, as shown in FIG. 55C, the disk rotating angle is 45°, and the flow path switching state of the rotation communication paths 40 is the “pattern B”. Specifically, between the “return-90° rotational state” and the “return-45° rotational state”, lifting up of the rotary shaft 15 and switching of the flow paths are performed simultaneously.

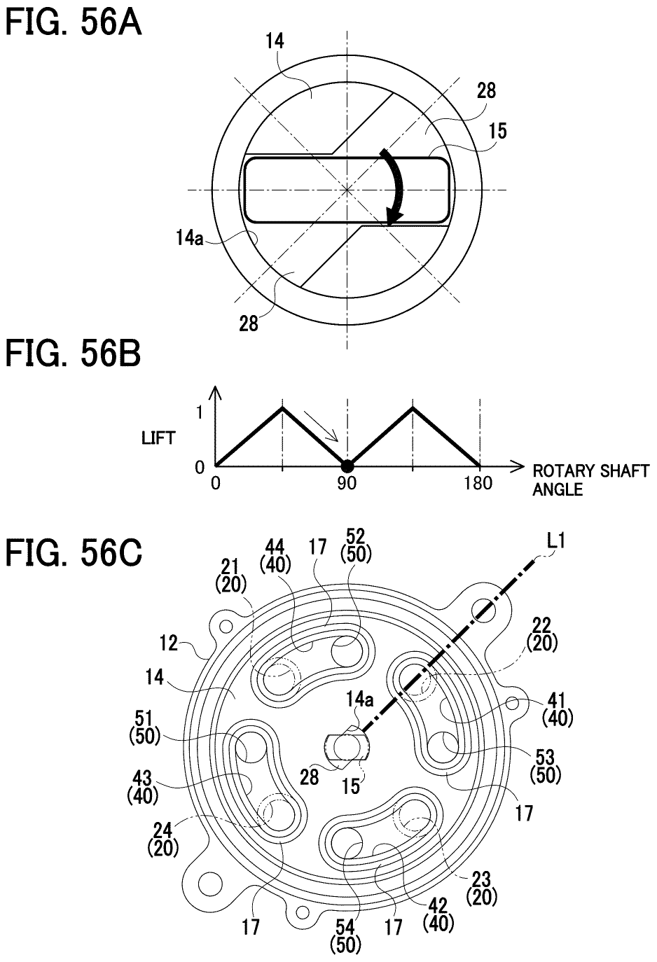

Next, FIGS. 56A to 56C show a “re-90° rotational state” to which the rotary shaft 15 rotates 45° clockwise from the “return-45° rotational state”. In this state, as shown in FIG. 56A, the rotary shaft 15 idle-rotates 45° clockwise and engages with one inner wall of the through hole 14a, the shaft protrusions 15b ride down into the disk recesses 13e, and hence the rotary shaft 15 lifts down as shown in FIG. 56B. Further, as shown in FIG. 56C, the disk rotating angle remains 45°, and the flow path switching state of the rotation communication paths 40 remains the “pattern B”.

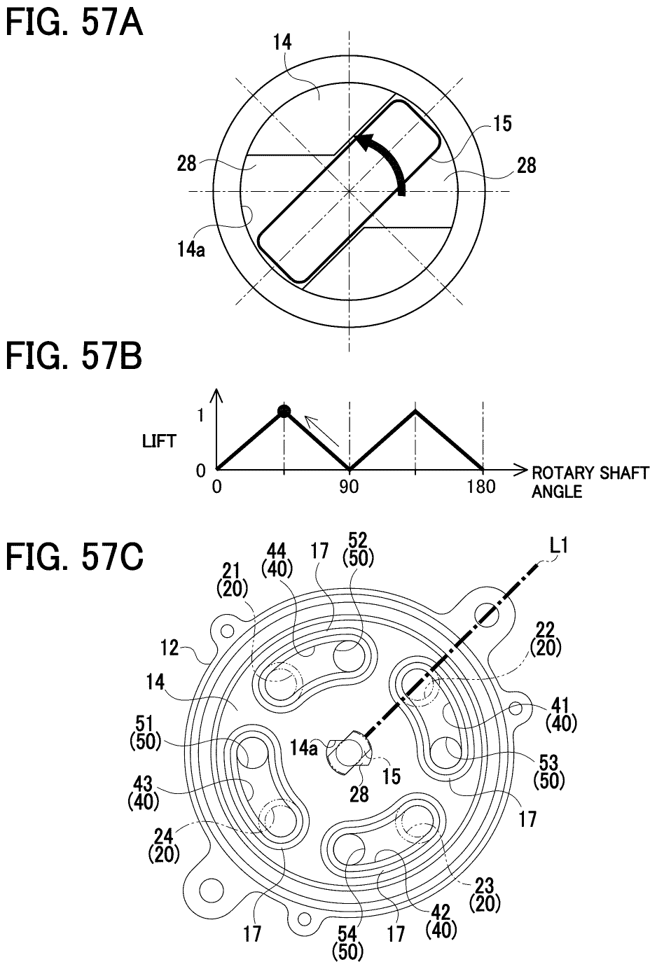

Next, FIGS. 57A to 57C show a “return-45° rotational state” to which the rotary shaft 15 rotates 45° counterclockwise from the “re-90° rotational state”. In this state, as shown in FIG. 57A, the rotary shaft 15 idle-rotates 45° counterclockwise and engages with one inner wall of the through hole 14a, the shaft protrusions 15b ride on the disk protrusions 13g, and hence the rotary shaft 15 lifts up as shown in FIG. 57B. Further, as shown in FIG. 57C, the disk rotating angle remains 45°, and the flow path switching state of the rotation communication paths 40 remains the “pattern B”.

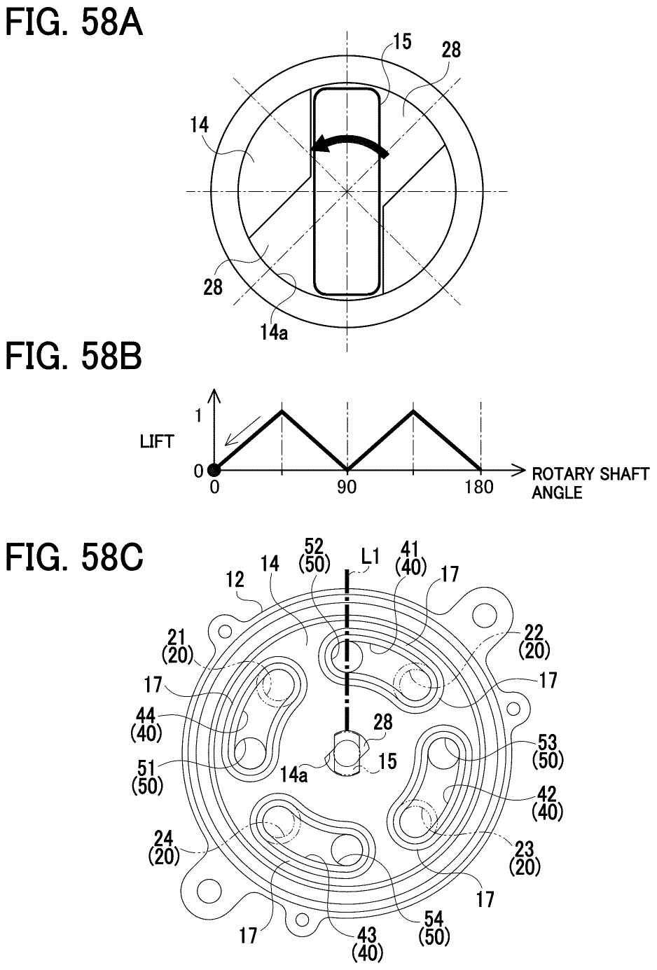

Next, FIGS. 58A to 58C show a “return-initial state” to which the rotary shaft 15 rotates 45° counterclockwise from the “return-45° rotational state”. In this state, as shown in FIG. 58A, the rotary shaft 15 rotates 45° counterclockwise together with the rotary disk 14, the shaft protrusions 15b ride down into the disk recesses 13e, and hence the rotary shaft 15 lifts down as shown in FIG. 58B. Further, as shown in FIG. 58C, the disk rotating angle returns to 0°, and the flow path switching state of the rotation communication paths 40 is the same “pattern A” as in the “initial state”. Specifically, between the “return-45° rotational state” and the “return-initial state”, lifting down of the rotary shaft 15 and switching of the flow paths are performed simultaneously.

### Operations and Effects of Flow Path Switching Device

The flow path switching device 1 in this embodiment described above is configured, unlike the second embodiment, to switch the flow paths of a fluid between three patterns.

In this embodiment, as shown in FIGS. 52A to 52C and FIGS. 58A to 58C, when the rotary disk 14 rotates, the rotary shaft 15 lifts down (the spacing between the fixed disk 13 and the upper housing 11 returns to the original state). Thus, the surface pressure applied on each seal member 17, 18 between the fixed disk 13 and the upper housing 11 is reduced when the rotary disk 14 rotates, which can prevent each seal member 17, 18 from undergoing sliding wear and dislodging by drag.

In this embodiment, in the configuration that is the “one-way idle-rotating type” and allows the flow paths to be switched between three pattens, the clockwise “idle-rotating angle” of the rotary shaft 15 and the “switching angle” of the flow paths are set to the same 45°. Thus, as shown in FIGS. 52A to 52C and FIGS. 58A to 58C, in switching the flow paths, after lifting up the rotary shaft 15, switching of the flow paths and lifting down of the rotary shaft 15 can be performed simultaneously. This can reduce the drive torque of the rotary shaft 15 (the drive torque of the drive part 4), and make the drive part 4 (the motor) compact.

### Sixth Embodiment

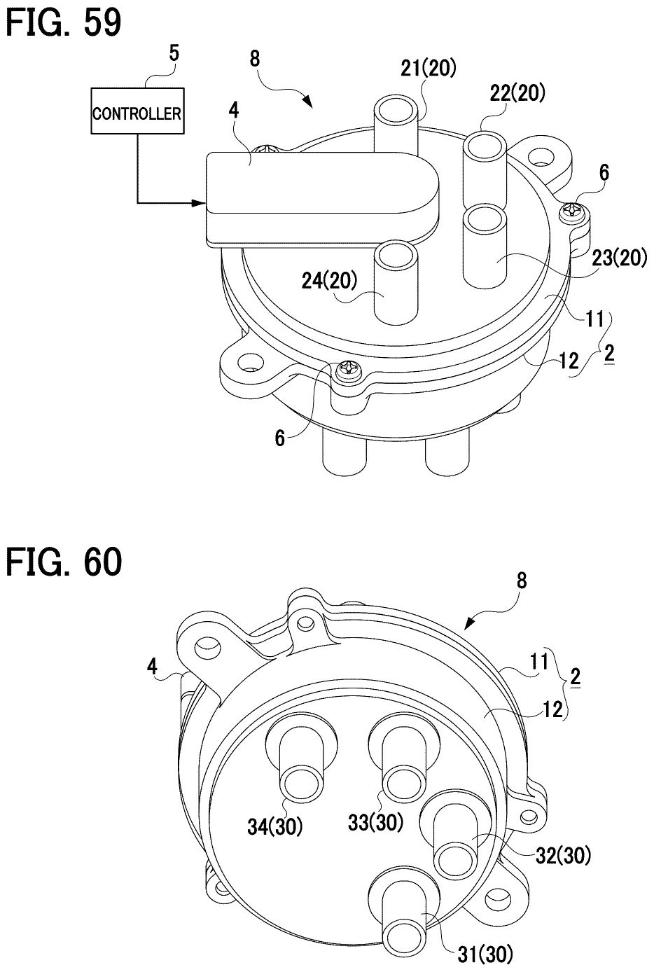

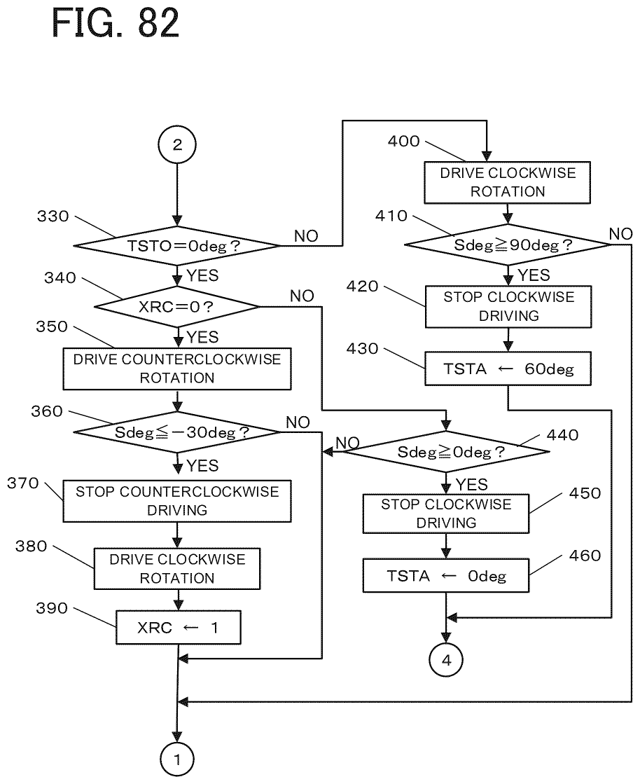

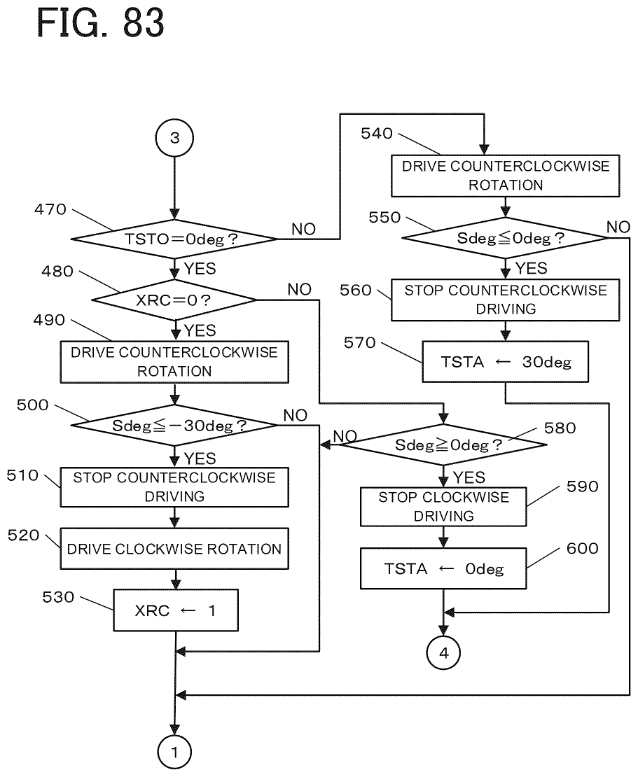

Next, a sixth embodiment will be described in detail below, referring to FIGS. 59 to 83.

### Outer Appearance of Flow Path Switching Device

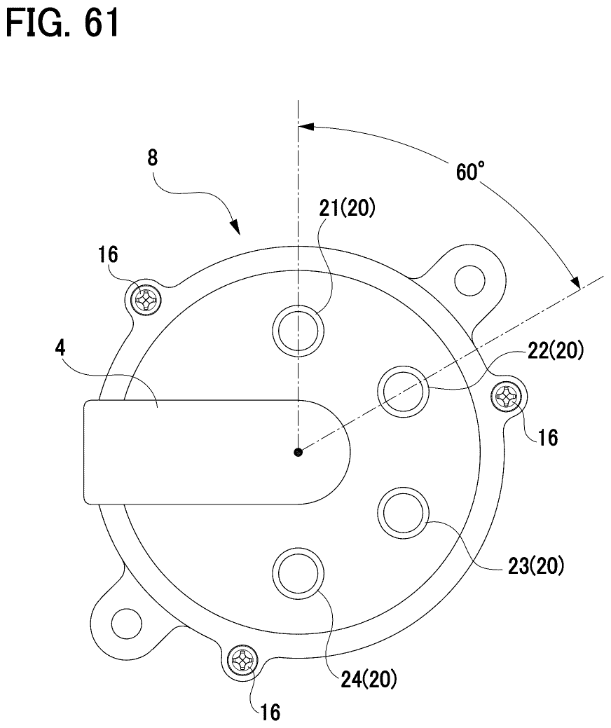

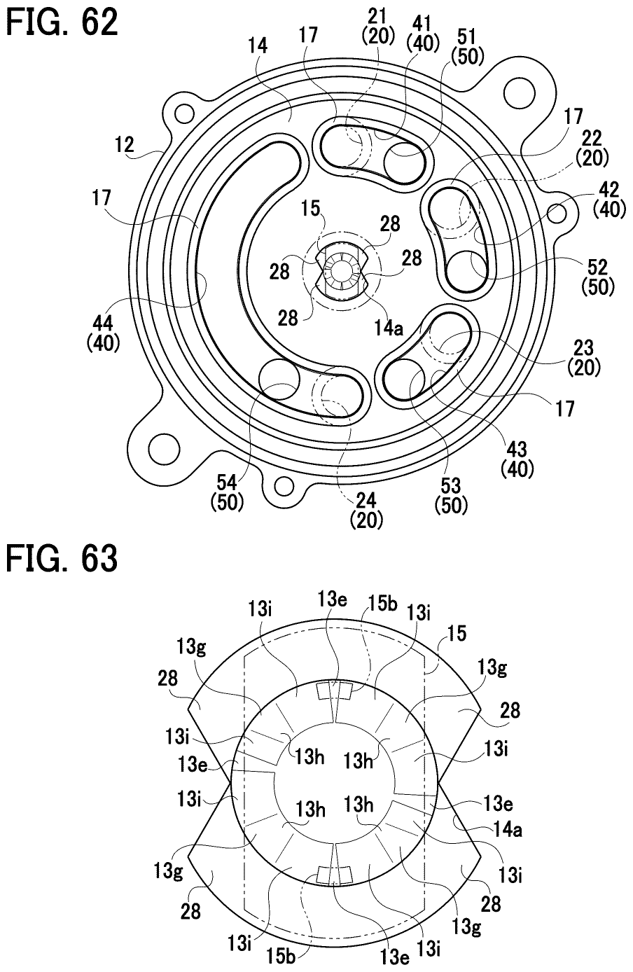

FIG. 59 is a perspective view showing an upper side of a flow path switching device 8 in this embodiment. FIG. 60 is a perspective view showing a bottom side of the flow path switching device 8. FIG. 61 is a plan view showing the flow path switching device 8. FIG. 62 is a plan view showing the flow path switching device 8, from which the upper housing 11 and the drive part 4 are removed. This embodiment differs from each of the aforementioned embodiments in the placement of the inflow paths 20 in the upper housing 11, the placement of the outflow paths 30 in the lower housing 12, the shape and placement of the rotation communication paths 40 in the rotary disk 14, and the placement of the fixed communication paths 50 in the fixed disk 13.

Specifically, as shown in FIGS. 59 and 61, in this embodiment, four inflow paths 20 (21 to 24) are arranged unevenly on almost one half of the upper surface of the upper housing 11, and adjacent ones of the inflow paths 20 (21 to 24) located close to each other are arranged at equal angle (60°) intervals. Further, as shown in FIG. 60, in this embodiment, four outflow paths 30 (31 to 34) are arranged unevenly on almost one half of the upper surface of the lower housing 12, corresponding to the four inflow paths 20 (21 to 24), and adjacent ones are arranged at equal angle (60°) intervals.

Further, as shown in FIG. 62, the rotation communication paths 40 provided in the rotary disk 14 have the same short curved shape for the first rotation communication path 41 to the third rotation communication path 43 and a long curved shape only for the fourth rotation communication path 44. The upper seal member 17 provided around each of the rotation communication paths 40 has the shape matching the shape of each corresponding rotation communication path 40 (41 to 44). The lower seal member 18 is configured as with the upper seal member 17.

In this embodiment, the flow path switching device 8 is further provided with a controller 5 for controlling the drive part 4 to switch the flow paths of a fluid, as shown in FIG. 59. This controller 5 stores a predetermined control program and is configured to control the drive part 4 to execute “flow path switching control” which will be described later.

### Sliding Resistance Reducing Structure

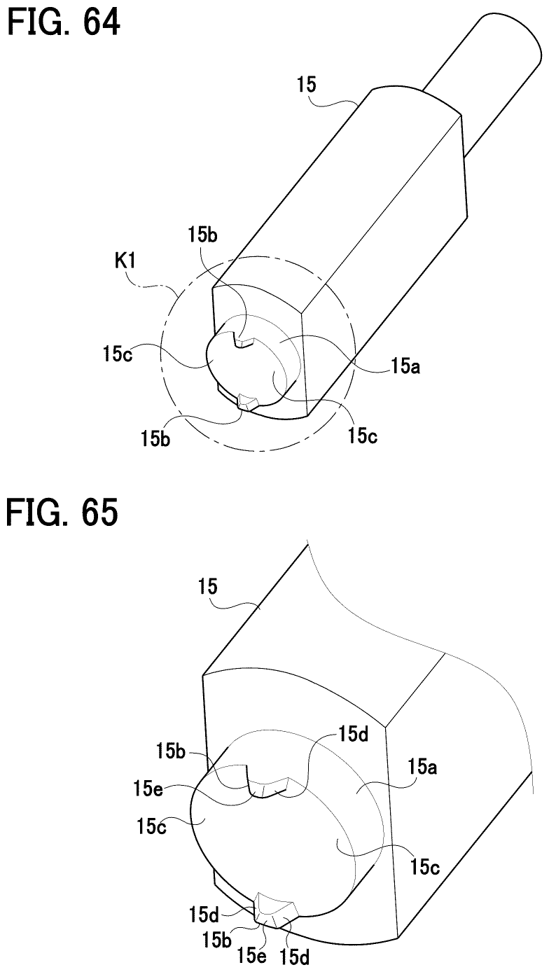

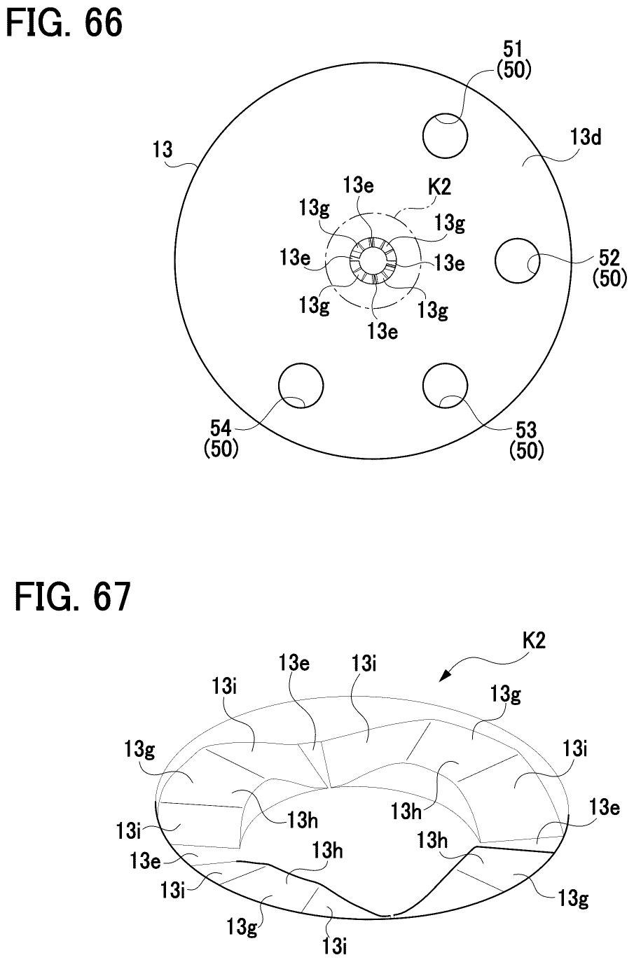

The flow path switching device 8 in this embodiment also differs from each of the above-mentioned embodiments in the configuration of the “sliding resistance reducing structure”. FIG. 63 is an enlarged plan view showing the part corresponding to the through hole 14a and the rotary shaft 15 in FIG. 62. FIG. 64 is a perspective view showing the rotary shaft 15 in this embodiment. FIG. 65 is an enlarged perspective view showing the engaging structure K1 of a leading end portion of the rotary shaft 15 shown in FIG. 64. FIG. 66 is a plan view showing the fixed disk 13 in this embodiment. FIG. 67 is an enlarged perspective view showing the engaged structure K2 of the fixed disk 13 shown in FIG. 66.

In this embodiment, the basic structures of the fixed disk 13, rotary disk 14, rotary shaft 15, upper seal member 17, and lower seal member 18 are similar to those in each of the foregoing embodiments excepting the placements and the shapes of the inflow paths 20, outflow paths 30, and rotation communication paths 40, and different in the following configurations. Specifically, as shown in FIG. 66, the placement of the fixed communication paths 50 (51 to 54) of the fixed disk 13 are arranged unevenly on almost one half of the upper surface of the fixed disk 13, and adjacent ones are arranged at equal angle (60°) intervals so as to match with the placement of the outflow paths 30 of the lower housing 12.

Furthermore, this embodiment differs from each of the above-described embodiments in the engaging structure K1 of the rotary shaft 15 and the engaged structure K2 of the fixed disk 13. Specifically, as shown in FIGS. 64 and 65, the engaging structure K1 provided in the leading end portion of the rotary shaft 15, unlike those in each of the above-mentioned embodiments, includes two shaft protrusions 15b and two shaft recesses 15c, which are arranged in the circumferential direction. The two shaft protrusions 15b are arranged at equal angular (180°) intervals, and a shaft recess 15c is formed between the shaft protrusions 15b. Each shaft protrusion 15b has the same shape as that in each of the above-described embodiments, and the length of the bottom portion of each shaft recess 15c in the circumferential direction is longer than that in each of the above-described embodiments.

On the other hand, as shown in FIGS. 66 and 67, each disk protrusion 13g and each disk recess 13e constituting the engaged structure K2 of the fixed disk 13 are arranged at equal angular (90°) intervals. Each of the disk protrusions 13g includes side surfaces 13i each inclined in their circumferential direction (arrangement direction). The inclination angles of both the side surfaces 13i are set equal. Those side surfaces 13i are also side surfaces of the disk recesses 13e. In this embodiment, in each disk protrusion 13g, its top portion 13h forms a flat surface and both sides of the top portion 13h form the inclined side surfaces 13i. Further, each disk recess 13e has a bottom portion that is a flat surface.

### Switching of Flow Path Patterns

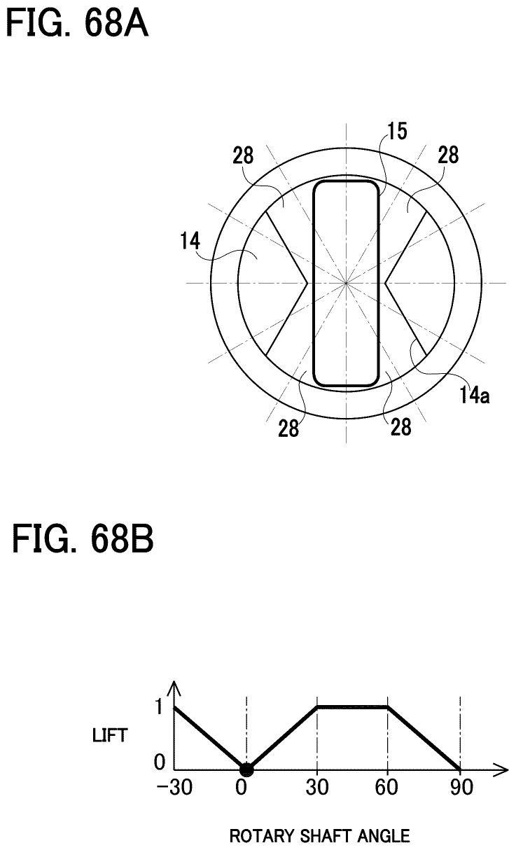

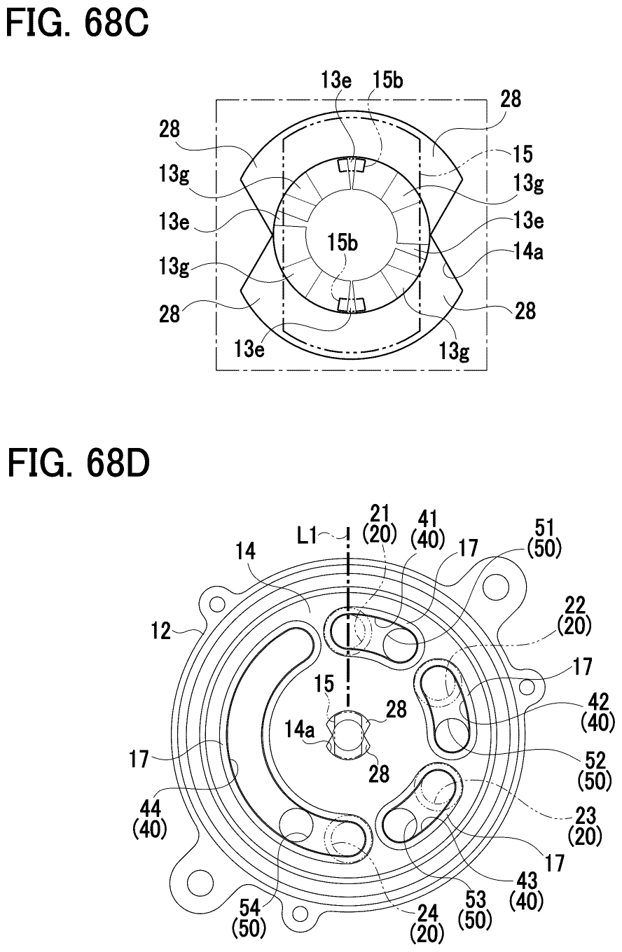

The flow path switching device 8 in this embodiment is configured as above to switch the flow paths of a fluid between three patterns. FIGS. 68A to 80D show operation diagrams related to switching of flow path patterns.

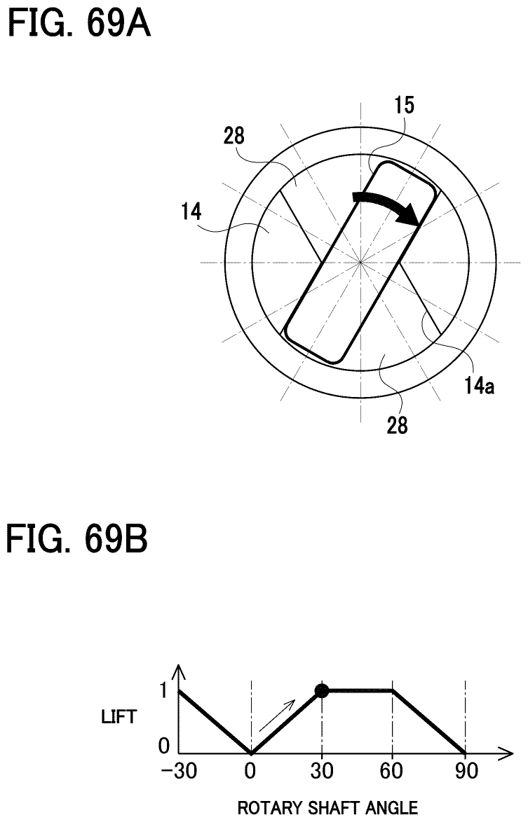

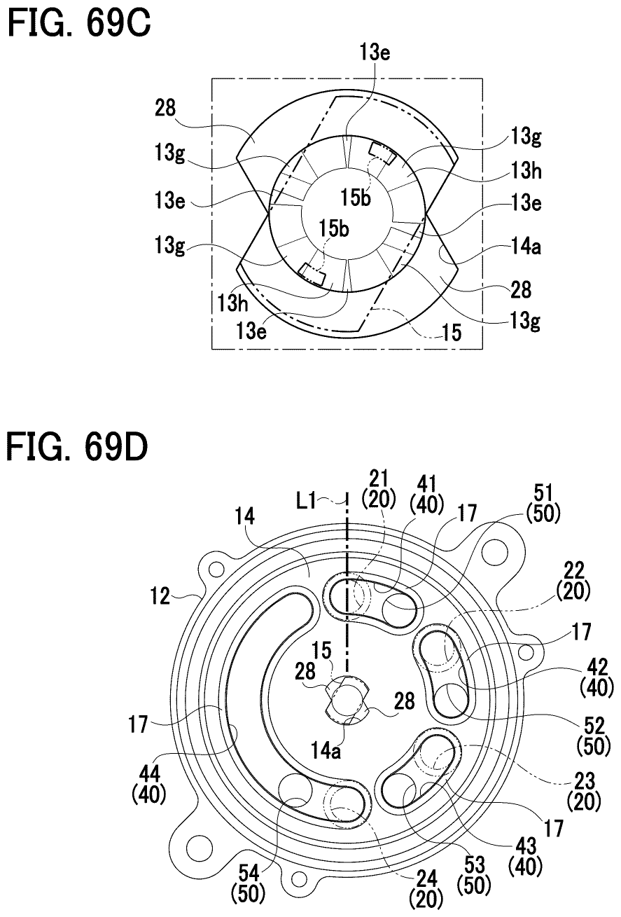

FIGS. 68A to 68D show the “initial state” of the flow path switching device 8 in this embodiment; FIG. 68A is an image diagram showing an engagement relationship between the through hole 14a of the rotary disk 14 and the rotary shaft 15. FIGS. 69A, 70A, 71A, 72A, 73A, 74A, 75A, 76A, 77A, 78A, 79A, and 80A, which will be described later, are image diagrams similar to FIG. 68A. FIG. 68B is an image diagram showing changes in lifting of the rotary shaft 15 with respect to the rotary shaft angle. FIGS. 69B, 70B, 71B, 72B, 73B, 74B, 75B, 76B, 77B, 78B, 79B, and 80B, which will be described later, are image diagrams similar to FIG. 68B. FIG. 68C is a plan diagram showing the rotational position of the through hole 14a and the rotary shaft 15 and the positional relationship between the disk protrusions 13g and the disk recesses 13e with the shaft protrusions 15b. FIGS. 69C, 70C, 71C, 72C, 73C, 74C, 75C, 76C, 77C, 78C, 79C, and 80C, which will be described later, are plan diagrams similar to FIG. 68C. FIG. 68D is a plan diagram, similar to FIG. 62, showing the rotational position of the rotary disk 14 and the rotation communication paths 40. FIGS. 69D, 70D, 71D, 72D, 73D, 74D, 75D, 76D, 77D, 78D, 79D, and 80D, which will be described later, are plan diagrams similar to FIG. 68D.

In this “initial state”, as shown in FIG. 68A, the rotary shaft 15 is positioned in the through hole 14a with gaps 28 on both sides in the rotation direction and, as shown in FIG. 68B, the rotary shaft 15 lifts down. Further, as shown in FIG. 68C, the shaft protrusions 15b ride down into the disk recesses 13e. Furthermore, the rotary disk 14 and the rotation communication paths 40 are placed in the state shown in FIG. 68D. At the time, the first rotation communication path 41 communicates with the first inflow path 21 and the first fixed communication path 51, the second rotation communication path 42 communicates with the second inflow path 22 and the second fixed communication path 52, the third rotation communication path 43 communicates with the third inflow path 23 and the third fixed communication path 53, and the fourth rotation communication path 44 communicates with the fourth inflow path 24 and the fourth fixed communication path 54. The disk rotating angle at that time is defined as 0°, and this flow path switching state is defined as the “pattern A”.

Next, changes from the “initial state” will be described in sequence. FIGS. 69A to 69D show a “30° rotational state” to which the rotary shaft 15 rotates 30° clockwise from the “initial state”. In this state, as shown in FIG. 69A, the rotary shaft 15 idle-rotates 30° clockwise from the “initial state” and engages one inner wall of the through hole 14a, and hence the rotary shaft 15 lifts up as shown in FIG. 69B. Further, as shown in FIG. 69C, the shaft protrusions 15b ride on one side edges of the top portions 13h of the disk protrusions 13g. Furthermore, as shown in FIG. 69D, the disk rotating angle remains 0°, and the flow path switching state of the rotation communication paths 40 is the same “pattern A” as in the “initial state”.

As described above, in this embodiment, the “idle-rotating angle” to idle-rotate the rotary shaft 15 clockwise when the shaft protrusions 15b ride on the disk protrusions 13g from the disk recesses 13e is set to 30°. In this embodiment, further, in the “initial state” shown in FIG. 68A, the rotary shaft 15 is positioned in the through hole 14a with the gaps 28 on both sides in the rotation direction, and thus, this configuration is a “two-way idle-rotating type” that allows the rotary shaft 15 to idle-rotate clockwise and counterclockwise.

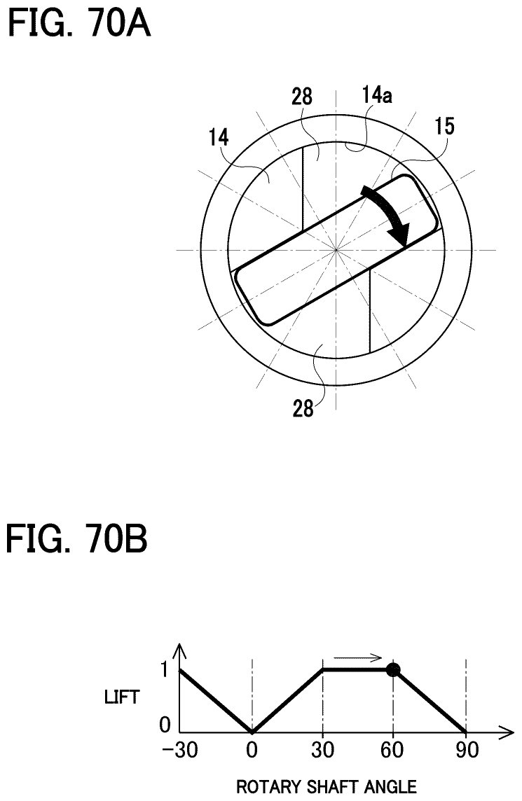

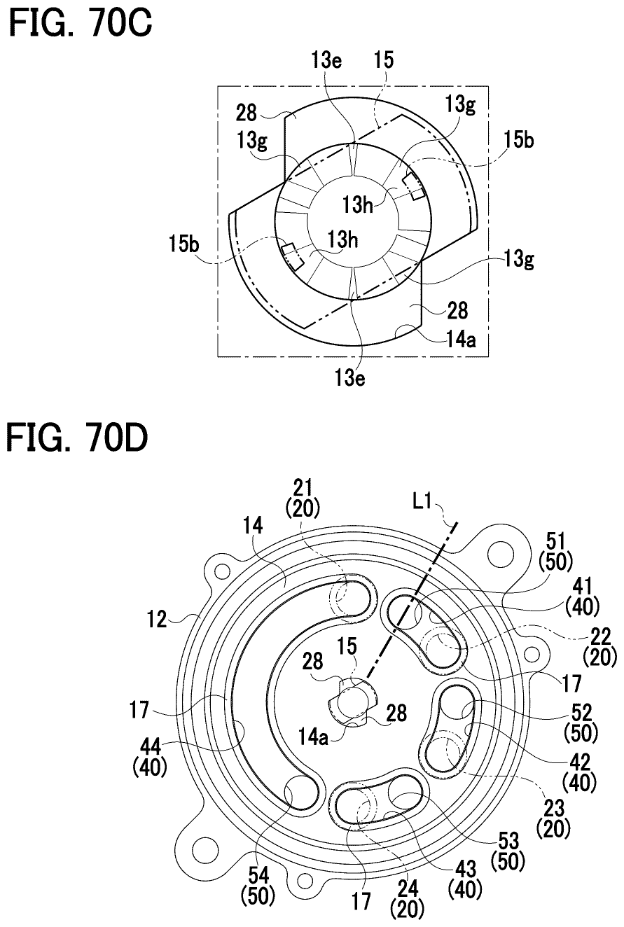

Next, FIGS. 70A to 70D show a “60° rotational state” to which the rotary shaft 15 further rotates 30° clockwise from the “30° rotational state”. In this state, as shown in FIG. 70A, the rotary shaft 15 rotates 30° clockwise together with the rotary disk 14 and, as shown in FIG. 70B, the rotary shaft 15 rotates clockwise while remaining lifted up. Further, as shown in FIG. 70C, the shaft protrusions 15b ride on the other side edges of the top portions 13h of the disk protrusions 13g. Furthermore, as shown in FIG. 70D, the rotation communication paths 40 rotate 30° clockwise. In this “60° rotational state”, the first rotation communication path 41 communicates with the second inflow path 22 and the first fixed communication path 51, the second rotation communication path 42 communicates with the third inflow path 23 and the second fixed communication path 52, the third rotation communication path 43 communicates with the fourth inflow path 24 and the third fixed communication path 53, and the fourth rotation communication path 44 communicates with the first inflow path 21 and the fourth fixed communication path 54. The disk rotating angle at that time is 30°, and this flow path switching state is defined as the “pattern B”. That is, between the “30° rotational state” and “60° rotational state”, holding of the rotary shaft 15 lifted up and switching of the flow paths are performed simultaneously.

In this embodiment, as described above, the “switching angle” to rotate the rotary disk 14 to switch the flow paths in the flow path switching device 8 is set to 30°. In this embodiment, specifically, the clockwise “idle-rotating angle” of the rotary shaft 15 and the “switching angle” of the rotary disk 14 to switch the flow paths are set to the same 30°.

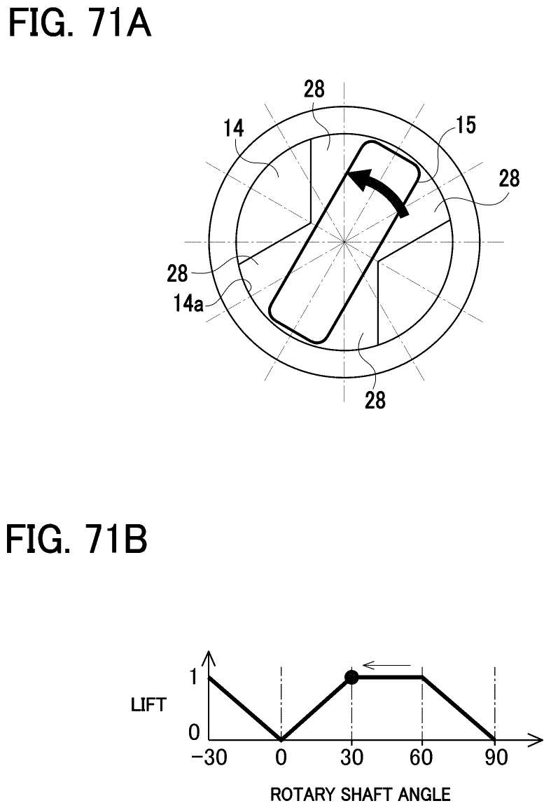

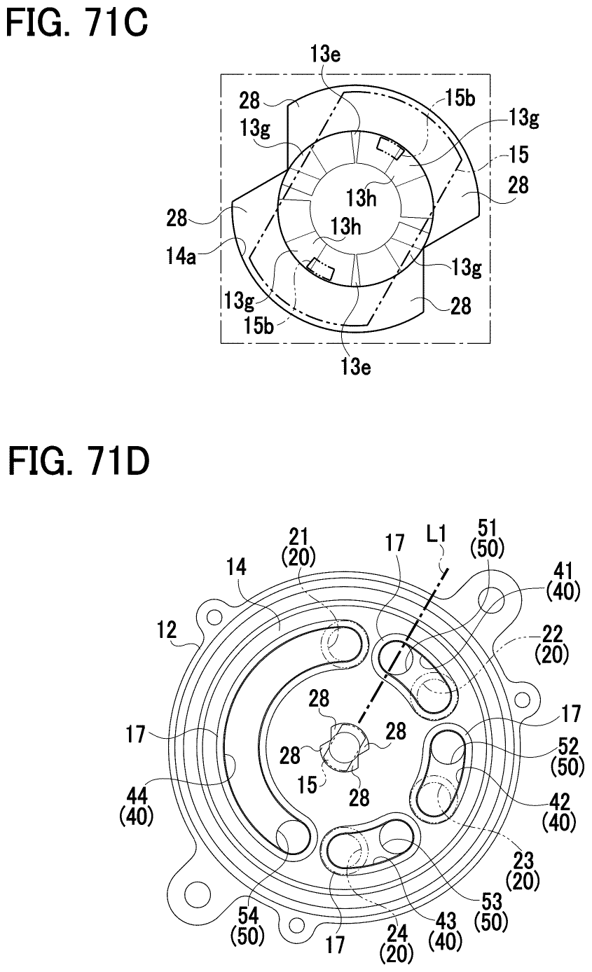

Next, FIGS. 71A to 71D show a “return-30° rotational state” to which the rotary shaft 15 rotates 30° counterclockwise from the “60° rotational state”. In this state, as shown in FIG. 71A, the rotary shaft 15 idle-rotates 30° counterclockwise, and the rotary shaft 15 rotates counterclockwise while remaining lifted up as shown in FIG. 71B. Further, as shown in FIG. 71C, the shaft protrusions 15b ride on one side edges of the top portions 13h of the disk protrusions 13g. Furthermore, as shown in FIG. 71D, the rotation communication paths 40 stay at the same positions as in the “60° rotational state”, and the disk rotating angle remains 30°. The flow path switching state at that time is the same “pattern B” as in the “60° rotational state”.

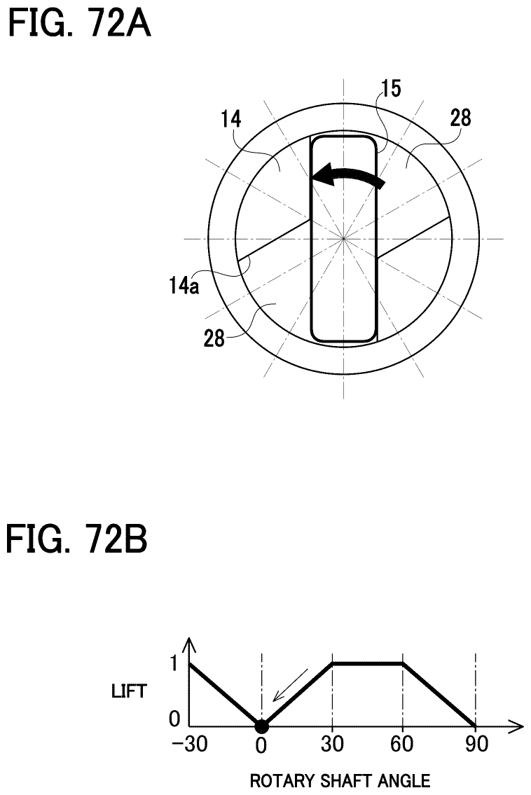

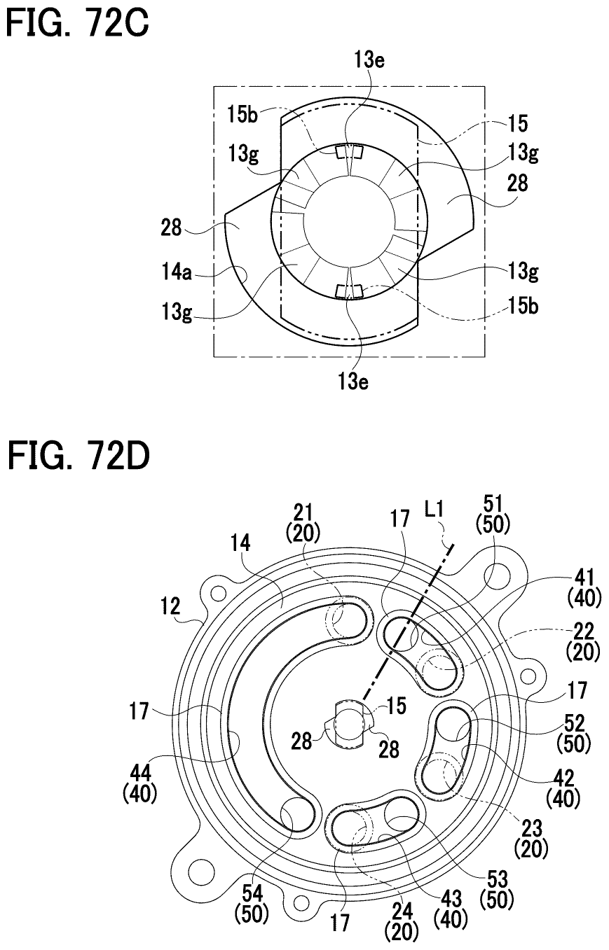

Next, FIGS. 72A to 72D show a “return-0° rotational state” to which the rotary shaft 15 further rotates 30° counterclockwise from the “return- 30° rotational state”. In this state, as shown in FIG. 72A, the rotary shaft 15 idle-rotates 30° counterclockwise and engages with one inner wall of the through hole 14a, and the rotary shaft 15 lifts down as shown in FIG. 72B. Still further, as shown in FIG. 72C, the shaft protrusions 15b ride down into the disk recesses 13e. Furthermore, as shown in FIG. 72D, the rotation communication paths 40 stay at the same positions as in the “return-30° rotational state”, and the disk rotating angle remains 30°. The flow path switching state at that time is the same “pattern B” as in the “60° rotational state”.

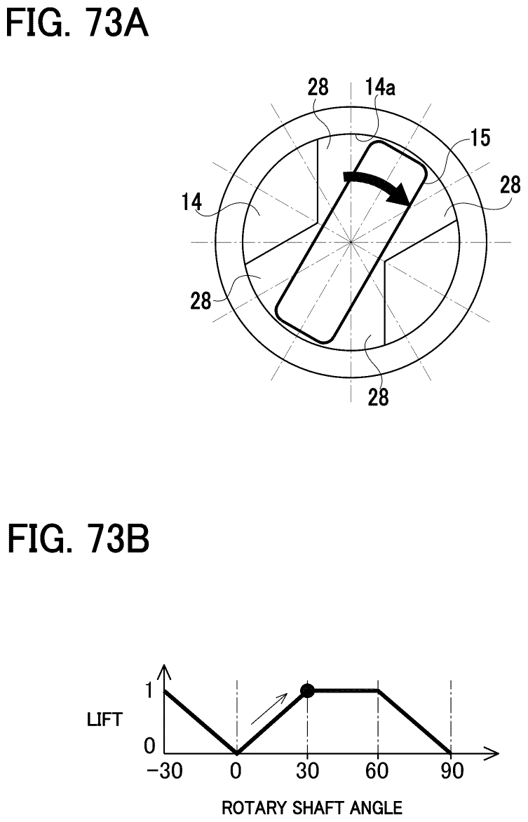

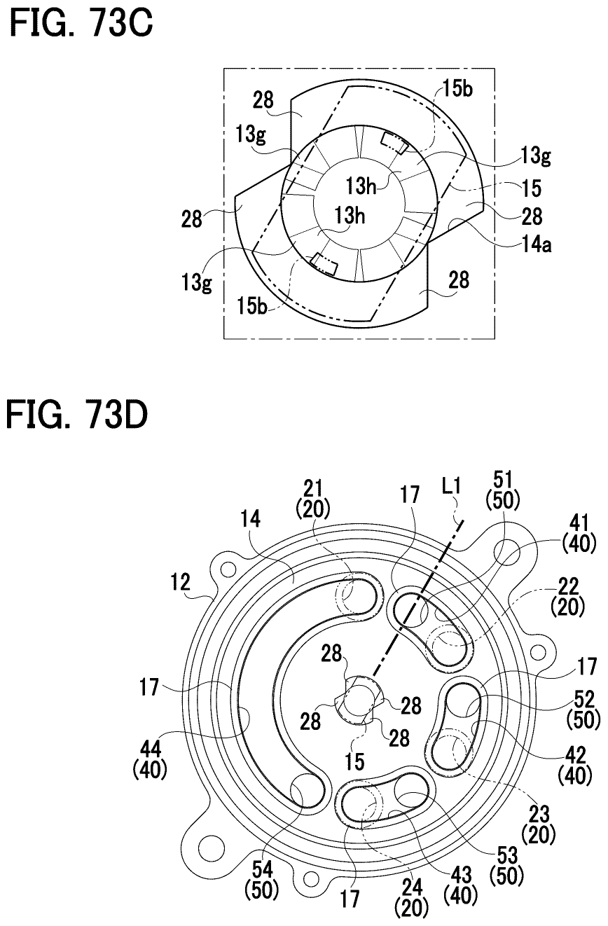

Next, FIGS. 73A to 73D show a “re-30° rotational state” to which the rotary shaft 15 rotates 30° clockwise from the “return-0° rotational state”. In this state, as shown in FIG. 73A, the rotary shaft 15 idle-rotates 30° clockwise from the “return-0° rotational state”, and the rotary shaft 15 lifts up as shown in FIG. 73B. Further, as shown in FIG. 73C, the shaft protrusions 15b ride on the one side edges of the top portions 13h of the disk protrusions 13g. Furthermore, as shown in FIG. 73D, the rotation communication paths 40 stay at the same position as in the “return-0° rotational state”, and the disk rotating angle remains 30°. The flow path switching state at that time is the same “pattern B” as in the “return-0° rotational state”.

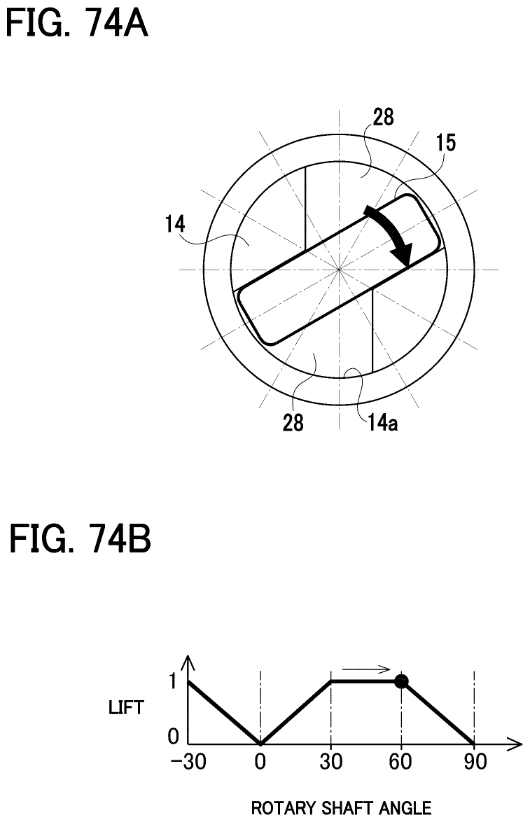

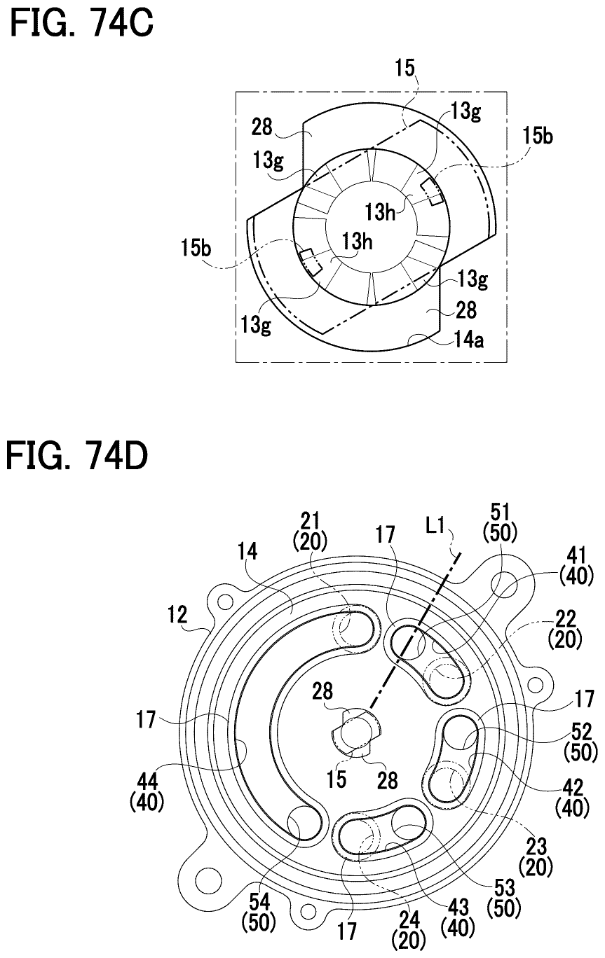

Next, FIGS. 74A to 74D show a “re-60° rotational state” to which the rotary shaft 15 rotates 30° clockwise from the “re-30° rotational state”. In this state, as shown in FIG. 74A, the rotary shaft 15 idle-rotates 30° clockwise and engages with the other inner wall of the through hole 14a, and the rotary shaft 15 rotates clockwise while remaining lifted up as shown in FIG. 74B. Further, as shown in FIG. 74C, the shaft protrusions 15b ride on the other side edges of the top portions 13h of the disk protrusions 13g. Further, as shown in FIG. 74D, the rotation communication paths 40 stay at the same position as in the “re-30° rotational state”, and the disk rotating angle remains 30°. The flow path switching state at that time is the same “pattern B” as in the “re-30° rotational state”.

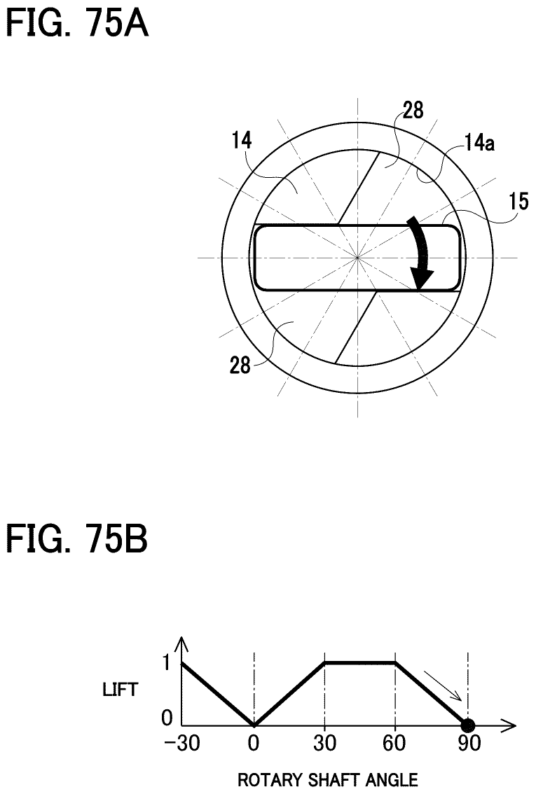

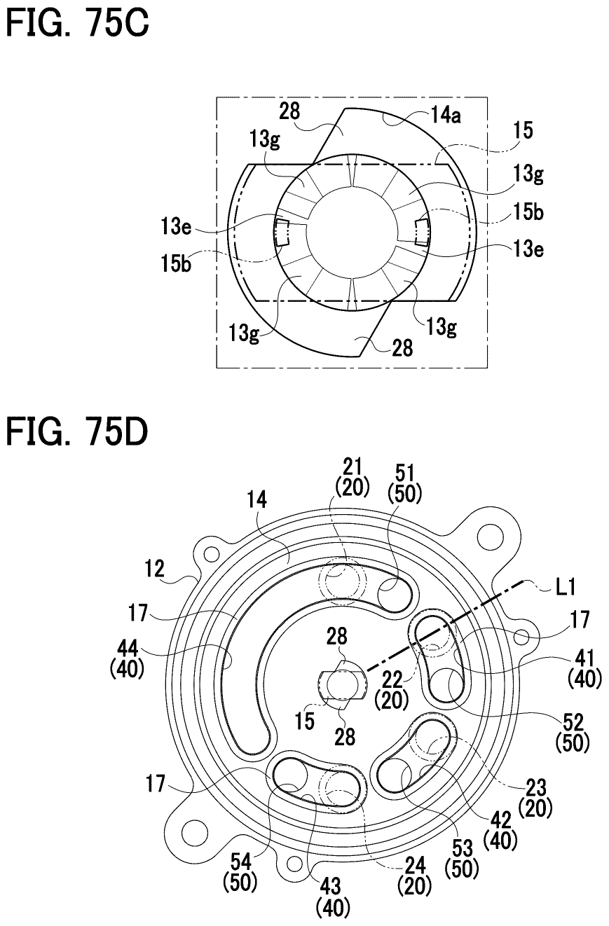

Next, FIGS. 75A to 75D show a “90° rotational state” to which the rotary shaft 15 rotates 30° clockwise from the “re-60° rotational state”. In this state, as shown in FIG. 75A, the rotary shaft 15 rotates 30° clockwise together with the rotary disk 14, and the rotary shaft 15 lifts down as shown in FIG. 75B. Further, as shown in FIG. 75C, the shaft protrusions 15b ride down from the top portions 13h of the disk protrusions 13g into the disk recesses 13e. Further, as shown in FIG. 74D, the rotation communication paths 40 rotate 30° clockwise. In this “90° rotational state”, the first rotation communication path 41 communicates with the second inflow path 22 and the second fixed communication path 52, the second rotation communication path 42 communicates with the third inflow path 23 and the third fixed communication path 53, the third rotation communication path 43 communicates with the fourth inflow path 24 and the fourth fixed communication path 54, and the fourth rotation communication path 44 communicates with the first inflow path 21 and the first fixed communication path 51. The disk rotating angle at that time is 60°, and the flow path switching state at that time is defined as the “patten C”. Specifically, between the “re-60° rotational state” and the “90° rotational state”, lifting down of the rotary shaft 15 and switching of the flow paths are performed simultaneously.

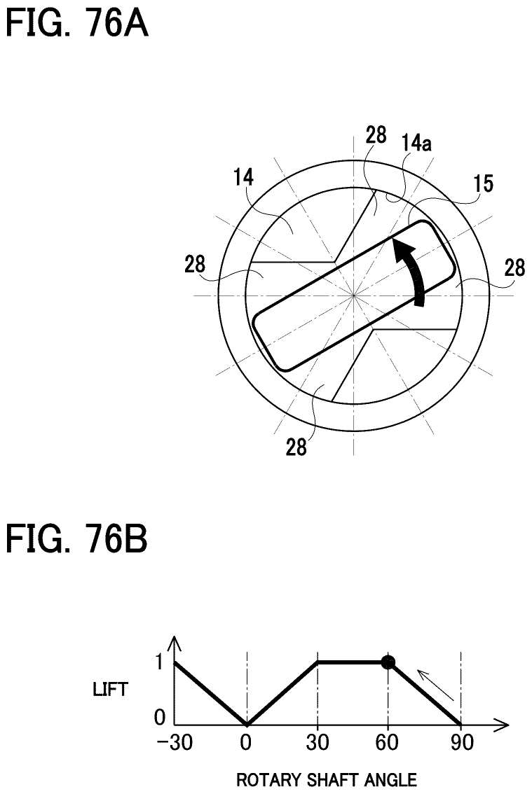

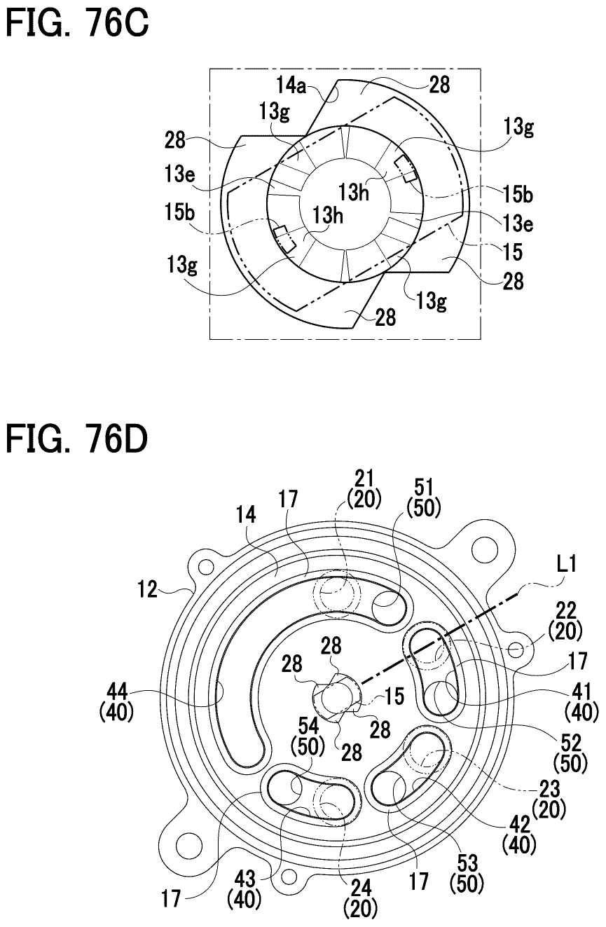

Next, FIGS. 76A to 76D show a “return-60° rotational state” to which the rotary shaft 15 rotates 30° counterclockwise from the “re-90° rotational state”. In this state, as shown in FIG. 76A, the rotary shaft 15 idle-rotates 30° counterclockwise, and the rotary shaft 15 lifts up as shown in FIG. 76B. Further, as shown in FIG. 76C, the shaft protrusions 15b ride on the other side edges of the top portions 13h of the disk protrusions 13g. Further, as shown in FIG. 76D, the rotation communication paths 40 stay at the same position as in the “90° rotational state”, and the disk rotating angle remains 60°. The flow path switching state at that time is the same “pattern C” as in the “90° rotational state”.

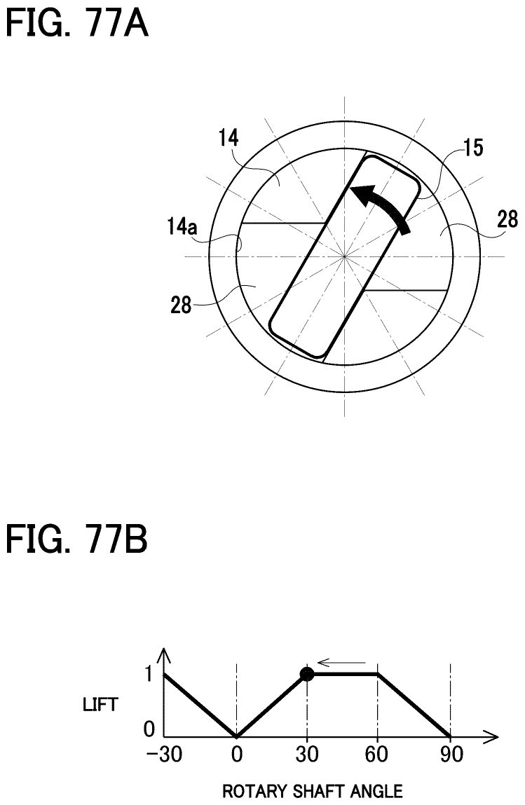

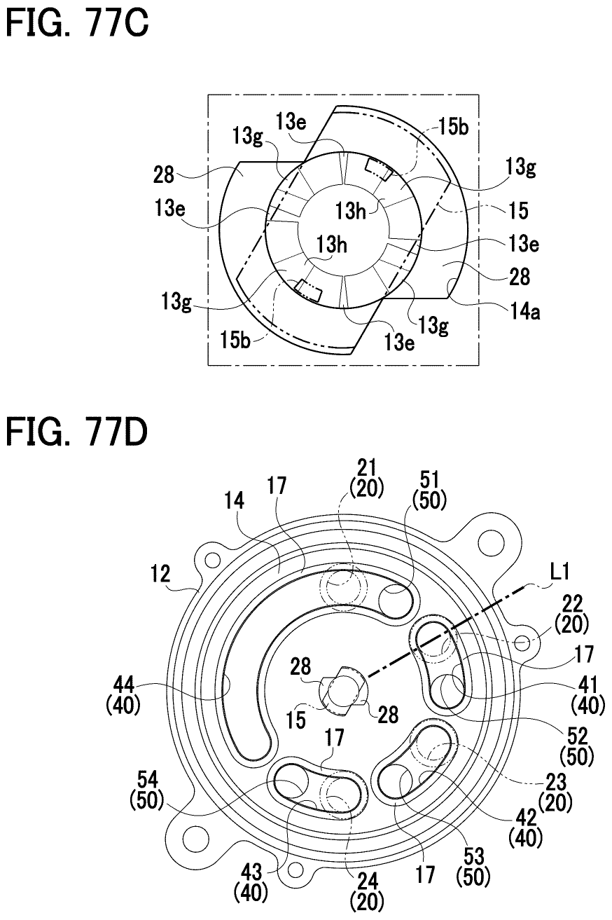

Next, FIGS. 77A to 77D show the “return-30° rotational state” to which the rotary shaft 15 rotates 30° counterclockwise from the “return-60° rotational state”. In this state, as shown in FIG. 77A, the rotary shaft 15 idle-rotates 30° counterclockwise and engages with one inner wall of the through hole 14a, and the rotary shaft 15 rotates counterclockwise while remaining lifted up as shown in FIG. 77B. Further, as shown in FIG. 77C, the shaft protrusions 15b ride on the one side edges of the top portions 13h of the disk protrusions 13g. Furthermore, as shown in FIG. 77D, the rotation communication paths 40 stay at the same position as in the “return-60° rotational state”, and the disk rotating angle remains 60°. The flow path switching state at that time is the same “pattern C” as in the “return-60° rotational state”.

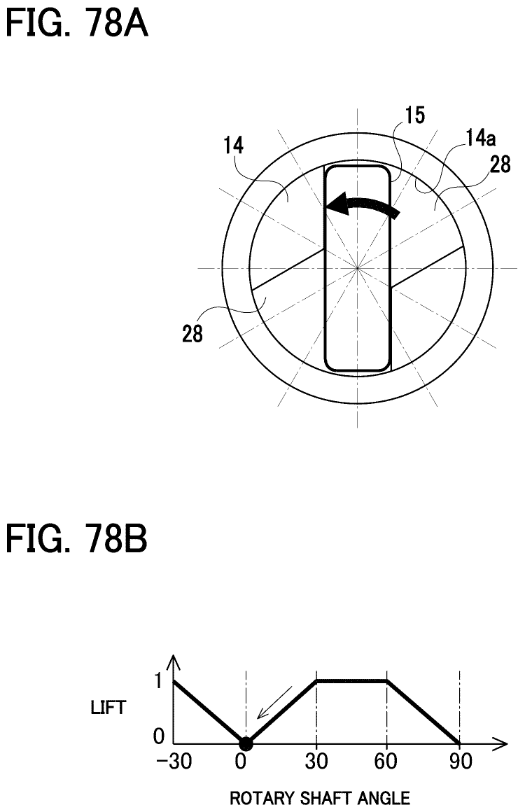

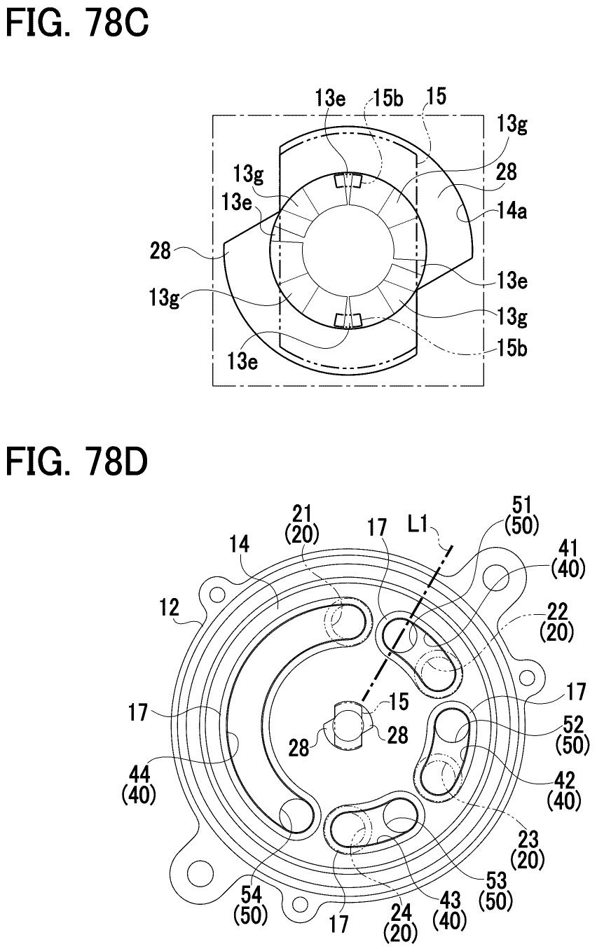

Next, FIGS. 78A to 78D show the “return-0° rotational state” to which the rotary shaft 15 rotates 30° counterclockwise from the “return-30° rotational state”. In this state, as shown in FIG. 78A, the rotary shaft 15 rotates 30° counterclockwise together with the rotary disk 14, and the rotary shaft 15 lifts down as shown in FIG. 78B. Further, as shown in FIG. 78C, the shaft protrusions 15b ride down into the disk recesses 13e. Further, as shown in FIG. 78D, the rotation communication paths 40 rotate 30° counterclockwise. The disk rotating angle at that time is 30° and the flow path switching state is the “pattern B”. Specifically, between the “return-30° rotational state” and the “return-0° rotational state”, lifting down of the rotary shaft 15 and switching of the flow paths are performed simultaneously.

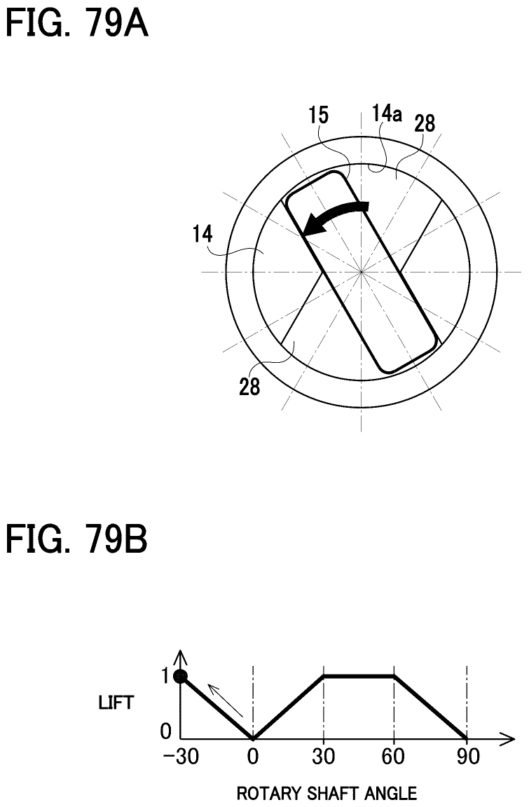

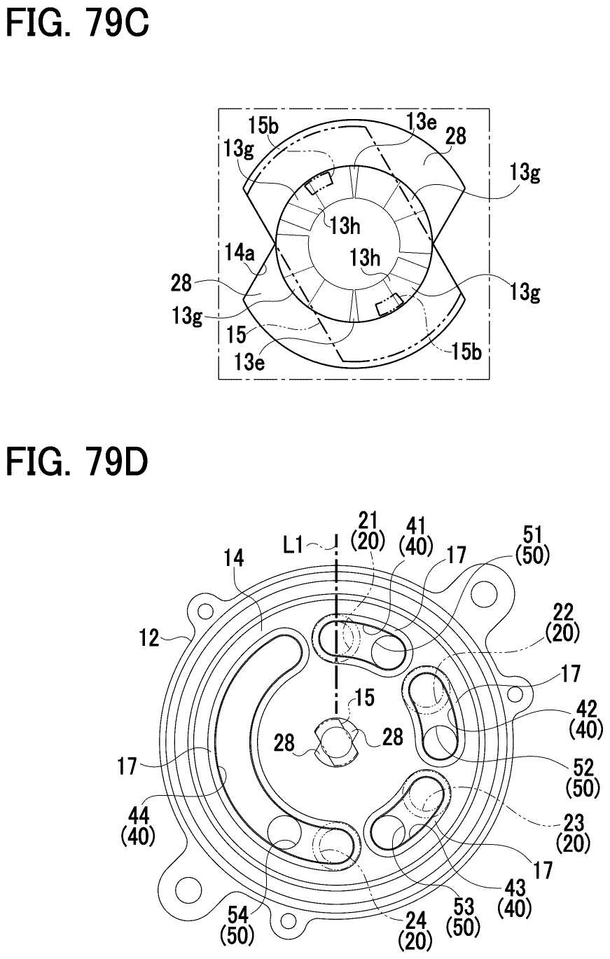

Next, FIGS. 79A to 79D show a “−30° rotational state” to which the rotary shaft 15 rotates 30° counterclockwise from the “return-0° rotational state”. In this state, as shown in FIG. 79A, the rotary shaft 15 rotates 30° counterclockwise together with the rotary disk 14, and the rotary shaft 15 lifts up as shown in FIG. 79B. Further, as shown in FIG. 79C, the shaft protrusions 15b ride on the disk protrusions 13g. Further, as shown in FIG. 79D, the rotation communication paths 40 rotate 30° counterclockwise. The disk rotating angle at that time is 0°, and the flow path switching state at that time is as the “patten A”. Specifically, between the “return-0° rotational state” and the “−30° rotational state”, lifting up of the rotary shaft 15 and switching of the flow paths are performed simultaneously.

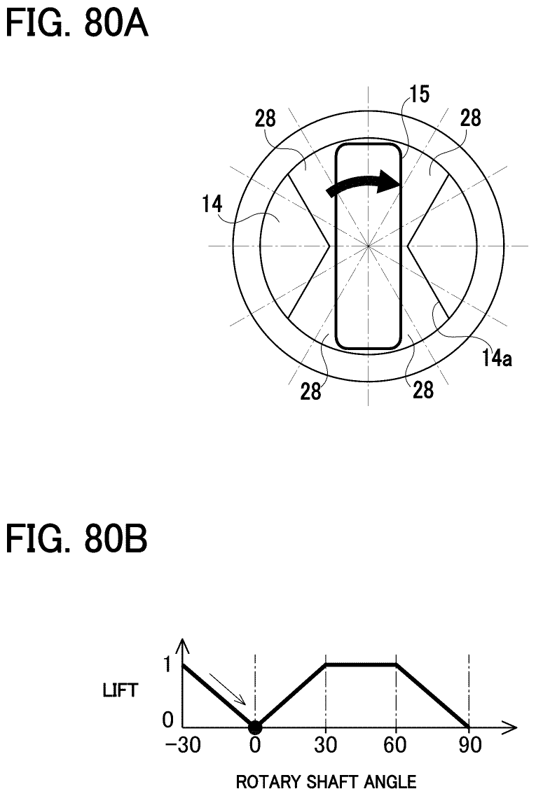

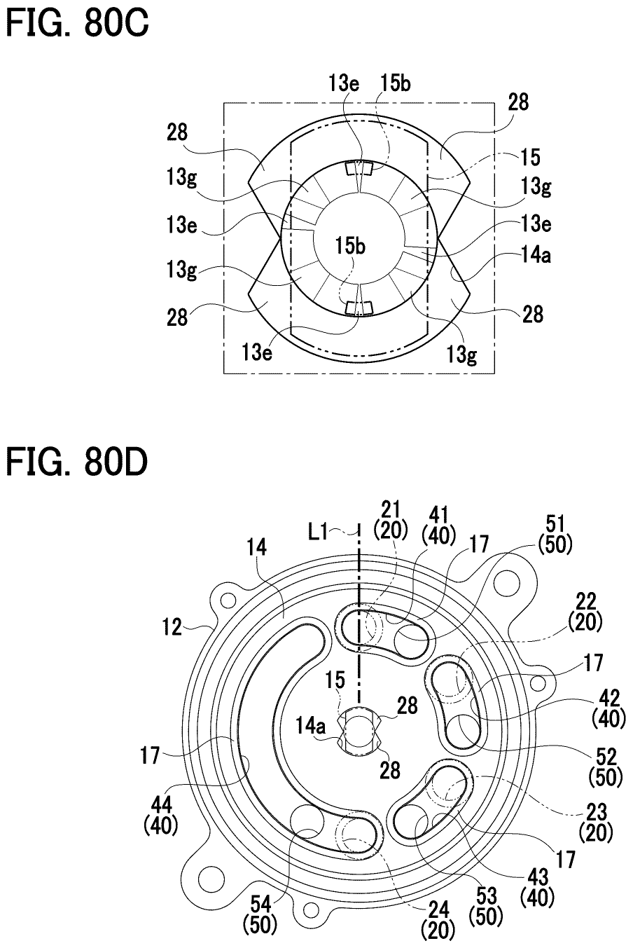

Next, FIGS. 80A to 80D show a “return-initial state” to which the rotary shaft 15 rotates 30° clockwise from the “−30° rotational state”. In this state, as shown in FIG. 80A, the rotary shaft 15 idle-rotates 30° clockwise, and the rotary shaft 15 lifts down as shown in FIG. 80B. Further, as shown in FIG. 80C, the shaft protrusions 15b ride down into the disk recess 13e. Further, as shown in FIG. 80D, the rotation communication paths 40 stay at the same position as in the “initial state”, and the disk rotating angle remains 0°. The flow path switching state at that time is the same “pattern A” as in the “initial state”.

### Flow Path Switching Control

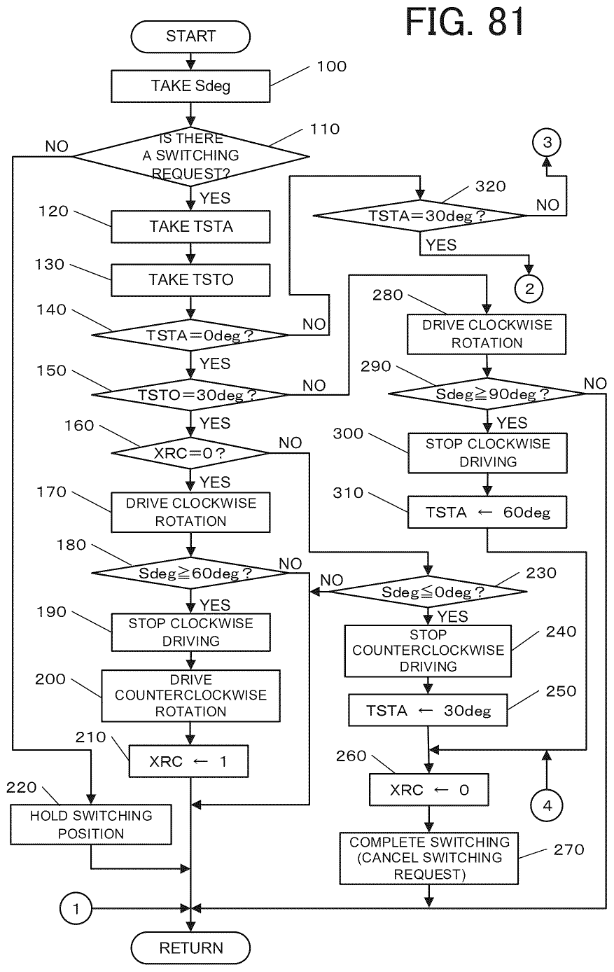

Next, the “flow path switching control” of the flow path switching device 8 in this embodiment to be executed by the controller 5 will be described below. FIGS. 81 to 83 are flowcharts showing one example of contents of the control.

When the process advances to this control routine, the controller 5 takes a rotary angle (a rotary shaft angle) Sdeg of the rotary shaft 15 in step 100. Herein, the housing 2 of the flow path switching device 8 is provided with a first angle sensor (not shown) for detecting the rotary shaft angle Sdeg, and the controller 5 is configured to take the rotary shaft angle Sdeg based on a detection value of that angle sensor.

In step 110, subsequently, the controller 5 determines whether or not there is a flow path switching request. This switching request may be assumed to be issued by, e.g., a control device that controls a fluid circuit in which the flow path switching device 8 is provided. The controller 5 advances the process to step 120 when this determination result is affirmative, but shifts the process to step 220 when this determination result is negative.

In step 220, the controller 5 keeps the switching position of the flow path switching device 8 and returns the process to step 100.

In step 120, the controller 5 takes a stop angle (a pre-switching disk stop angle) TSTA of the rotary disk 14 before switching. Herein, the housing 2 of the flow path switching device 8 is provided with a second angle sensor (not shown) for detecting the disk rotating angle, and the controller 5 is configured to take the pre-switching disk stop angle TSTA based on a detection value of that angle sensor.

In step 130, the controller 5 takes a stop angle (a switching request disk stop angle) TSTO of the rotary disk 14 that is requested to be switched. This switching request disk stop angle TSTO may be assumed to be issued by, e.g., the control device that controls the fluid circuit in which the flow path switching device 8 is provided.

In step 140, the controller 5 then determines whether or not the pre-switching disk stop angle TSTA is 0 deg., i.e., 0°. The controller 5 advances the process to step 150 when this determination result is affirmative, but shifts the process to step 320 when this determination result is negative.

In step 150, the controller 5 determines whether or not the switching request disk stop angle TSTO is 30 deg., i.e., 30°. The controller 5 advances the process to step 160 when this determination result is affirmative, but shifts the process to step 280 when this determination result is negative.

In step 160, the controller 5 determines whether or not a reverse control flag XRC is 0. The controller 5 is configured, as described later, to set this flag XRC to 1 when the rotary shaft 15 is rotated counterclockwise, and to 0 when the rotary shaft 15 is rotated clockwise. The controller 5 advances the process to step 170 when this determination result is affirmative, but shifts the process to step 230 when this determination result is negative.

In step 170, the controller 5 controls the drive part 4 to rotationally drive the rotary shaft 15 clockwise.

In step 180, subsequently, the controller 5 determines whether or not the rotary shaft angle Sdeg is 60 deg. or more, i.e., 60° or more. The controller 5 advances the process to step 190 when this determination result is affirmative, but returns the process to step 100 when this determination result is negative.

In step 190, the controller 5 controls the drive part 4 to stop clockwise driving of the rotary shaft 15.

In step 200, the controller 5 then controls the drive part 4 to rotationally drive the rotary shaft 15 counterclockwise.

In step 210, the controller 5 sets the reverse control flag XRC to 1.

On the other hand, in step 230 shifted from step 160, the controller 5 determines whether or not the rotary shaft angle Sdeg is 0 deg. or less, i.e., 0° or less. The controller 5 advances the process to step 240 when this determination result is affirmative, but returns the process to step 100 when this determination result is negative.

In step 240, the controller 5 controls the drive part 4 to stop counterclockwise driving of the rotary shaft 15.

In step 250, the controller 5 sets the pre-switching disk stop angle TSTA to 30 deg., i.e., 30°.

In step 260, the controller 5 sets the reverse control flag XRC to 0.

In step 270, the controller 5 completes the flow path switching. In other words, the controller 5 cancels the switching request and returns the process to step 100.

On the other hand, in step 280 shifted from step 150, the controller 5 controls the drive part 4 to rotationally drive the rotary shaft 15 clockwise.

In step 290, the controller 5 determines whether or not the rotary shaft angle Sdeg is 90 deg. or more, i.e., 90° or more. The controller 5 advances the process to step 300 when this determination result is affirmative, but returns the process to step 100 when this determination result is negative.

In step 300, the controller 5 controls the drive part 4 to stop clockwise driving of the rotary shaft 15.

In step 310, the controller 5 sets the pre-switching disk stop angle TSTA to 60 deg., i.e., 60°, and shifts the process to step 260.

On the other hand, in step 320 shifted from step 140, the controller 5 determines whether or not the pre-switching disk stop angle TSTA is 30 deg. The controller 5 advances the process to step 330 when this determination result is affirmative, but shifts the process to step 470 when this determination result is negative.

In step 330 shifted from step 320, the controller 5 determines whether or not the switching request disk stop angle TSTO is 0 deg., i.e., 0°. The controller 5 advances the process to step 340 when this determination result is affirmative, but shifts the process to step 400 when this determination result is negative.

In step 340, the controller 5 determines whether or not the reverse control flag XRC is 0. The controller 5 advances the process to step 350 when this determination result is affirmative, but shifts the process to step 440 when this determination result is negative.

In step 350, the controller 5 controls the drive part 4 to rotationally drive the rotary shaft 15 counterclockwise.

In step 360, the controller 5 determines whether or not the rotary shaft angle Sdeg is −30 deg. or less, i.e., −30° or less. The controller 5 advances the process to step 370 when this determination result is affirmative, but returns the process to step 100 when this determination result is negative.

In step 370, the controller 5 controls the drive part 4 to stop counterclockwise driving of the rotary shaft 15.

In step 380, the controller 5 controls the drive part 4 to rotationally drive the rotary shaft 15 clockwise.

In step 390, the controller 5 sets the reverse control flag XRC to 1, and returns the process to step 100.

On the other hand, in step 400 shifted from step 330, the controller 5 controls the drive part 4 to rotationally drive the rotary shaft 15 clockwise.

In step 410, the controller 5 determines whether or not the rotary shaft angle Sdeg is 90 deg. or more. The controller 5 advances the process to step 420 when this determination result is affirmative, but returns the process to step 100 when this determination result is negative.

In step 420, the controller 5 controls the drive part 4 to stop clockwise driving of the rotary shaft 15.

In step 430, the controller 5 sets the pre-switching disk stop angle TSTA to 60 deg., and shifts the process to step 260.

On the other hand, in step 440 shifted from step 340, the controller 5 determines whether or not the rotary shaft angle Sdeg is 0 deg. or more. The controller 5 advances the process to step 450 when this determination result is affirmative, but returns the process to step 100 when this determination result is negative.

In step 450, the controller 5 controls the drive part 4 to stop clockwise driving of the rotary shaft 15.

In step 460, the controller 5 sets the pre-switching disk stop angle TSTA to 0 deg., and shifts the process to step 260.

On the other hand, in step 470 shifted from step 320, the controller 5 determines whether or not the switching request disk stop angle TSTO is 0 deg. The controller 5 advances the process to step 480 when this determination result is affirmative, but shifts the process to step 540 when this determination result is negative.

In step 480, the controller 5 determines whether or not the reverse control flag XRC is 0. The controller 5 advances the process to step 490 when this determination result is affirmative, but shifts the process to step 580 when this determination result is negative.

In step 490, the controller 5 controls the drive part 4 to rotationally drive the rotary shaft 15 counterclockwise.

In step 500, the controller 5 determines whether or not the rotary shaft angle Sdeg is −30 deg. or less. The controller 5 advances the process to step 510 when this determination result is affirmative, but returns the process to step 100 when this determination result is negative.

In step 510, the controller 5 controls the drive part 4 to stop counterclockwise driving of the rotary shaft 15.

In step 520, the controller 5 controls the drive part 4 to rotationally drive the rotary shaft 15 clockwise.

In step 530, the controller 5 sets the reverse control flag XRC to 1, and returns the process to step 100.

On the other hand, in step 540 shifted from step 470, the controller 5 controls the drive part 4 to rotationally drive the rotary shaft 15 counterclockwise.

In step 550, the controller 5 determines whether or not the rotary shaft angle Sdeg is 0 deg. or less. The controller 5 advances the process to step 560 when this determination result is affirmative, but returns the process to step 100 when this determination result is negative.

In step 560, the controller 5 controls the drive part 4 to stop counterclockwise driving of the rotary shaft 15.

In step 570, the controller 5 sets the pre-switching disk stop angle TSTA to 30 deg., and shifts the process to step 260.

In step 580 shifted from step 480, the controller 5 determines whether or not the rotary shaft angle Sdeg is 0 deg. or more. The controller 5 advances the process to step 590 when this determination result is affirmative, but returns the process to step 100 when this determination result is negative.

In step 590, the controller 5 controls the drive part 4 to stop clockwise driving of the rotary shaft 15.

In step 600, sets the pre-switching disk stop angle TSTA to 0 deg., and shifts the process to step 260.

In this embodiment, the drive part 4 corresponds to one example of “drive means” of this disclosure, and the controller 5 corresponds to one example of “control means” of this disclosure. Further, the controller 5 is configured to control the drive part 4 to rotate the rotary shaft 15 clockwise, and stop the rotation of the rotary shaft 15 when the leading end portion of the rotary shaft 15 contacts with the fixed disk 13, that is, when the flow paths are switched while the top portions 15e of the shaft protrusions 15b are in contact with the top portions 13h of the disk protrusions 13g, and then the rotary shaft 15 is rotated counterclockwise (in an opposite direction) and the leading end portion of the rotary shaft 15 engages with the fixed disk 13, i.e., when the shaft recesses 15c and shaft protrusions 15b respectively engage with the disk protrusions 13g and the disk recesses 13e.

### Operations and Effects of Flow Path Switching Device

According to the configuration of the flow path switching device 8 in this embodiment described above, the controller 5 controls the drive part 4 to rotate the rotary shaft 15 so that the top portions 15e of the shaft protrusions 15b come into contact with the top portions 13h of the disk protrusions 13g (the spacing between the upper housing 11 and the rotary disk 14 and the spacing between the fixed disk 13 and the rotary disk 14 are widened), switching the flow paths, and thereafter rotate the rotary shaft 15 counterclockwise (in the opposite direction) so that the shaft protrusions 15b and the shaft recesses 15c engage with the disk recesses 13e and the disk protrusions 13g (the spacing between the upper housing 11 and the rotary disk 14 and the spacing between the fixed disk 13 and the rotary disk 14 return to their original states), and stop the rotation of the rotary shaft 15. This ensures that the spacing between the upper housing 11 and the rotary disk 14 and the spacing between the fixed disk 13 and the rotary disk 14 are restored to respective original states. This can ensure the sealing property of the upper seal member 17 and the lower seal member 18.

In this embodiment, as shown in FIGS. 75A to 75D and FIGS. 78A to 78D, when the rotary disk 14 rotates, the rotary shaft 15 lifts down (the spacing between the fixed disk 13 and the upper housing 11 returns to its original state). This shows that when the flow paths are switched, the surface pressure applied on each seal member 17, 18 between the fixed disk 13 and the upper housing 11 is reduced, which can prevent each seal member 17, 18 from undergoing sliding wear and dislodging by drag. In addition, in this embodiment, unlike each of the foregoing embodiments, as shown in FIGS. 70A to 70D, the rotary disk 14 rotates while the rotary shaft 15 lifts up (the spacing between the fixed disk 13 and the upper housing 11 remains widened). Accordingly, at the time of switching the flow paths, each seal member 17, 18 can be more reliably prevented from sliding wear and dislodgement by drag.

In this embodiment, in the configuration that is the “two-way idle-rotating type” and allows the flow paths to be switched between three pattens, the “idle-rotating angle” of the rotary shaft 15 and the “switching angle” of the flow path are set to the same 30°. As shown FIGS. 70A to 70D, FIGS. 75A to 75D, and FIGS. 78A to 78D, therefore, when switching the flow paths, this configuration can lift up the rotary shaft 15 and thereafter simultaneously perform switch the flow paths and hold the rotary shaft 15 lifted up or lift down the rotary shaft 15. This can reduce the drive torque of the rotary shaft 15 (the drive torque of the drive part 4), and make the drive part 4 (the motor) compact.

### Seventh Embodiment

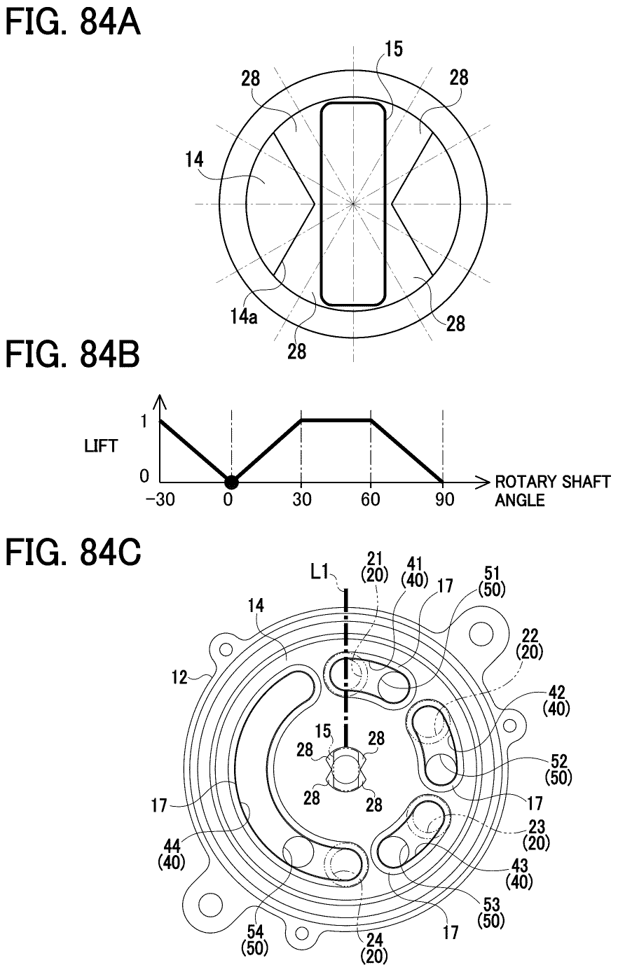

Next, a seventh embodiment will be described in detail below, referring to FIGS. 84A to 90C.

### Switching of Flow Path Patterns

The flow path switching device 8 in this embodiment differs from that in the sixth embodiment in switching of flow path patterns. In this embodiment, specifically, the flow path switching device 8 is configured to switch the flow paths of a fluid between two patterns by the same “two-way idle-rotating type” as in the sixth embodiment. FIGS. 84A to 90C are operation diagrams related to the switching of flow path patterns.

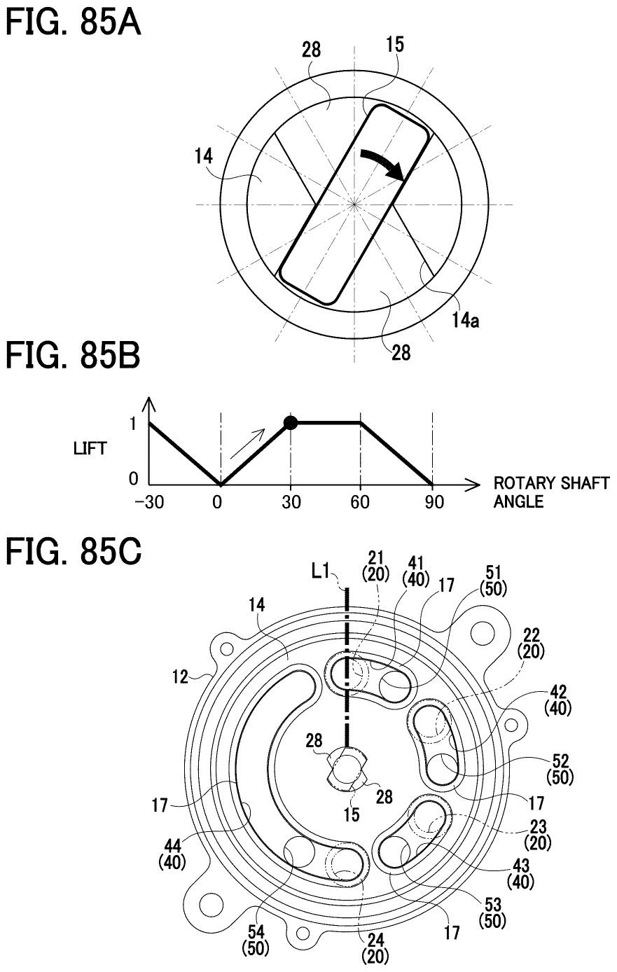

FIGS. 84A to 84C show the “initial state” of the flow path switching device 8 in this embodiment; FIG. 84A is an image diagram showing an engagement relationship between the through hole 14a of the rotary disk 14 and the rotary shaft 15. FIGS. 85A, 86A, 87A, 88A, 89A, and 90A, which will be described later, are image diagrams similar to FIG. 84A. FIG. 84B is an image diagram showing changes in lifting of the rotary shaft 15 with respect to the rotary shaft angle. FIGS. 85B, 86B, 87B, 88B, 89B, and 90B, which will be described later, are image diagrams similar to FIG. 84B. FIG. 84C is a plan diagram, similar to FIG. 62, showing the rotational positions of the rotary disk 14 and the rotation communication paths 40. FIGS. 85C, 86C, 87C, 88C, 89C, and 90C, which will be described later, are plan diagrams similar to FIG. 84C.

In this “initial state”, as shown in FIG. 84A, the rotary shaft 15 is positioned in the through hole 14a with the gaps 28 on both sides in the rotation direction and, as shown in FIG. 84B, the shaft protrusions 15b ride down into the disk recesses 13e and hence the rotary shaft 15 lifts down. Further, the rotary disk 14 and the rotation communication paths 40 are placed in the state shown in FIG. 84C. At that time, the first rotation communication path 41 communicates with the first inflow path 21 and the first fixed communication path 51, the second rotation communication path 42 communicates with the second inflow path 22 and the second fixed communication path 52, the third rotation communication path 43 communicates with the third inflow path 23 and the third fixed communication path 53, and fourth rotation communication path 44 communicates with the fourth inflow path 24 and the fourth fixed communication path 54. The disk rotating angle at that time is defined as a 0°, and the flow path switching state is defined as the “pattern A”.

Next, changes from the “initial state” will be described in sequence. FIGS. 85A to 85C show a “30° rotational state” to which the rotary shaft 15 rotates 30° clockwise from the “initial state”. In this state, as shown in FIG. 85A, the rotary shaft 15 idle-rotates 30° clockwise from the “initial state” and engages the other inner wall of the through hole 14a, the shaft protrusions 15b ride on one side edges of the top portions 13h of the disk protrusions 13g, and hence the rotary shaft 15 lifts up as shown in FIG. 85B. Further, as shown in FIG. 85C, the disk rotating angle remains 0°, and the flow path switching state of the rotation communication paths 40 is the same “pattern A” as in the “initial state”.

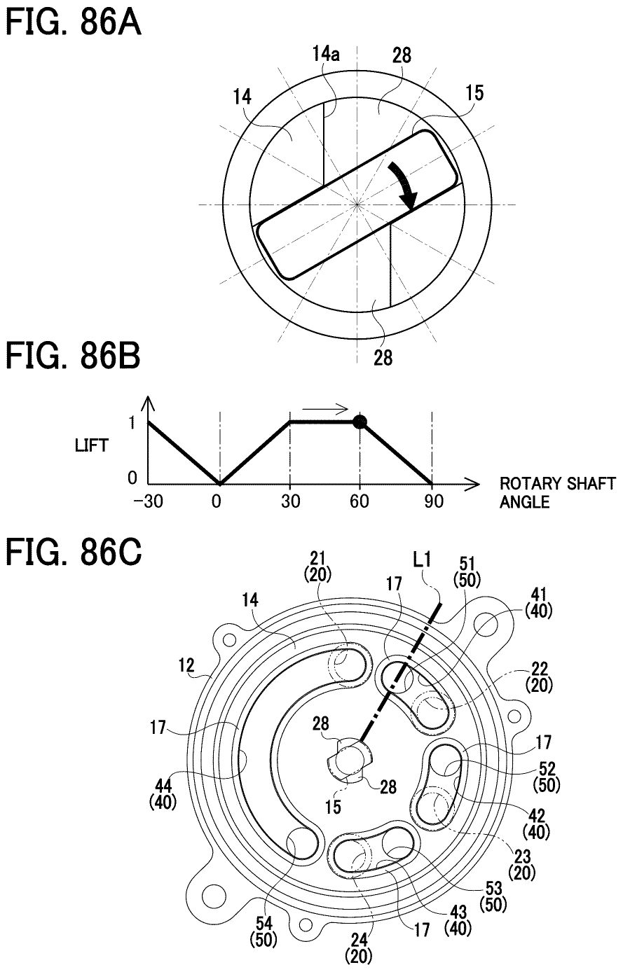

Next, FIGS. 86A to 86C show a “60° rotational state” to which the rotary shaft 15 rotates 30° clockwise from the “30° rotational state”. In this state, as shown in FIG. 85A, the rotary shaft 15 rotates 30° clockwise together with the rotary disk 14, the shaft protrusions 15b ride on the other side edges of the top portions 13h of the disk protrusions 13g and, as shown in FIG. 86B, the rotary shaft 15 rotates clockwise while remaining lifted up. As shown in FIG. 86C, the rotation communication paths 40 rotates clockwise 30° clockwise. In this “30° rotational state”, the first rotation communication path 41 communicates with the second inflow path 22 and the first fixed communication path 51, the second rotation communication path 42 communicates with the third inflow path 23 and the second fixed communication path 52, the third rotation communication path 43 communicates with the fourth inflow path 24 and the third fixed communication path 53, and the fourth rotation communication path 44 communicates with the first inflow path 21 and the fourth fixed communication path 54. The disk rotating angle at that time is 30°, and this flow path switching state is defined as the “pattern B”.

In this embodiment, as described above, the “switching angle” to rotate the rotary disk 14 to switch the flow paths of the flow path switching device 8 is set to 30°. In this embodiment, specifically, the clockwise “idle-rotating angle” of the rotary shaft 15 and the “switching angle” of the rotary disk 14 to switch the flow paths are set to the same 30°.

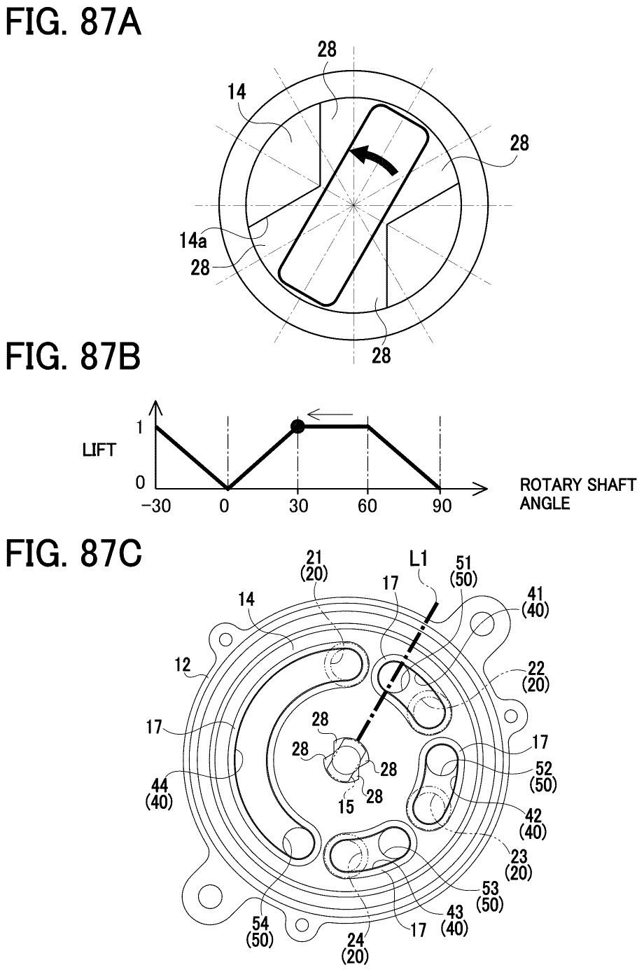

Next, FIGS. 87A to 87C show a “return-30° rotational state” to which the rotary shaft 15 rotates 30° counterclockwise from the “60° rotational state”. In this state, as shown in FIG. 87A, the rotary shaft 15 idle-rotates 30° counterclockwise and the shaft protrusions 15b ride on one side edges of the top portions 13h, so that the rotary shaft 15 rotates counterclockwise while remaining lifted up as shown in FIG. 87B. Furthermore, as shown in FIG. 87C, the rotation communication paths 40 stay at the same positions as in the “60° rotational state”, and the disk rotating angle remains 30°. The flow path switching state at that time is the same “pattern B” as in the “60° rotational state”.

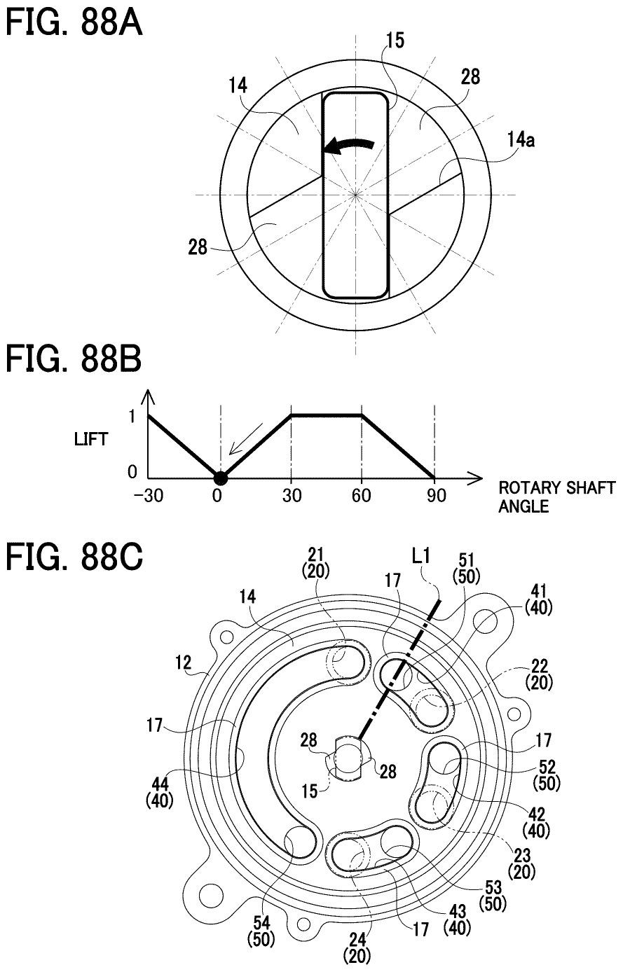

Next, FIGS. 88A to 88C show a “return-0° rotational state” to which the rotary shaft 15 further rotates 30° counterclockwise from the “return-30° rotational state”. In this state, as shown in FIG. 88A, the rotary shaft 15 idle-rotates 30° counterclockwise and engages with one inner wall of the through hole 14a, the shaft protrusions 15b ride down into the disk recesses 13e, and hence the rotary shaft 15 lifts down as shown in FIG. 88B. Furthermore, as shown in FIG. 88C, the rotation communication paths 40 stay at the same positions as in the “return-30° rotational state”, and the disk rotating angle remains 30°. The flow path switching state at that time is the same “pattern B” as in the “return-30° rotational state”.

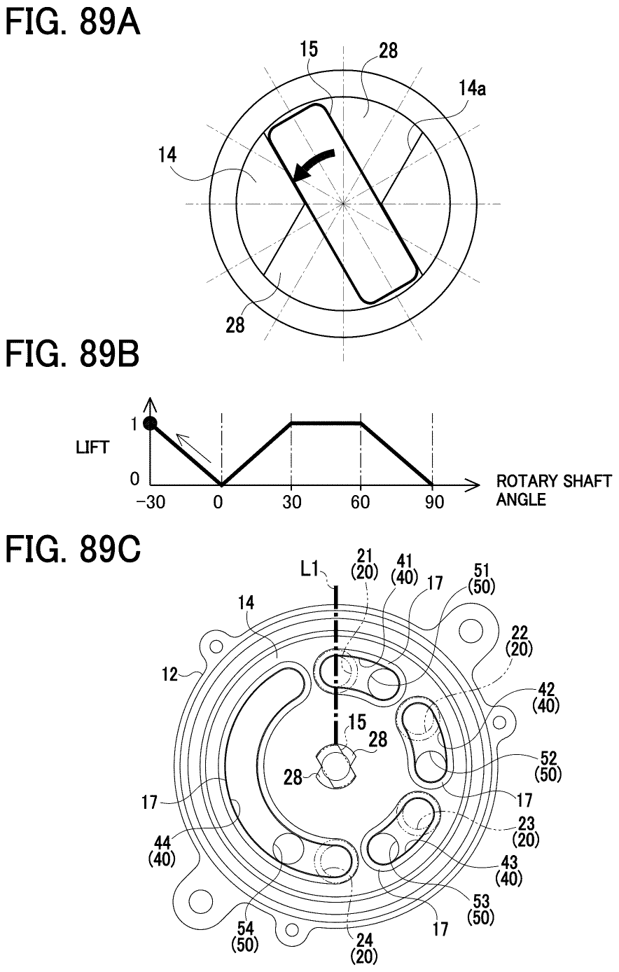

Next, FIGS. 89A to 89C show a “−30° rotational state” to which the rotary shaft 15 rotates 30° counterclockwise from the “return-0° rotational state”. In this state, as shown in FIG. 89A, the rotary shaft 15 rotates 30° counterclockwise together with the rotary disk 14, the shaft protrusions 15b ride on the disk protrusions 13g, and hence the rotary shaft 15 lifts up as shown in FIG. 89B. Furthermore, as shown in FIG. 89C, the rotary disk 14 and the rotation communication paths 40 rotate 30° counterclockwise. The flow path switching state at that time is the same “pattern A” as in the “initial state”.

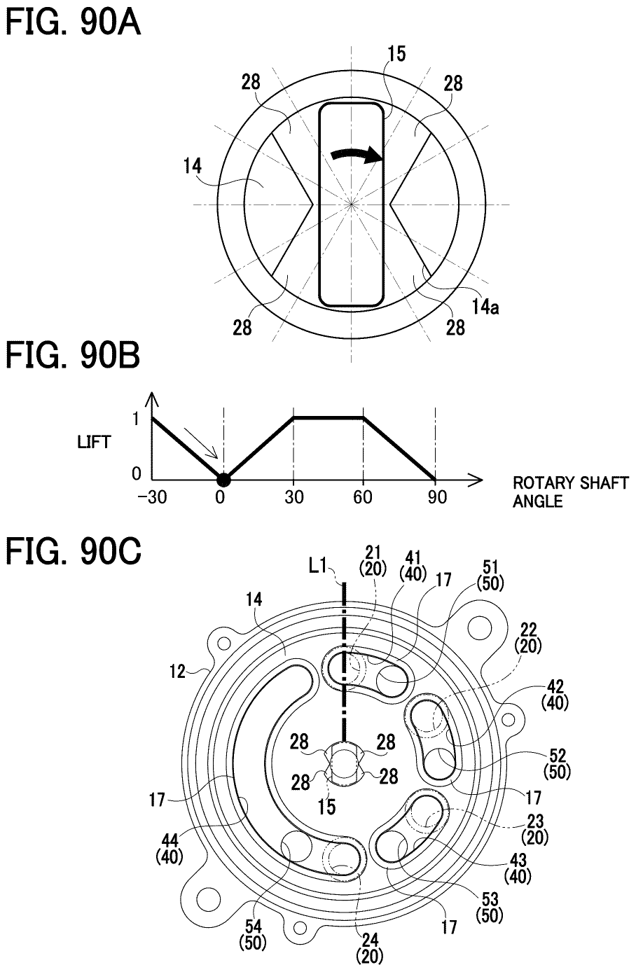

Next, FIGS. 90A to 90D show a “return-initial state” to which the rotary shaft 15 rotates 30° clockwise from the “−30° rotational state”. In this state, as shown in FIG. 90A, the rotary shaft 15 idle-rotates 30° clockwise and the shaft protrusions 15b ride down into the disk recesses 13e, and hence the rotary shaft 15 lifts down as shown in FIG. 90B. Further, as shown in FIG. 90C, the rotation communication paths 40 stay at the same position as in the “initial state”, and the disk rotating angle remains 0°. The flow path switching state at that time is the “pattern A”.

### Operations and Effects of Flow Path Switching Device

According to the configuration of the flow path switching device 8 in this embodiment described above, the device is the “two-way idle-rotating type” and is configured to switch the flow paths between two pattens. This configuration includes both the mode of switching the flow paths at the same time of lifting down the rotary shaft 15 and the mode of switching the flow paths while the rotary shaft 15 is lifted up, and further the mode of switching the flow paths while the rotary shaft 15 remains lifted up may be added partly. Specifically, as shown in FIGS. 86A to 86C, the rotary disk 14 rotates while the rotary shaft 15 remains lifted up (the spacing between the fixed disk 13 and the upper housing 11 remains widened). When the flow paths are switched, accordingly, each seal member 17, 18 can be prevented from sliding wear and dislodgement by drag.

### Eighth Embodiment

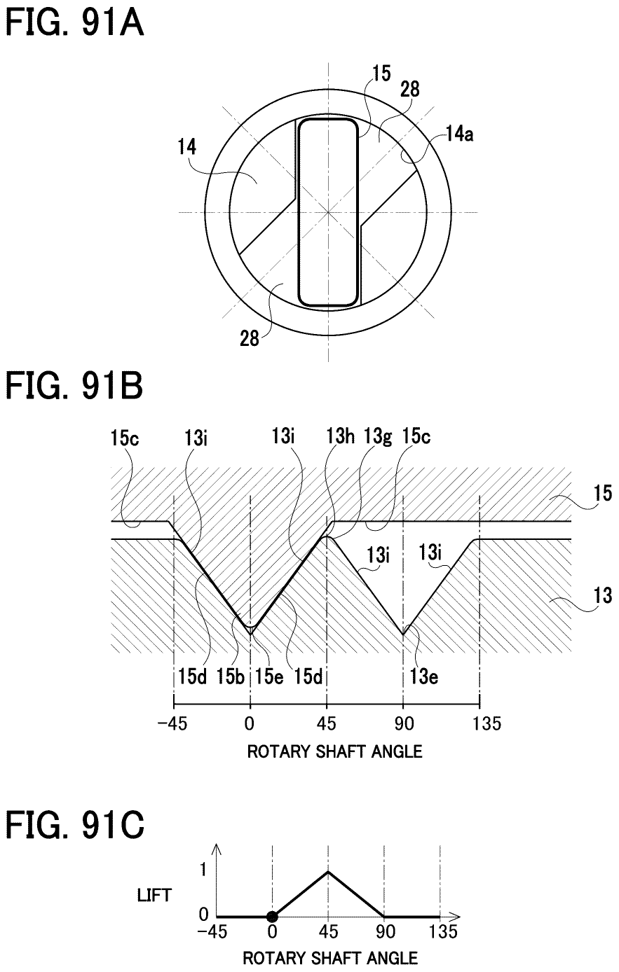

An eighth embodiment will be described in detail below, referring to FIGS. 91A to 95C.

### Engaging Structure and Engaged Structure

This embodiment is a modified example of the third embodiment and differs from the third embodiment in the configurations of the engaging structure and the engaged structure. In this embodiment, similar to the third embodiment, the flow path switching device is configured to switch the flow paths of a fluid between two patterns and is the “one-way idle-rotating type” that the rotary shaft 15 can idle-rotate clockwise only.

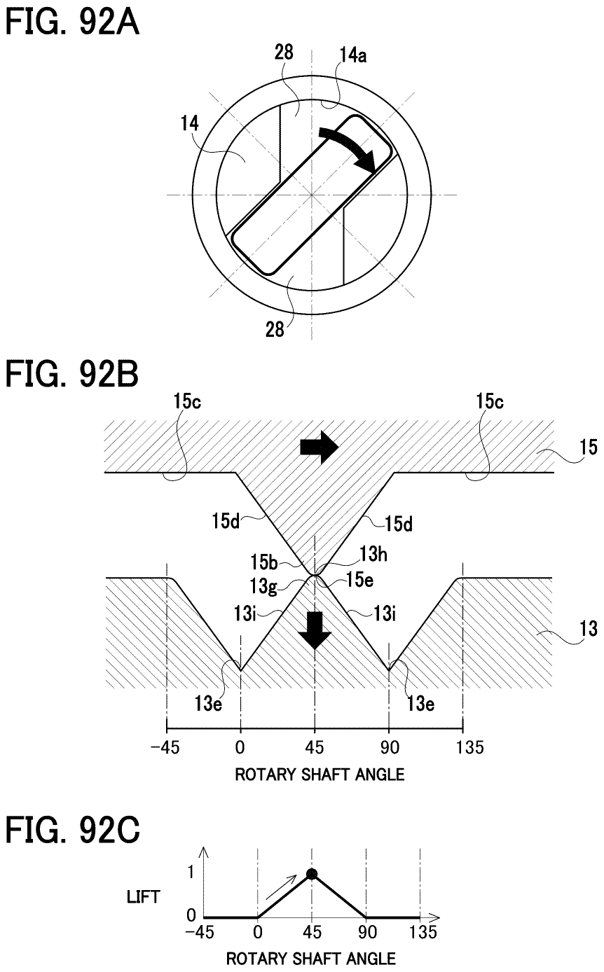

FIGS. 91A to 91C show an “initial state” of the flow path switching device 1 in this embodiment; FIG. 91A is the same image diagram as FIG. 40A. FIGS. 92A, 93A, 94A, and 95A, which will be described later, are image diagrams similar to FIG. 91A. FIG. 91B is an image diagram showing the relationship between the engaging structure K1 (the shaft protrusions 15b and the shaft recesses 15c) and the engaged structure K2 (the disk recesses 13e and the disk protrusions 13g) in this embodiment. FIGS. 92B, 93B, 94B, and 95B, which will be described later, are image diagrams similar to FIG. 91B. As shown in FIG. 91B to FIG. 95B, in this embodiment, the top portions 15e of the shaft protrusions 15b and the top portions 13h of the disk protrusions 13g each have a protruding curved surface. In this embodiment, the inclination angle of each side surface 15d of the shaft protrusions 15b and the inclination angle of each side surface 13i of the disk protrusions 13g and the disk recesses 13e are set to be the same. FIG. 91C is the same image diagram as FIG. 40B. FIGS. 92C, 93C, 94C, and 95C, which will be described later, are image diagrams similar to FIG. 91C.

In the “initial state” shown in FIGS. 91A to 91C, the rotary shaft 15 is positioned in the through hole 14a with the gaps 28 located only in the clockwise direction as shown in FIG. 91A. The shaft protrusions 15b ride down into the disk recesses 13e, and the rotary shaft 15 lifts down as shown in FIGS. 91B and 91C. In this state, as shown in FIG. 91B, the shaft protrusions 15b fit in and engage with the disk recesses 13e.

Next, changes from the “initial state” will be described in sequence. FIGS. 92A to 92C show a “45° rotational state” to which the rotary shaft 15 rotates 45° clockwise from the “initial state”. In this state, as shown in FIG. 92A, the rotary shaft 15 idle-rotates 45° clockwise from the “initial state” and engages with the other inner wall of the through hole 14a, and hence the shaft protrusions 15b ride on the disk protrusions 13g and the rotary shaft 15 lifts up as shown in FIGS. 92B and 92C. In this state, as shown in FIG. 92B, the top portions 15e of the shaft protrusions 15b ride on and contact with the top portions 13h of the disk protrusions 13g.

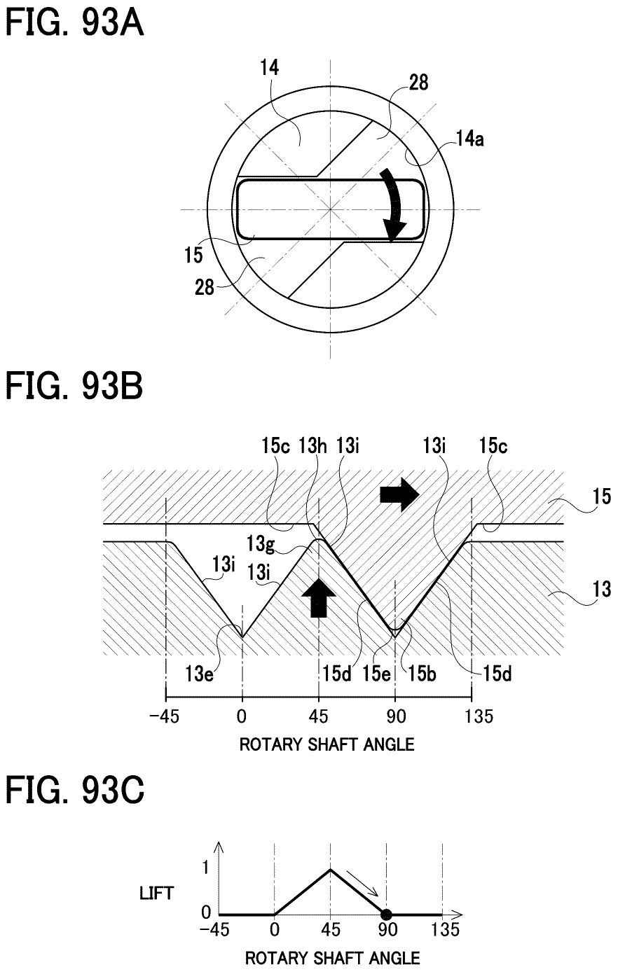

Next, FIGS. 93A to 93C show a “90° rotational state” to which the rotary shaft 15 further rotates 45° clockwise from the “45° rotational state”. In this state, as shown in FIG. 93A, the rotary shaft 15 rotates 45° clockwise together with the rotary disk 14 from the “45° rotational state” and, as shown in FIGS. 93B and 93C, the shaft protrusions 15b ride down into the disk recesses 13e and the rotary shaft 15 lifts down. In this state, as shown in FIG. 93B, the shaft protrusions 15b fit in and engage with the disk recesses 13e.

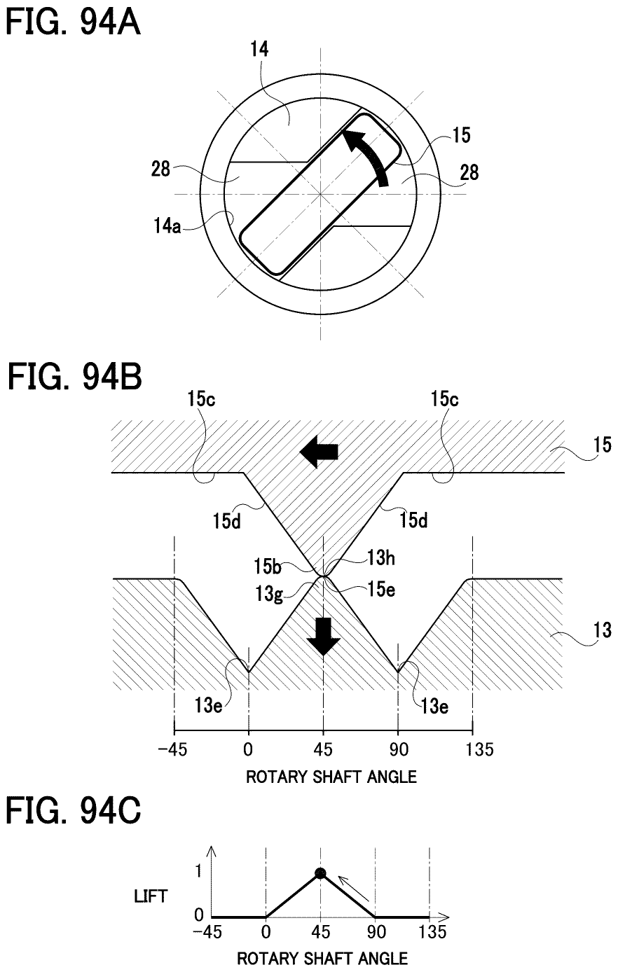

Next, FIGS. 94A to 94C show a “return-45° rotational state” to which the rotary shaft 15 rotates 45° counterclockwise from the “90° rotational state”. In this state, as shown in FIG. 94A, the rotary shaft 15 idle-rotates 45° counterclockwise from the “90° rotational state” and engages with one inner wall of the through hole 14a. As shown in FIGS. 94B and 94C, the shaft protrusions 15b ride on the disk protrusions 13g and hence the rotary shaft 15 lifts up. In this state, as shown in FIG. 94B, the top portions 15e of the shaft protrusions 15b ride on and contact with the top portions 13h of the disk protrusions 13g.

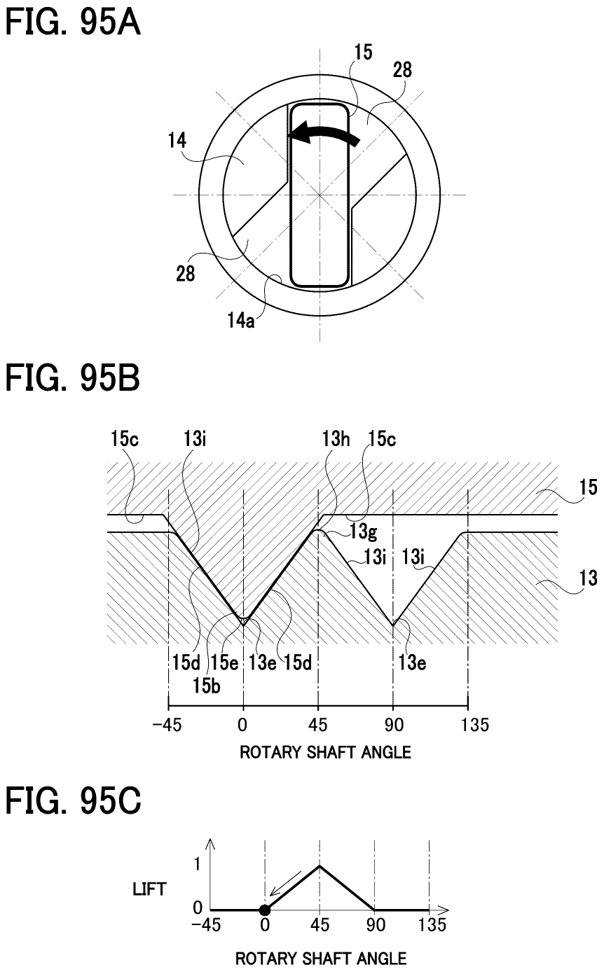

Next, FIGS. 95A to 95C show a “return-initial state” to which the rotary shaft 15 rotates 45° counterclockwise from the “return-45° rotational state”. In this state, as shown in FIG. 95A, the rotary shaft 15 rotates 45° counterclockwise together with the rotary disk 14 from the “return-45° rotational state. As shown in FIGS. 95B and 95C, the shaft protrusions 15b ride down into the disk recesses 13e, and hence the rotary shaft 15 lifts down. In this state, as shown in FIG. 95B, the shaft protrusions 15b fit in and engage with the disk recesses 13e.

### Operations and Effects of Flow Path Switching Device

According to the configuration of the flow path switching device 1 in this embodiment described above, the top portions 15e of the shaft protrusions 15b and the top portions 13h of the disk protrusions 13g each have a protruding curved surface. Accordingly, as shown in FIGS. 92B and 94B, when the rotary shaft 15 lifts up and the top portions 15e of the shaft protrusions 15b ride on the top portions 13h of the disk protrusions 13g, they engage with each other stably, which can avoid the shaft protrusions 15b from suddenly changing to move up and down.

### Ninth Embodiment

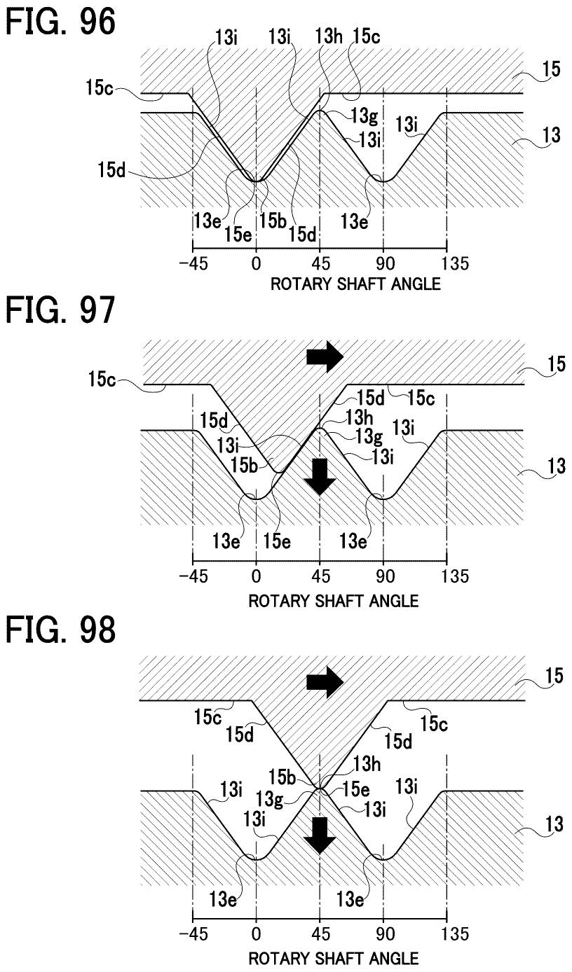

Next, a nineth embodiment will be described in detail, referring to FIGS. 96 to 102.

### Engaging Structure and Engaged Structure

This embodiment is a modified example of the eighth embodiment and differs from the eighth embodiment in the configurations of the engaging structure K1 and the engaged structure K2.

FIGS. 96 to 98 are related to the flow path switching device 1 in this embodiment; FIG. 96 is an image diagram showing a relationship between the engaging structure and the engaged structure when the rotary shaft 15 lifts down before switching flow paths; FIG. 97 is an image diagram showing the relationship between the engaging structure and the engaged structure in the process of lifting up the rotary shaft 15 in switching the flow paths; and FIG. 98 is an image diagram showing the relationship between the engaging structure and the engaged structure when the rotary shaft 15 lifts up in switching the flow paths. In this embodiment, as shown in FIG. 96 to FIG. 98, the top portions 15e of the shaft protrusions 15b and the top portions 13h of the disk protrusions 13g each have a protruding curved surface, and the bottom portions of the disk recesses 13e each have a recess curved surface. In this embodiment, furthermore, the radius of the protruding curved surface of the top portion 15e of each shaft protrusion 15b is smaller than the radius of the recess curved surface of the bottom portion of each disk recess 13e.

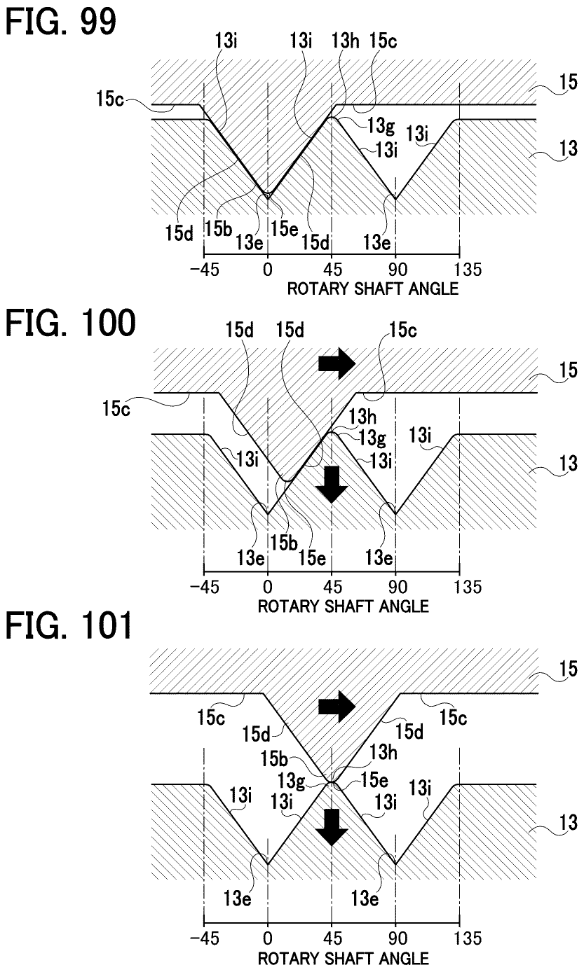

In contrast, FIGS. 99 to 101 are related to a comparative example (the eighth embodiment); FIG. 99 is an image diagram showing the relationship between the engaging structure and the engaged structure when the rotary shaft 15 lifts down before switching flow paths; FIG. 100 is an image diagram showing the relationship between the engaging structure and the engaged structure in the process of lifting up the rotary shaft 15 in switching the flow paths; and FIG. 101 is an image diagram showing the relationship between the engaging structure and the engaged structure when the rotary shaft 15 lifts up in switching the flow paths.

### Operations and Effects of Flow Path Switching Device

According to the configuration of the flow path switching device 1 in this embodiment described above, as shown in FIGS. 96 to 98, the radius of the protruding curved surface of each shaft protrusion 15b is smaller than the radius of the recess curved surface of each disk recess 13e, so that when the rotary shaft 15 starts to lift up from the state shown in FIG. 96, that is, at the early stage of flow path switching where the rotary shaft 15 starts to rotate to switch the flow paths, the sliding resistance of the shaft protrusions 15b against the disk recesses 13e becomes smaller than that in the comparative example shown in FIG. 99. Comparing between the case shown in FIG. 97 and the case shown in FIG. 100, the sliding resistances in both cases are almost the same. Further, comparing the case shown in FIG. 98 and the case shown in FIG. 101, the sliding resistances in both cases are also almost the same. This can reduce the drive torque of the rotary shaft 15 at the early stage of flow path switching, and reduce the upward moving angle of the rotary shaft 15 that starts to move up. Furthermore, since the upward moving angle of the rotary shaft 15 at the start of lift-up can be reduced, the drive torque of the rotary shaft 15 can be suppressed.

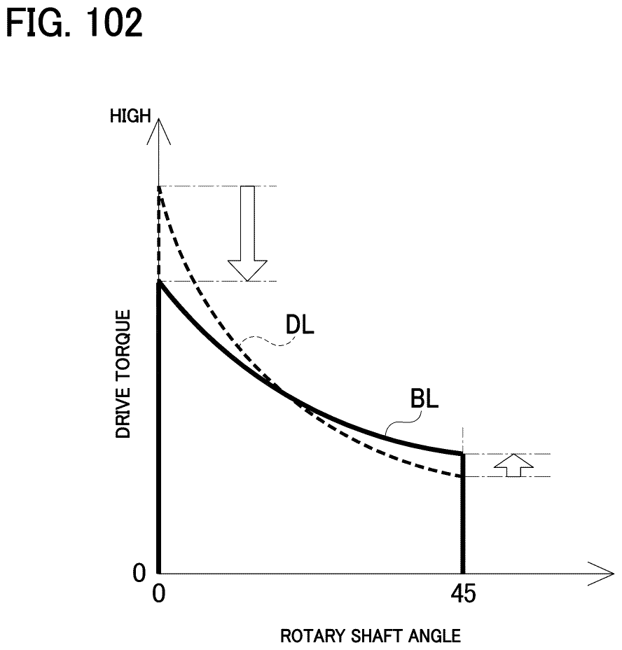

FIG. 102 is a graph showing the relationship between changes in rotary shaft angle and changes in drive torque. In FIG. 102, a thick line BL indicates the present embodiment and a broken line DL indicates the comparative example (the eighth embodiment). This graph reveals, as shown in FIG. 102, that the drive torque at the rotary shaft angle of 0° in the present embodiment is lower than that in the comparative example, and the drive torque at the rotary shaft angle of 45° in the present embodiment is higher than that in the comparative example.

### Tenth Embodiment

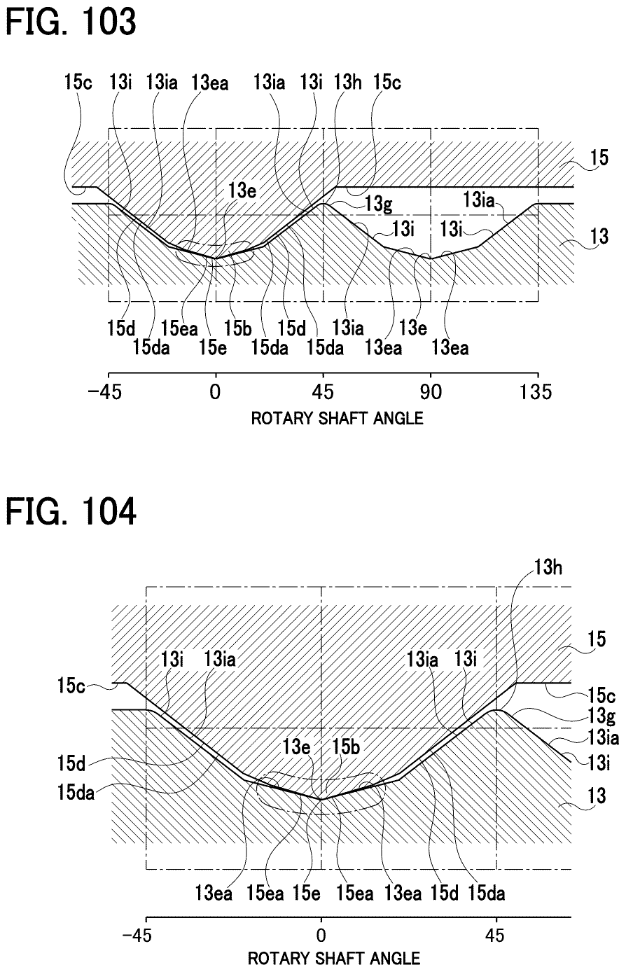

Next, a tenth embodiment will be described in detail, referring to FIGS. 103 to 113.

### Issues in the Ninth Embodiment

In the foregoing nineth embodiment, the top portions 15e of the shaft protrusions 15b and the top portions 13h of the disk protrusions 13g each have a protruding curved surface, and the bottom portions of the disk recesses 13e each have a recess curved surface. Further, the radius of the protruding curved surface of the top portion 15e of each shaft protrusion 15b is smaller than the radius of the recess curved surface of the bottom portion of each disk recess 13e. Therefore, when the rotary shaft 15 lifts down and the shaft protrusions 15b ride down in the disk recesses 13e, the top portion 15e of each shaft protrusion 15b contacts with the bottom portion of each disk recess 13e at only one point. In this state, the contact surface pressure of each seal member 17, 18 against the upper housing 11 and the fixed disk 13 is maximum, high stress acts on the contact points of the top portions 15e of the shaft protrusions 15b and the bottom portions of the disk recesses 13e.

This leads to a concern that, when the rotary shaft 15 starts to rotate to lift up from the lift-down state, the top portions 15e of the shaft protrusions 15b and the bottom portions of the disk recesses 13e start to slide with only one point contact, increasing the sliding resistance and promoting wear between both parts 15b and 13e. As the top portion of each shaft protrusion 15b or the bottom portion of each disk recess 13e wears down, the clearance between the rotary disk 14 and the fixed disk 13 becomes narrower, which further increases the contact surface pressure of each seal member 17, 18 and thus further increases the sliding resistance. As a result, the drive torque required to start rotation of the rotary shaft 15 to lift up the rotary shaft 15, the drive part 4 needs to output high power. In this embodiment, therefore, the shapes of the engaging structure and the engaged structure (the shaft protrusions 15b and the disk recesses 13e) are modified as below in order to reduce the drive torque required to lift up the rotary shaft 15 from the lift-down state.

### Engaging Structure and Engaged Structure

FIGS. 103 to 113 are image diagrams showing changes in the relationship between the engaging structure and the engaged structure in the flow path switching device 1 in this embodiment, when the rotary shaft 15 lifts up from the lift-down state and further lifts down during flow path switching.

FIG. 103 is an image diagram showing the relationship between the engaging structure and the engaged structure in a lift-down state before switching flow paths. FIG. 104 is an enlarged diagram showing an abutting portion in FIG. 103. As shown in FIGS. 103 and 104, the disk recesses 13e in this embodiment each have, at its bottom portion, a V-shaped, gently recess inclined surface (a recess gently-inclined surface) 13ea, and a steeply-inclined surface 13ia that is continuous from the recess gently-inclined surface 13ea to the disk protrusion 13g and forms the side surface 13i of the disk protrusion 13g. In this embodiment, the top portion 13h of each disk protrusion 13g has a protruding curved surface. Further, the shaft protrusions 15b each have, at its top portion 15e, a V-shaped, gently protrusion inclined surface (a protrusion gently-inclined surface) 15ea that conforms to the recess gently-inclined surface 13ea and can surface contact therewith. The side surface 15d of each shaft protrusion 15b continuous from the protrusion gently inclined surface 15ea has a steeply-inclined surface 15da that conforms to the steeply-inclined surface 13ia of the side surface 13i of each disk protrusion 13g and can surface contact therewith.

In this state before switching the flow paths, the contact surface pressure of each seal member 17, 18 against the upper housing 11 and the fixed disk 13 is high, and the abutment surface pressure of the shaft protrusions 15b and the disk recesses 13e is high. However, since the recess gently-inclined surface 13ea and the protrusion gently-inclined surface 15ea surface-abut on each other, the stress of high abutment surface pressure is distributed without concentrating on one point.

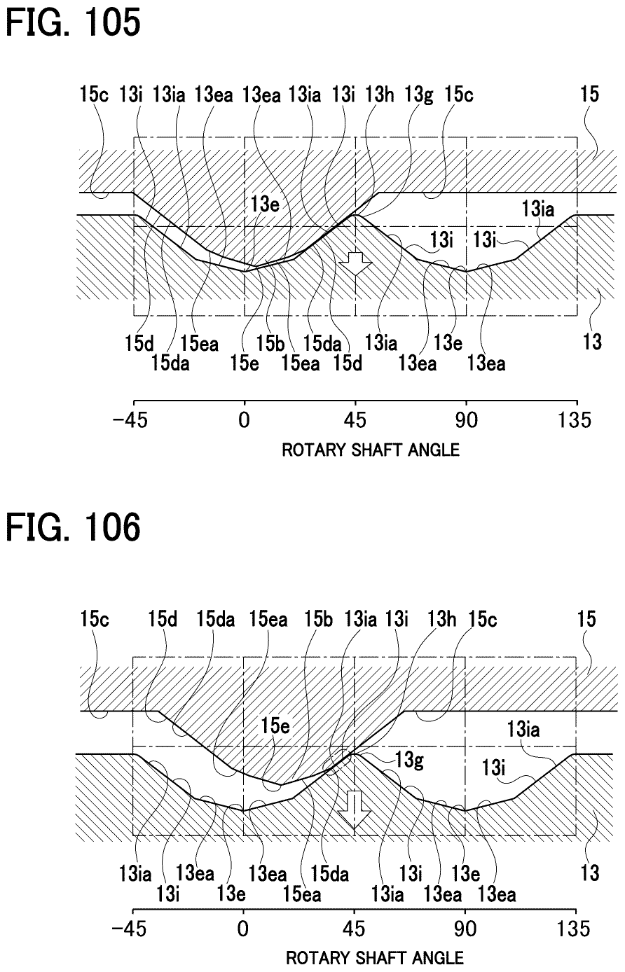

Next, FIG. 105 is an image diagram showing the relationship between the engaging structure and the engaged structure at the start of flow path switching (during the initial drive at the start of lift-up). During this initial drive, sliding is performed with the protrusion gently-inclined surface 15ea abutting on the recess gently-inclined surface 13ea and the steeply-inclined surface 15da of the shaft protrusion 15b abutting on the steeply-inclined surface 13ia of the disk protrusion 13g. At that time, each seal member 17, 18 has a high surface pressure, and the abutment surface pressure of the shaft protrusion 15b with the disk recess 13e is high. However, the recess gently-inclined surface 13ea and the protrusion gently-inclined surface 15ea surface-abut on each other and the steeply-inclined surface 13ia and the steeply-inclined surface 15da abut on each other, so that the stress of high abutment surface pressure is distributed.

Next, FIG. 106 is an image diagram showing the relationship between the engaging structure and the engaged structure in the process of flow path switching (in the process of lift-up). In this process of lift-up, the steeply-inclined surface 15da of the shaft protrusion 15b slides while abutting on the steeply-inclined surface 13ia of the disk recess 13e. At that time, the rotary shaft 15 starts to lift up (the fixed disk 13 starts to move down), increasing the gaps of the upper housing 11 and the fixed disk 13 with respect to the rotary disk 14, so that the contact surface pressure of each seal member 17, 18 decreases to a medium degree of surface pressure.

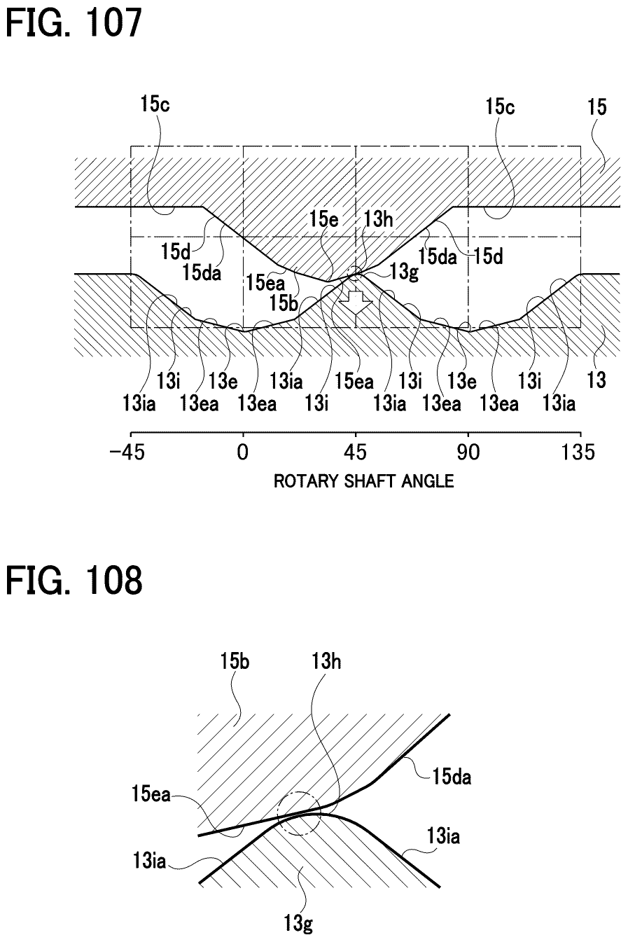

Next, FIG. 107 similarly shows the relationship between the engaging structure and the engaged structure in the process of flow path switching (in the process of lift-up). In this process of lift-up, the protrusion gently-inclined surface 15ea of the shaft protrusion 15b slides while abutting on the top portion 13h forming the protruding curved surface of the disk protrusion 13g. FIG. 108 is an enlarged image diagram showing an abutting portion in FIG. 107. At that time, the rotary shaft 15 lifts up (the fixed disk 13 moves down), further increasing the gaps of the upper housing 11 and the fixed disk 13 with respect to the rotary disk 14, so that the contact surface pressure of each seal member 17, 18 further decreases to a low degree of surface pressure. This reduces the load on the top portions 13h of the disk protrusions 13g, and thus the abutment stress of the shaft protrusions 15b against the top portions 13h of the disk protrusions 13g concentrates, but decreases.

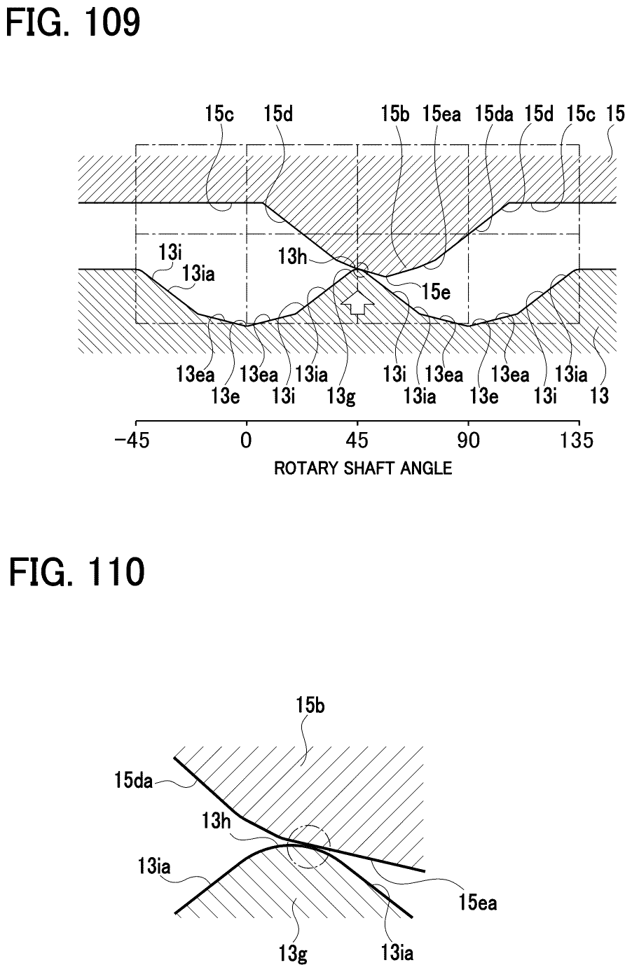

Next, FIG. 109 shows the relationship between the engaging structure and the engaged structure in the process of flow path switching and just after the top portions 15e of the shaft protrusions 15b run over the top portions 13h of the disk protrusions 13g (start to lift down). FIG. 110 is an enlarged diagram showing an abutting portion in FIG. 109. At this stage of starting to lift down, similar to the cases shown in FIGS. 107 and 108, the protrusion gently-inclined surface 15ea of each shaft protrusion 15b slides while abutting on the curved surface of the top portion 13h of each disk protrusion 13g. At that time, the rotary shaft 15 starts to lift down (the fixed disk 13 starts to move up), but because the gaps of the upper housing 11 and the fixed disk 13 with respect to the rotary disk 14 have been widened, the contact surface pressure of each seal member 17, 18 decreases to a low surface pressure. Therefore, similar to the cases shown in FIGS. 107 and 108, the abutment stress of the shaft protrusions 15b against the top portions 13h of the disk protrusions 13g concentrates, but decreases.

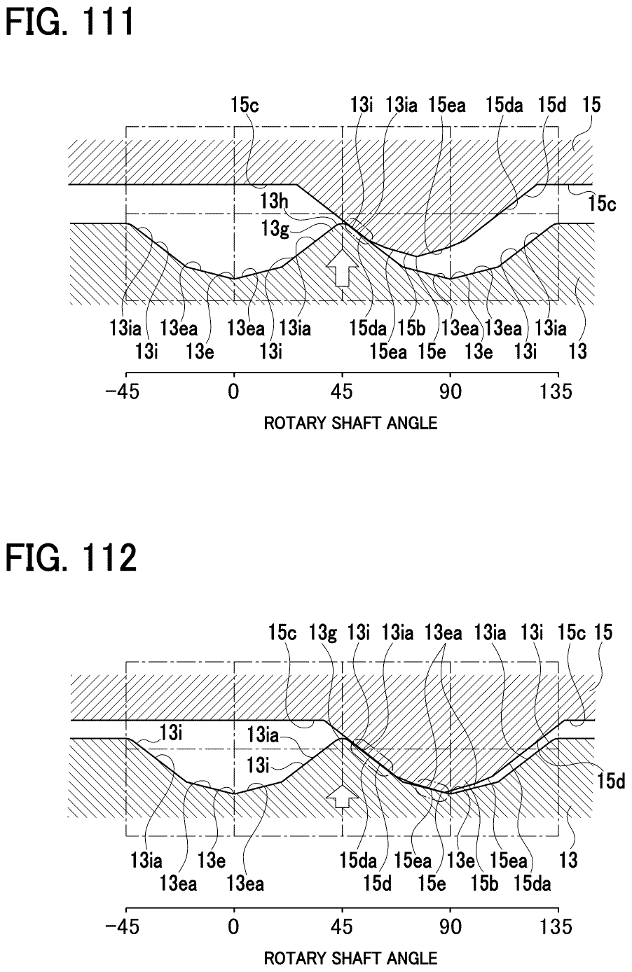

Next, FIG. 111 shows the relationship between the engaging structure and the engaged structure in the process of flow path switching (in the process of lift-down). In this process of lift-down, the steeply-inclined surface 15da of the shaft protrusion 15b slides while abutting on the steeply-inclined surface 13ia of the disk recess 13e. At that time, the rotary shaft 15 in the process of lift-down (in the process of upward motion of the fixed disk 13) and the gaps of the upper housing 11 and the fixed disk 13 with respect to the rotary disk 14 gradually decrease, so that the contact surface pressure of each seal member 17, 18 starts to increase and reaches a medium degree of surface pressure.

Next, FIG. 112 shows the relationship between the engaging structure and the engaged structure before completion of flow path switching (before completion of lift-down). In this stage before completion of lift-down, the protrusion gently-inclined surface 15ea slides while abutting on the recess gently-inclined surface 13ea and the steeply-inclined surface 15da of the shaft protrusion 15b slides while abutting on the steeply-inclined surface 13ia of the disk protrusion 13g. At that time, each seal member 17, 18 has a high surface pressure and the abutment surface pressure of the shaft protrusion 15b and the disk recess 13e is high. However, since the recess gently-inclined surface 13ea and the protrusion gently-inclined surface 15ea surface-abut on each other and the steeply-inclined surface 13ia and the steeply-inclined surface 15da abuts on each other, so that the stress of high abutment surface pressure is distributed.

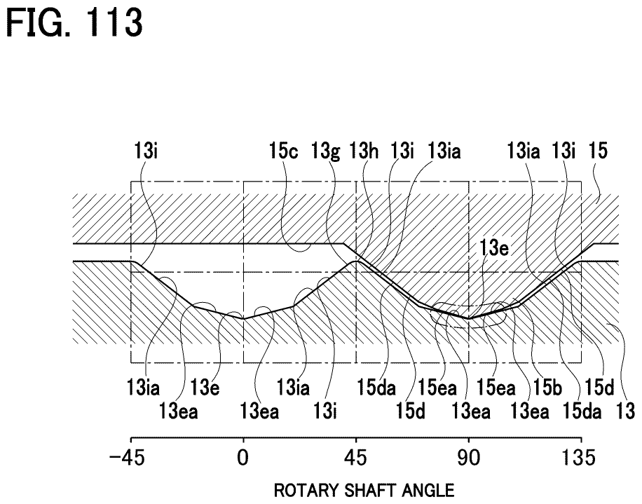

Next, FIG. 113 shows the relationship between the engaging structure and the engaged structure on completion of flow path switching (on completion of lift-down). At this stage of lift-down completion, the surface pressure of each seal member 17, 18 further increases and the abutment surface pressure of the shaft protrusion 15b and the disk recess 13e is high. However, since the recess gently-inclined surface 13ea and the protrusion gently-inclined surface 15ea surface-abut on each other, so that the stress of high abutment surface pressure is distributed.

### Operations and Effects of Flow Path Switching Device

According to the configuration of the flow path switching device 1 in this embodiment described above, when the rotary shaft 15 lifts down before switching flow paths, the shaft protrusions 15b of the rotary shaft 15 engage with the disk recesses 13e of the fixed disk 13, and the recess gently-inclined surfaces 13ea of the disk recesses 13e abut on the protrusion gently-inclined surfaces 15ea of the shaft protrusions 15b. When the rotary shaft 15 starts to rotate from this state in order to switch the flow paths, the shaft protrusions 15b start to slide against the disk recess 13e with gentle inclination by abutment between the recess gently-inclined surfaces 13ea and the protrusion gently-inclined surfaces 15ea, and slides by surface abutment between the protrusion gently-inclined surfaces 15ea and the recess gently-inclined surfaces 13ea. Further, as the rotation of the rotary shaft 15 advances, the disk recesses 13e and the shaft protrusions 15b shift to sliding by surface abutment, from abutment between the recess gently-inclined surfaces 13ea and the protrusion gently-inclined surfaces 15ea to abutment between the steeply-inclined surfaces 13ia and 15da. This can reduce the drive torque required to rotate the rotary shaft 15 at the time when the rotary shaft 15 starts to rotate from the engagement state of the shaft protrusions 15b with the disk recesses 13e, and suppress the wear between the shaft protrusions 15b and the disk recesses 13e. Furthermore, this can reduce the drive torque and make the drive part 4 compact.

### Eleventh Embodiment

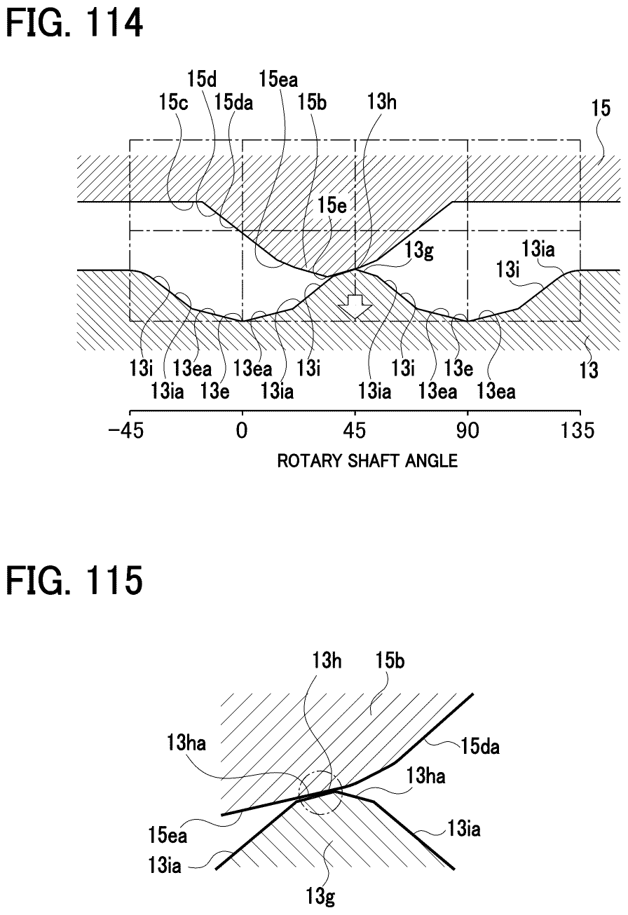

Next, an eleventh embodiment will be described in detail, referring to FIGS. 114 and 115.

### Engaging Structure and Engaged Structure

This embodiment is a modified example of the tenth embodiment and differs from the tenth embodiment in the configurations of the engaging structure and the engaged structure. FIG. 114 is an image diagram, similar to FIG. 107, showing the relationship between the engaging structure and the engaged structure in the process of flow path switching (in the process of lift-up of the rotary shaft 15). FIG. 115 is an enlarged image diagram showing an abutting portion in FIG. 114.

As shown in FIGS. 114 and 115, the top portion 13h of each disk protrusion 13g has a protrusion gently-inclined surface 13ha having a V-shape, similar to the top portion 15e of each shaft protrusion 15b, not the protruding curved surface. In this process of lift-up, the protrusion gently-inclined surfaces 15ea of the shaft protrusions 15b slide while surface-abutting on the protrusion gently-inclined surfaces 13ha of the top portions 13h of the disk protrusions 13g. This can reduce the abutment stress between the shaft protrusions 15b and the disk protrusions 13g, and suppress wear between both sides 15b and 13g.

### Other Embodiments

This disclosure is not limited to each of the above-described embodiments and may be embodied in other specific forms without departing from the essential characteristics thereof.

(1) In the first embodiment described above, the flow path switching device 1 is configured as an eight-way valve, but is not limited thereto. Any other multiple-way valves may be adopted, such as a three-way valve, a four-way valve, and a six-way valve. Accordingly, the rotary disk 14 has only to include at least one rotation communication path 40 and the fixed disk 13 has only to include a plurality of fixed communication paths 50.

(2) The “sliding resistance reducing structure” in the foregoing first embodiment is one example and is not limited to the above-described engaging structure K1 and engaged structure K2.

(3) In the foregoing second embodiment, only the top portion 15e of each shaft protrusion 15b is formed with the protruding curved surface, but only the top portion 13h of each disk protrusion 13g may be formed with a protruding curved surface or both the top portion 15e of each shaft protrusion 15b and the top portion 13h of each disk protrusion 13g may be formed with protruding curved surfaces.

(4) In the foregoing second embodiment, the top portion 15e of each shaft protrusion 15b is formed with the protruding curved surface, but may be formed with a flat surface.

### INDUSTRIAL APPLICABILITY

This disclosure is applicable to switch fluid flow paths in a fluid circuit in which a fluid such as coolant flows, for example.

### REFERENCE SIGNS LIST

1 Flow path switching device
2 Housing
3 Valve body part
4 Drive part (Drive means)
5 Controller (Control means)
8 Flow path switching device
13 Fixed disk
13e Disk recess
13ea Recess gently-inclined surface
13g Disk protrusion
13h Top portion
13ha Protrusion gently-inclined surface
13i Side surface
13ia Steeply-inclined surface
14 Rotary disk (Drive disk)
15 Rotary shaft
15b Shaft protrusion
15c Shaft recess
15d Side surface
15da Steeply-inclined surface
15e Top portion
15ea Protrusion gently-inclined surface
17 Upper seal member
18 Lower seal member
20 Inflow path (Communication path)
28 Gap
30 Outflow path (Communication path)
40 Rotation communication path (Communication path)
50 Fixed communication path (Communication path)
X Axial direction

1. A flow path switching device comprising:
a housing;
a valve body part placed in the housing;
in which the valve body part includes: a fixed disk; a drive disk stacked on the fixed disk, the drive disk being to rotate with respect to the fixed disk; and a rotary shaft for rotating the drive disk,
the housing, the fixed disk, and the drive disk each include a plurality of communication paths, which are connected by rotation of the drive disk to form flow paths of a fluid,
a seal member is provided in the flow paths at least between the fixed disk and the drive disk to suppress leakage of the fluid,
wherein a leading end portion of the rotary shaft is provided to be able to make contact and engagement with the fixed disk, and
the fixed disk is configured to reciprocally move in an axial direction by making contact and engagement with the leading end portion of the rotary shaft in association with rotation of the rotary shaft.

2. The flow path switching device according to claim 1, wherein
the leading end portion of the rotary shaft includes a shaft protrusion and a shaft recess, which are arranged in a circumferential direction,
the fixed disk includes a disk recess and a disk protrusion, which can make contact and engagement with the shaft protrusion and the shaft recess, and
the shaft protrusion and the shaft recess, and, the disk recess and the disk protrusion include side surfaces inclined in the circumferential direction.

3. The flow path switching device according to claim 2, wherein a top portion of at least one of the shaft protrusion or the disk protrusion is formed with a flat surface or a protruding curved surface, and a bottom portion of at least one of the disk recess or the shaft recess is formed with a flat surface or a recessed curved surface.

4. The flow path switching device according to claim 2, wherein
the disk recess includes a V-shaped recess gently-inclined surface at the bottom portion of the disk recess, and includes a steeply-inclined surface continuous from the recess gently-inclined surface to the disk protrusion, forming the side surface of the disk protrusion, and
the shaft protrusion includes a V-shaped protrusion gently-inclined surface at the top portion of the shaft protrusion, the protrusion gently-inclined surface conforming to the recess gently-inclined surface, and the side surface of the shaft protrusion, continuous from the protrusion gently-inclined surface, includes a steeply-inclined surface conforming to the steeply-inclined surface of the side surface of the disk protrusion.

5. The flow path switching device according to claim 1, wherein the drive disk and the rotary shaft are coupled with each other to be relatively movable in a rotation direction and an axial direction.

6. The flow path switching device according to claim 5, wherein a connection portion between the rotary shaft and the drive disk has a gap in the rotation direction.

7. The flow path switching device according to claim 6, wherein an idle-rotating angle at which the rotary shaft idle-rotates within the gap when the leading end portion of the rotary shaft shifts from a state of the engagement with the fixed disk to a state of the contact with the fixed disk and a switching angle to rotate the drive disk to switch the flow paths are set to a same angle.

8. The flow path switching device according to claim 7, further comprising:
drive means that rotationally drives the rotary shaft; and
control means that controls the drive means,
wherein the control means controls the drive means to rotate the rotary shaft to switch the flow paths with the leading end portion of the rotary shaft in the contact state with the fixed disk, and then to rotate the rotary shaft in an opposite direction and stop rotation of the rotary shaft with the leading end portion of the rotary shaft in the engagement state with the fixed disk.

9. The flow path switching device according to claim 2, wherein the drive disk and the rotary shaft are coupled with each other to be relatively movable in a rotation direction and an axial direction.

10. The flow path switching device according to claim 3, wherein the drive disk and the rotary shaft are coupled with each other to be relatively movable in a rotation direction and an axial direction.

11. The flow path switching device according to claim 4, wherein the drive disk and the rotary shaft are coupled with each other to be relatively movable in a rotation direction and an axial direction.

12. The flow path switching device according to claim 9, wherein a connection portion between the rotary shaft and the drive disk has a gap in the rotation direction.

13. The flow path switching device according to claim 10, wherein a connection portion between the rotary shaft and the drive disk has a gap in the rotation direction.

14. The flow path switching device according to claim 11, wherein a connection portion between the rotary shaft and the drive disk has a gap in the rotation direction.

15. The flow path switching device according to claim 12, wherein an idle-rotating angle at which the rotary shaft idle-rotates within the gap when the leading end portion of the rotary shaft shifts from a state of the engagement with the fixed disk to a state of the contact with the fixed disk and a switching angle to rotate the drive disk to switch the flow paths are set to a same angle.

16. The flow path switching device according to claim 13, wherein an idle-rotating angle at which the rotary shaft idle-rotates within the gap when the leading end portion of the rotary shaft shifts from a state of the engagement with the fixed disk to a state of the contact with the fixed disk and a switching angle to rotate the drive disk to switch the flow paths are set to a same angle.

17. The flow path switching device according to claim 14, wherein an idle-rotating angle at which the rotary shaft idle-rotates within the gap when the leading end portion of the rotary shaft shifts from a state of the engagement with the fixed disk to a state of the contact with the fixed disk and a switching angle to rotate the drive disk to switch the flow paths are set to a same angle.

18. The flow path switching device according to claim 15, further comprising:
drive means that rotationally drives the rotary shaft; and
control means that controls the drive means,
wherein the control means controls the drive means to rotate the rotary shaft to switch the flow paths with the leading end portion of the rotary shaft in the contact state with the fixed disk, and then to rotate the rotary shaft in an opposite direction and stop rotation of the rotary shaft with the leading end portion of the rotary shaft in the engagement state with the fixed disk.

19. The flow path switching device according to claim 16, further comprising:
drive means that rotationally drives the rotary shaft; and
control means that controls the drive means,
wherein the control means controls the drive means to rotate the rotary shaft to switch the flow paths with the leading end portion of the rotary shaft in the contact state with the fixed disk, and then to rotate the rotary shaft in an opposite direction and stop rotation of the rotary shaft with the leading end portion of the rotary shaft in the engagement state with the fixed disk.

20. The flow path switching device according to claim 17, further comprising:
drive means that rotationally drives the rotary shaft; and
control means that controls the drive means,
wherein the control means controls the drive means to rotate the rotary shaft to switch the flow paths with the leading end portion of the rotary shaft in the contact state with the fixed disk, and then to rotate the rotary shaft in an opposite direction and stop rotation of the rotary shaft with the leading end portion of the rotary shaft in the engagement state with the fixed disk.
